(19) United States
(12) Patent Application Publication
(10) Pub. No.: US 2026/0061516 A1
(43) Pub. Date: Mar. 5, 2026

(54) PROCESSING SYSTEM

(71) Applicant: NIKON CORPORATION, Tokyo (JP)

(72) Inventor: Takeshi MATSUDA, Saitama-shi (JP)

(73) Assignee: NIKON CORPORATION, Tokyo (JP)

(21) Appl. No.: 19/107,052

(22) PCT Filed: Aug. 30, 2022
(86) PCT No.: PCT/JP2022/032592

§ 371 Date: Feb. 27, 2025

(51) Int. Cl. B23K 26/08; B23K 26/03

(52) U.S. Cl. CPC B23K 26/08; B23K 26/032

(57) ABSTRACT

A processing system includes: a partition apparatus that defines a processing space; a first apparatus that performs a first operation for changing a shape of an object by processing the object contained in the processing space; and a second apparatus that performs a second operation in the processing space, the partition apparatus includes a movable aperture member in which an aperture is formed, the first apparatus is inserted into the aperture to be positioned in the processing space and the second apparatus is positioned in the outer space in a first period during which the first apparatus performs the first operation, and the second apparatus is inserted into the aperture to be positioned in the processing space and the first apparatus is positioned in the outer space in a second period during which the second apparatus performs the second operation.

### TECHNICAL FIELD

The present invention relates to a technical field of a processing system that is configured to process an object, for example.

### BACKGROUND ART

A Patent literature 1 discloses one example of a processing system that is configured to process an object. One technical problem of this processing system is to properly process the object.

### CITATION LIST

### Patent Literature

Patent Literature 1: US2002/0017509A1

### SUMMARY OF INVENTION

A first aspect provides a processing system that is configured to perform a processing for changing a shape of an object, wherein the processing system includes: a partition apparatus that defines a part of a processing space, a flow of gas between an outer space and the processing space is restricted; a first apparatus that is configured to perform a first operation for changing the shape of the object by processing the object contained in the processing space; and a second apparatus that is configured to perform a second operation in the processing space, the partition apparatus includes an aperture member in which an aperture is formed and which is movable, in a first period during which the first apparatus performs the first operation, at least a part of the first apparatus is inserted into the aperture, which is formed in the aperture member, to be positioned in the processing space, in the first period, the second apparatus is positioned in the outer space, in a second period during which the second apparatus performs the second operation, at least a part of the second apparatus is inserted into the aperture to be positioned in the processing space, and in the second period, the first apparatus is positioned in the outer space.

A second aspect provides a processing system that is configured to perform a processing for changing a shape of an object, wherein the processing system includes: a partition apparatus that defines a part of a processing space, a flow of gas between an outer space and the processing space is restricted; and a first apparatus that is configured to perform a first operation for changing the shape of the object by processing the object contained in the processing space, the partition apparatus includes: an aperture member in which an aperture is formed and which is movable; and a support member that supports the aperture member in a movable manner and that is formed by stacking a plurality of plates, the first apparatus inserted into the aperture performs the first operation while moving the aperture member, at least one of the plurality of plates moves doe to a movement of the aperture member.

A third aspect provides a processing system that is configured to perform a processing for changing a shape of an object, wherein the processing system includes: a first apparatus that is configured to perform a first operation for changing the shape of the object by processing the object contained in the processing space; a second apparatus that is configured to perform a second operation in the processing space; and a change apparatus that is configured to attach a first tool to the first apparatus and that is configured to detach the first tool from the first apparatus, the first tool includes an optical system, and the first operation includes processing the object by irradiating the object with processing light through the optical system.

An operation and another advantage of the present invention will be apparent from an example embodiment described below.

### BRIEF DESCRIPTION OF DRAWINGS

FIG. 1 is a block diagram that illustrates a configuration of a processing system in a first example embodiment.

FIG. 2 is a perspective view that illustrates the configuration of the processing system in the first example embodiment.

FIG. 3 is a cross-sectional view that illustrates the configuration of the processing system in the first example embodiment.

FIG. 4 is a perspective view that illustrates a configuration of a ceiling member in which a movable aperture is formed.

FIG. 5 is a perspective view that illustrates a configuration of a processing head that is configured to process a workpiece and that is configured to measure the workpiece.

FIG. 6 is a cross-sectional view that illustrates the processing head performing a first processing operation.

FIG. 7 is a cross-sectional view that illustrates the processing head performing the first processing operation.

FIG. 8 is a cross-sectional view that illustrates the processing head performing a second processing operation.

FIG. 9 is a cross-sectional view that illustrates the processing head performing the second processing operation.

FIG. 10 is a cross-sectional view that illustrates the processing system performing a switching of the processing head.

FIG. 11 is a cross-sectional view that illustrates the processing system performing the switching of the processing head.

FIG. 12 is a cross-sectional view that illustrates the processing system performing the switching of the processing head.

FIG. 13 is a cross-sectional view that illustrates the processing system performing the switching of the processing head.

FIG. 14 is a cross-sectional view that illustrates the processing system performing the switching of the processing head.

FIG. 15 is a cross-sectional view that illustrates the processing system performing the switching of the processing head.

FIG. 16 is a block diagram that illustrates a configuration of a processing system in a second example embodiment.

FIG. 17 is a cross-sectional view that illustrates a configuration of a tool change unit.

FIG. 18 is a cross-sectional view that conceptionally illustrates an operation for changing a tool in a processing space inside a housing.

FIG. 19 is a cross-sectional view that conceptionally illustrates the operation for changing the tool in the processing space inside the housing.

FIG. 20 Each of FIG. 20(a) and FIG. 20(b) is a cross-sectional view that illustrates the tool change unit positioned in the processing space.

FIG. 21 is a cross-sectional view that conceptionally illustrates the operation for changing the tool in an outer space outside the housing.

FIG. 22 is a cross-sectional view that conceptionally illustrates the operation for changing the tool in the outer space outside the housing.

FIG. 23 is a block diagram that illustrates a configuration of a processing system in a third example embodiment.

FIG. 24 is a perspective view that illustrates one example of a calibration member positioned in the outer space.

FIG. 25 is a cross-sectional view that illustrate a second processing head calibrated in a period during which a first processing head processes the workpiece.

FIG. 26 is a cross-sectional view that illustrate the first processing head calibrated in a period during which the second processing head processes the workpiece.

FIG. 27 is a cross-sectional view that illustrate a configuration of one specific example of the calibration member.

FIG. 28 is a plan view that illustrate a search mark formed by a light transmission area.

FIG. 29 is a plan view that illustrate a beam transmission member on which a plurality of search marks are formed.

FIG. 30 is a plan view that illustrate the plurality of search marks irradiated with processing light.

FIG. 31 illustrates light reception information output from light receiving element.

FIG. 32 is a plan view that illustrates a base irradiation position of the processing light and an actual irradiation position of the processing light.

FIG. 33 Each of FIG. 33(a) to FIG. 33 (c) illustrates the light reception information output from the light receiving element.

FIG. 34 is a cross-sectional view that illustrates a processing head in a fourth example embodiment.

FIG. 35 is a cross-sectional view that illustrates the processing head in the fourth example embodiment.

FIG. 36 is a perspective view that illustrates a configuration of a processing system in a fifth example embodiment.

FIG. 37 is a perspective view that illustrates the configuration of the processing system in the fifth example embodiment.

### DESCRIPTION OF EXAMPLE EMBODIMENTS

Next, with reference to drawings, an example embodiment of a processing system will be described. In the below described description, a processing system SYS to which the example embodiment of the processing system is adapted will be described. However, the present invention is not limited to the below described example embodiment.

Moreover, in the below-described description, a positional relationship of various components included in the processing system SYS will be described by using an XYZ rectangular coordinate system that is defined by an X-axis, a Y-axis and a Z-axis that are orthogonal to one another. Note that each of an X-axis direction and a Y-axis direction is assumed to be a horizontal direction (namely, a predetermined direction in a horizontal plane) and a Z-axis direction is assumed to be a vertical direction (namely, a direction that is orthogonal to the horizontal plane, and substantially a vertical direction) in the below-described description, for convenience of the description. Moreover, rotational directions (in other words, inclination directions) around the X-axis, the Y-axis and the Z-axis are referred to as a OX direction, a OY direction and a OZ direction, respectively. Here, the Z-axis direction may be a gravity direction. Moreover, an XY plane may be a horizontal direction.

### (1) Processing System SYS in First Example Embodiment

First, a first example embodiment of the processing system SYS will be described. In the below-described description, the processing system SYS in the first example embodiment is referred to as a “processing system SYSa”.

### (1-1) Configuration of Processing System SYSa

First, a configuration of the processing system SYSa in the first example embodiment will be described.

### (1-1-1) Entire Configuration of Processing System SYSa

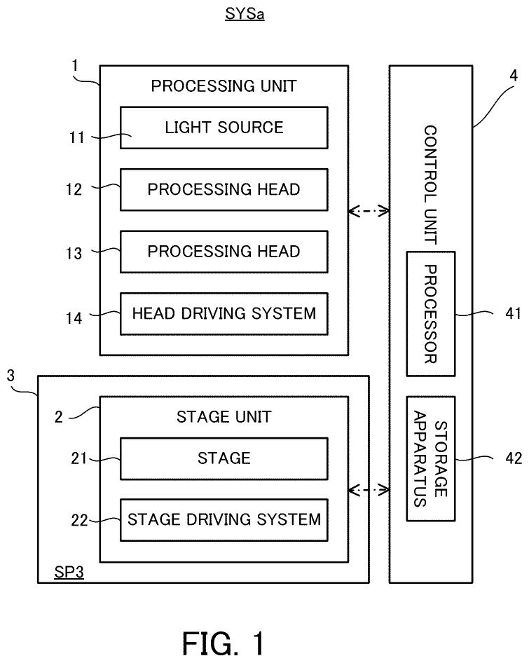

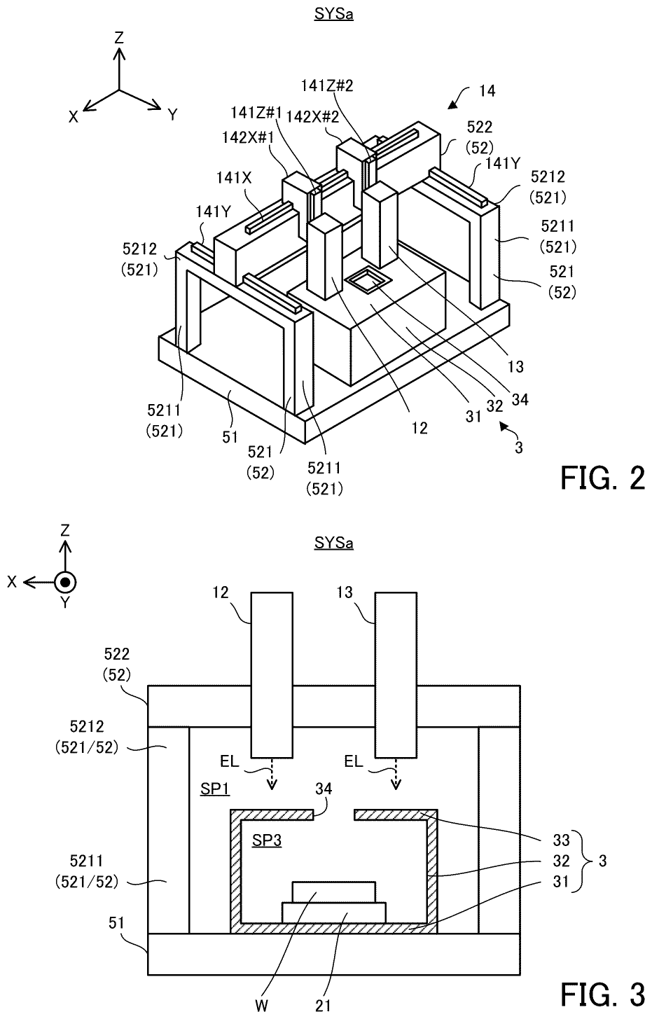

First, with reference to FIG. 1 and FIG. 3, an entire configuration of the processing system SYSa in the first example embodiment will be described. FIG. 1 is a block diagram that illustrates the configuration of the processing system SYSa in the first example embodiment. FIG. 2 is a perspective view that illustrates the configuration of the processing system SYSa in the first example embodiment. FIG. 3 is a cross-sectional view that illustrates the configuration of the processing system SYSa in the first example embodiment.

As illustrated in FIG. 1 to FIG. 3, the processing system SYSa includes a processing unit 1, a stage unit 2, a housing 3, and a control unit 4. At least a part of the stage unit 2 is contained in the housing 3. Namely, at least a part of the stage unit 2 is contained in an inner space SP3 formed in the housing 3. The inner space SP3 in the housing 3 may be purged with purge gas (namely, gas) such as Nitrogen gas and so on, or may not be purged with the purge gas. The inner space SP3 in the housing 3 may be evacuated or may not be evacuated. Incidentally, the processing unit 1 may be referred to as a processing apparatus. The stage unit 2 may be referred to as a stage apparatus. The control unit 4 may be referred to as a control apparatus.

The processing unit 1 is configured to process a workpiece W that is a processing target object under the control of the control unit 4. Incidentally, the workpiece W may be referred to as a base member. The workpiece W may be a metal, may be an alloy (for example, duralumin and the like), may be a semiconductor (for example, silicon), may be a resin, may be a composited material such as a CFRP (Carbon Fiber Reinforced Plastic), may be a painting material (as one example a film of painting material that is coated on a base member), may be a glass, may be a ceramic, or may be an object that is made from any other material, for example. At least one of a gypsum, a rubber such as a polyurethane, and an elastomer is one example of any material. Moreover, a first part of the workpiece W may be made from a first type of material, and a second part of the workpiece W, which is different from the first part, may be made from a second type of material, which is different from the first type of material.

The processing unit 1 may process the workpiece W by irradiating the workpiece W with processing light EL. The processing light EL may be any light as long as the workpiece W is processed by irradiating the workpiece W with it. In the first example embodiment, an example in which the processing light EL is laser light will be described, however, the processing light EL may be light that is different from the laser light. Furthermore, a wavelength of the processing light EL may be any wavelength as long as the workpiece W is processed by irradiating the workpiece W with it. For example, the processing light EL may be visible light, or may be invisible light (for example, at least one of infrared light, ultraviolet light, extreme ultraviolet light, and the like). The processing light EL may include pulsed light. Alternatively, the processing light EL may not include the pulsed light. In other words, the processing light EL may be continuous light. Incidentally, the processing light EL may be referred to as a processing beam because light is one example of an energy beam.

However, the processing unit 1 may process the workpiece W without irradiating the workpiece W with the processing light EL. Namely, the processing unit 1 may process the workpiece W by using a processing method that is different from a processing method of irradiating the workpiece W with the processing light EL. For example, the processing unit 1 may process the workpiece W by making a tool contact the workpiece W. For example, the processing unit 1 may process the workpiece W by making a tool, which rotates around a rotational axis, contact the workpiece W. Namely, the processing unit 1 may perform a machining processing using the tool. The tool may be a cutting tool. The tool may be a polishing tool. The tool may be an end mill. The tool may be a drill.

In order to process the workpiece W, the processing unit 1 includes a light source 11, a processing head 12, a processing head 13, and a head driving system 14.

The light source 11 is configured to generate the processing light EL under the control of the control unit 4. For example, the light source 11 may generate, as the processing light EL, at least one of infrared light, visible light, ultraviolet light, and extreme ultraviolet light. However, other type of light may be used as the processing light EL. In the first example embodiment, laser light is used as the processing light EL as described above. In this case, the light source 11 may include a laser light source (for example, a semiconductor laser such as a Laser Diode (LD)). The laser light source may include at least one of a fiber laser, a CO₂ laser, a YAG laser, an Excimer laser and the like. However, the light source 11 may include any light source (for example, at least one of a LED (Light Emitting Diode), a discharge lamp and the like).

Each of the processing heads 12 and 13 is configured to process the workpiece W by irradiating the workpiece W with the processing light EL, which is generated by the light source 11, under the control of the control unit 4. Namely, each of the processing heads 12 and 13 is configured to perform a processing operation for processing the workpiece W on the workpiece W. Therefore, each of the processing heads 12 and 13 may be referred to as a “processing apparatus”. Incidentally, in the below-described description, the processing operation performed by the processing head 12 is referred to as a “first processing operation”, and the processing operation performed by the processing head 13 is referred to as a “second processing operation”, as necessary.

The processing heads 12 and 13 may process the workpiece W by using the processing light EL emitted from a single light source 11. Alternatively, the processing heads 12 and 13 may process the workpiece W by using different processing lights EL emitted from different light sources 11, respectively. The first processing operation performed by the processing head 12 may be a processing operation whose type is the same as that of the second processing operation performed by the processing head 13. Alternatively, the first processing operation performed by the processing head 12 may be a processing operation whose type is different from that of the second processing operation performed by the processing head 13. Incidentally, the processing head 12, which performs the first processing operation, may be referred to as a first processing apparatus (alternatively, simply a first apparatus). The processing head 13, which performs the second processing operation, may be referred to as a second processing apparatus (alternatively, simply a second apparatus).

The light source 11 may be built in the processing head 12. Namely, the light source 11 may be positioned in the processing head 12. Alternatively, the light source 11 may be positioned outside the processing head 12. In a case where the light source 11 is positioned outside the processing head 12, the processing light EL generated by the light source 11 may be transmitted from an outside of the processing head 12 to an inside of the processing head 12 by using a light transmission member.

The light source 11 may be built in the processing head 13. Namely, the light source 11 may be positioned in the processing head 13. Alternatively, the light source 11 may be positioned outside the processing head 13. In a case where the light source 11 is positioned outside the processing head 13, the processing light EL generated by the light source 11 may be transmitted from an outside of the processing head 13 to an inside of the processing head 13 by using a light transmission member.

The processing unit 1 may include both of the light source 11 built in at least one of the processing heads 12 and 13 and the light source 11 positioned outside the processing heads 12 and 13.

At least one of the processing heads 12 and 13 may change a shape of the workpiece W by processing the workpiece W. Namely, the first processing operation performed by the processing head 12 may include a processing operation for changing the shape of the workpiece W. The second processing operation performed by the processing head 13 may include a processing operation for changing the shape of the workpiece W. However, at least one of the processing heads 12 and 13 may process the workpiece W without changing the shape of the 10) workpiece W. An operation for changing a characteristic of at least a part of the workpiece W is one example of the processing operation for processing the workpiece W without changing the shape of the workpiece W.

A subtractive manufacturing operation is first example of the processing operation for changing the shape of the workpiece W. The subtractive manufacturing operation is a processing operation for removing a part of the workpiece W. In this case, the subtractive manufacturing operation may be regarded as a processing operation for changing the shape of the workpiece W by removing a part of workpiece W.

At least one of the processing heads 12 and 13 may perform the subtractive manufacturing processing by using a principle of a non-thermal processing (for example, an ablation processing). Namely, at least one of the processing heads 12 and 13 may perform a non-thermal processing operation (for example, an ablation processing operation) on the workpiece W. In order to perform the non-thermal processing operation, at least one of the processing heads 12 and 13 may use, as the processing light EL, light whose photon density (in other words, fluence) is high. As one example, at least one of the processing heads 12 and 13 may use, as the processing light EL, light including the pulsed light an ON time of which is equal to or shorter than nano-seconds, is equal to or shorter than pico-seconds, or is equal to or shorter than femto-seconds. Namely, at least one of the processing heads 12 and 13 may use, as the processing light EL, light including the pulsed light whose pulse width is equal to or shorter than nano-seconds, is equal to or shorter than pico-seconds or is equal to or shorter than femto-seconds. In this case, a material constituting an energy-transferred part of the workpiece W, to which an energy of the processing light EL is transferred, instantly evaporates and spatters. Namely, the material constituting the energy-transferred part of the workpiece W evaporates and spatters within a time sufficiently shorter than a thermal diffusion time of the workpiece W. The material constituting the energy-transferred part of the workpiece W may be sublimated without being in a molten state. In this case, the material constituting the energy-transferred part of the workpiece W may be released from the workpiece W as at least one of ion, atom, radical, molecule, cluster, and solid piece. However, at least one of the processing heads 12 and 13 may perform the subtractive manufacturing processing by using a principle of a thermal processing.

An additive manufacturing processing is a second example of the processing operation for changing the shape of the workpiece W. The additive manufacturing processing is a processing operation for adding a new build object to the workpiece W. In this case, the additive manufacturing may be regarded as a processing operation for changing the shape of the workpiece W by adding a new build object to the workpiece W.

At least one of the processing heads 12 and 13 may perform the additive manufacturing operation based on any additive manufacturing method. For example, at least one of the processing heads 12 and 13 may perform the additive manufacturing operation based on a Laser Metal Deposition (LMD). The additive manufacturing operation based on the Laser Metal Deposition is an additive manufacturing operation for builds a build object that is integrated with the workpiece W or that is separable from the workpiece W by melting a build material M, which is supplied to the workpiece W, with the processing light EL. Alternatively, at least one of the processing heads 12 and 13 may perform the additive manufacturing operation based on at least one of a Powder Bed Fusion such as a Selective Laser Sintering (SLS), a binder jetting (Binder Jetting), a Material Jetting, a stereolithography, and a Laser Metal Fusion (LMF).

A planar processing operation is a third example of the processing operation for changing the shape of the workpiece W. The planar processing operation is a processing operation for making a surface of the workpiece be closer to a flat surface by melting the surface of the workpiece W and then solidifying the melted surface. In this case, the planar processing operation may be regarded as a processing operation for changing the shape of the workpiece W by making the surface of the workpiece W be closer to the flat surface. Incidentally, the planar processing operation may be referred to as a melting processing operation (in other words, a remelt processing operation), because the planar processing operation is a processing operation for melting the surface of the workpiece W.

At least one of the processing heads 12 and 13 may perform the planar processing operation by using the principle of the thermal processing. Namely, at least one of the processing heads 12 and 13 may perform a thermal processing operation on the workpiece W. In order to perform the thermal processing operation, at least one of the processing heads 12 and 13 may use, as the processing light EL, light including the pulsed light that is equal to or longer than milli-second or is equal to or longer than nano-seconds. In order to perform the thermal processing operation, at least one of the processing heads 12 and 13 may use the continuous light as the processing light EL. However, at least one of the processing heads 12 and 13 may perform the planar processing operation by using the principle of the non-thermal processing (the ablation processing).

A peeling processing operation is another example of the processing operation for changing the shape of the workpiece W. The peeling processing operation is a processing operation for peeling the surface of the workpiece W. In this case, the peeling processing operation may be regarded as a processing operation for changing the shape of the workpiece W by peeling the surface of the workpiece W. A welding processing operation is another example of the processing operation for changing the shape of the workpiece W. The welding processing operation is a processing operation for welding (namely, joining) another object to the workpiece W. In this case, the welding processing operation may be regarded as a processing operation for changing the shape of the workpiece W by welding another object to the workpiece W. A cutting processing operation is another example of the processing operation for changing the shape of the workpiece W. The cutting processing operation is a processing operation for cutting the workpiece W. In this case, the cutting processing operation may be regarded as a processing operation for changing the shape of the workpiece W by cutting the workpiece W.

At least one of the processing heads 12 and 13 may form a desired structure on the surface of the workpiece W by processing the workpiece W. However, the processing unit 1 may perform a processing that is different from a processing for forming the desired structure on the surface of the workpiece W. A riblet structure is one example of the desired structure. The riblet structure may include a structure by which a resistance (especially at least one of a frictional resistance and a turbulent frictional resistance) of the surface of the workpiece W to a fluid is reducible. Therefore, the riblet structure may be formed on the workpiece W including a member that is positioned (in other words, disposed) in the fluid. Note that the fluid here means any medium (for example, at least one of gas and liquid) that flows relative to the surface of the workpiece W. For example, in a case where the surface of workpiece W moves relative to the medium although the medium itself is static, this medium may be referred to as the fluid. Note that a state where the medium is static may mean a state where the medium does not move relative to a predetermined reference object (for example, a ground surface).

At least one of an airplane, a vehicle, a motorcycle, a windmill, a turbine for an engine, and a turbine for a power generation is one example of the workpiece W on which the riblet structure is formed. In a case where the riblet structure is formed on the workpiece W, the workpiece W is movable relative to the fluid more easily. Therefore, the resistance that prevents the workpiece W from moving relative to the fluid is reduced, and thereby an energy saving is achievable. Namely, it is possible to manufacture the environmentally preferable workpiece W. For example, in a case where the workpiece W is a member exposed on a surface of the airplane (for example, at least a part of the airplane), the resistance that prevents the airplane from moving is reduced, and thereby a fuel saving of the airplane is achievable. For example, in a case where the workpiece W is a member forming an exterior body of the vehicle (for example, at least a part of the vehicle), the resistance that prevents the vehicle from moving is reduced, and thereby a fuel saving of the vehicle is achievable. For example, in a case where the workpiece W is a member forming an exterior body of the motorcycle (for example, at least a part of the motorcycle), the resistance that prevents the motorcycle from moving is reduced, and thereby a fuel saving of the motorcycle is achievable. For example, in a case where the workpiece W is the windmill (for example, at least a part of the windmill), the resistance that prevents the windmill from moving (typically, rotating) is reduced, and thereby a high efficiency of the windmill is achievable. For example, in a case where the workpiece W is the turbine for the engine (for example, at least a part of the turbine for the engine), the resistance that prevents the turbine for the engine from moving (typically, rotating) is reduced, and thereby a high efficiency or energy saving of the turbine for the engine is achievable. For example, in a case where the workpiece W is the turbine for the power generation (for example, at least a part of the turbine for the power generation), the resistance that prevents the turbine for the power generation from moving (typically, rotating) is reduced, and thereby a high efficiency of the turbine for the power generation (namely, an improvement of a power generation efficiency) is achievable. Therefore, there is a possibility that at least one of the processing heads 12 and 13 can contribute “13-2-2 Total Greenhous gas emission per year” in indicators included in Goal 13 (Take urgent action to combat climate change and its impact) of Sustainable Development Goals (SDGs) initiated by United Nations.

Each of the processing heads 12 and 13 performs the processing operation on the workpiece W placed on a below-described stage 21. Especially, in the first example embodiment, the stage 21 is contained in the inner space SP3 of the housing 3 as illustrated in FIG. 3. As a result, as illustrated in FIG. 3, the workpiece W placed on the stage 21 is also contained in the inner space SP3 of the housing 3. As a result, each of the processing heads 12 and 13 performs the processing operation on the workpiece W contained in the inner space SP3 of the housing 3. In this case, each of the processing heads 12 and 13 may be considered to perform the processing operation in the inner space SP3 of the housing 3. Incidentally, the inner space SP3 is referred to as a processing space SP3 in the below-described description, because processing operations are performed in the inner space SP3.

Each of the processing heads 12 and 13 may be positioned above the stage 21 on which the workpiece W is placed. Especially, in the first example embodiment, each of the processing heads 12 and 13 may be allowed to be positioned above the housing 3, because the stage 21 is contained in the processing space SP3 of the housing 3 as illustrated in FIG. 3. For example, each of the processing heads 12 and 13 may be attached to a gate-shaped support frame 52 that is positioned on a surface plate 51 of the processing system SYSa. Incidentally, the housing 3 may be positioned on the surface plate 51. The support frame 52 may include any structure as long as the support frame 52 is configured to support the processing heads 12 and 13 above the housing 3. In the examples illustrated in FIG. 2 and FIG. 3, the support frame 52 includes a pair of support frames 521 and a beam member 522. Each support frame 521 may include a pair of leg members 5211 that protrude from the surface plate 51 in the Z-axis direction and that are arranged along the Y-axis direction, and a beam member 5212 that extends in the Y-axis direction and that connects the pair of leg members 5211 through upper ends of the pair of leg members 5211. The housing 3 may be positioned between the pair of support frames 521. The beam member 522 extends in the X-axis direction and connects the pair of support frames 521 through upper ends of the pair of support frames 521. The beam member 522 may be positioned above the housing 3. Each of the processing heads 12 and 13 may be attached to the beam member 522. Incidentally, in the example illustrated in FIG. 2, each of the processing heads 12 and 13 a below-described head driving system 14:

In a case where the processing head 12 is positioned above the housing 3, the processing head 12 may irradiate the workpiece W contained in the processing space SP3 of the housing 3 by emitting the processing light EL downwardly from the processing head 12. Namely, the processing head 12 may irradiate the workpiece W contained in the processing space SP3 of the housing 3 with the processing light EL that propagates along the Z-axis direction by emitting the processing light EL that progresses along the Z-axis direction. Similarly, in a case where the processing head 13 is positioned above the housing 3, the processing head 13 may irradiate the workpiece W contained in the processing space SP3 of the housing 3 by emitting the processing light EL downwardly from the processing head 13. Namely, the processing head 13 may irradiate the workpiece W contained in the processing space SP3 of the housing 3 with the processing light EL that propagates along the Z-axis direction by emitting the processing light EL that propagates along the Z-axis.

However, as illustrated in FIG. 2 and FIG. 3, each of the processing heads 12 and 13, which is positioned above the housing 3, is typically positioned in an outer space SP1 outside the housing 3. The outer space SP1 is separated from the processing space SP3 by the housing 3. Therefore, there is a possibility that the processing light EL emitted from each of the processing heads 12 and 13 is shielded by the housing 3 before reaching the workpiece W. In the first example embodiment, in order to allow each of the processing heads 12 and 13 positioned in the outer space SP1 to process the workpiece W contained in the processing space SP3, an aperture 34 may be formed in the housing 3, as illustrated in FIG. 2 and FIG. 3. In this case, each of the processing heads 12 and 13 may process the workpiece W contained in the processing space SP3 through the aperture 34 formed in the housing 3. Incidentally, a structure of the housing 3 including the aperture 34 and the processing operation for processing the workpiece W through the aperture 34 will be described in detail later, so the description there of is omitted here.

Incidentally, at least one of the processing heads 12 and 13 may perform any operation that is different from the processing operation for processing the workpiece W, in addition to the processing operation for processing the workpiece W, under the control of the control unit 4. At least one of the processing heads 12 and 13 may perform any operation that is different from the processing operation for processing the workpiece W, instead of the processing operation for processing the workpiece W, under the control of the control unit 4. However, in the below-described description, an example in which at least one of the processing heads 12 and 13 performs the processing operation will be described for convenience of description. Incidentally, in a case where the processing head 12 is configured to perform any operation, the processing head 12 may be referred to simply as a head. In a case where the processing head 13 is configured to perform any operation, the processing head 13 may be referred to simply as a head.

A measurement operation for measuring the workpiece W (alternatively, any object that is different from the workpiece W) is one example of any operation that is different from the processing operation. Incidentally, in a case where the processing head 12 is configured to perform the measurement operation, the processing head 12 may be referred to as a measurement head. In a case where the processing head 13 is configured to perform the measurement operation, the processing head 13 may be referred to as a measurement head.

A holding operation for holding the workpiece W (alternatively, any object that is different from the workpiece W) is one example of any operation that is different from the processing operation. For example, at least one of the processing heads 12 and 13 may perform the holding operation by using an end effector that is configured to hold the workpiece W. Incidentally, in a case where the processing head 12 is configured to perform the holding operation, the processing head 12 may be referred to as a holding head. In a case where the processing head 13 is configured to perform the holding operation, the processing head 13 may be referred to as a holding head.

A cleaning operation for cleaning the workpiece W (alternatively, any object that is different from the workpiece W) is one example of any operation that is different from the processing operation. For example, at least one of the processing heads 12 and 13 may perform the cleaning operation by using a member configured to clean the workpiece W. Incidentally, in a case where the processing head 12 is configured to perform the cleaning operation, the processing head 12 may be referred to as a cleaning head. In a case where the processing head 13 is configured to perform the cleaning operation, the processing head 13 may be referred to as a cleaning head.

The head driving system 14 moves each of the processing heads 12 and 13 under the control of the control unit 4. For example, the head driving system 14 may move each of the processing heads 12 and 13 along at least one of the X-axis direction, the Y-axis direction, and the Z-axis direction, for example. The head driving system 14 may move each of the processing heads 12 and 13 along at least one of the OX direction, the OY direction, and the OZ direction, in addition to or instead of at least one of the X-axis direction, the Y-axis direction, and the Z-axis direction, for example. Namely, the head driving system 14 may rotate each of the processing heads 12 and 13 around at least one axis of a rotational axis along the X-axis direction (namely, an A-axis), a rotational axis along the Y-axis direction (namely, a B-axis), and a rotational axis along the Z-axis direction (namely, a C-axis). Incidentally, the head driving system 14 may be referred to as a movement apparatus or a driving apparatus.

In the first example embodiment, the head driving system 14 moves each of the processing heads 12 and 13 along the X-axis direction, the Y-axis direction, and the Z-axis direction. In this case, as illustrated in FIG. 2 and FIG. 3, the head driving system 14 may include a pair of Y guide members 141Y, an X guide member 141X, an X slide member 142X#1, an X slide member 142X#2, a Z guide member 141Z#1, and a Z guide member 141Z#2. The pair of Y guide members 141Y are a pair of shaft members that extend in the Y-axis direction. The pair of Y guide members 141Y are positioned on the pair of support frames 521 (especially, the pair of beam members 5212). The beam member 522 of the support frame 52 is attached to the pair of Y guide members 141Y so that the beam member 522 of the support frame 52 is movable along the pair of Y guide members 141Y. The X guide member 141X is a shaft member that extend in the X-axis direction. The X guide member 141X is positioned on the beam member 522. Each of the X-slide members 142X#1 and 142X#2 are attached to the X guide member 141X so that each of the X slide members 142X#1 and 142X#2 is movable along the X guide member 141X. Each of the Z guide members 141Z#1 to 141Z#2 is a shaft member that extends in the Z-axis direction. The Z guide members 141Z#1 to 141Z#2 are positioned on the X slide members 142X#1 to 142X#2, respectively. The processing head 12 is attached to the Z guide member 141Z#1 so that the processing head 12 is movable along the Z guide member 141Z#1. The processing head 13 is attached to the Z guide member 141Z#2 so that the processing head 13 is movable along the Z guide member 141Z#2.

When the beam member 522 moves along the pair of Y guide members 141Y, the processing head 12, which is attached to the beam member 522 through the X guide member 141X, the X slide member 142X#1, and the Z guide members 141Z#1, moves along the Y-axis direction. Furthermore, when the X slide member 142X#1 moves along the X guide member 141X, the processing head 12, which is attached to the X slide member 142X#1 through the Z guide member 141Z#1, moves along the X-axis direction. Furthermore, when the processing head 12 moves along the Z guide member 141Z#1, the processing head 12 moves along the Z-axis direction.

When the beam member 522 moves along the pair of Y guide members 141Y, the processing head 13, which is attached to the beam member 522 through the X guide member 141X, the X slide member 142X#2, and the Z guide members 141Z#2, moves along the Y-axis direction. Furthermore, when the X slide member 142X#2 moves along the X guide member 141X, the processing head 13, which is attached to the X slide member 142X#2 through the Z guide member 141Z#2, moves along the X-axis direction. Furthermore, when the processing head 13 moves along the Z guide member 141Z#2, the processing head 13 moves along the Z-axis direction.

Incidentally, in the above-described description, since both of the processing heads 12 and 13 are positioned on the beam member 522, both of the processing heads 12 and 13 move simultaneously in the Y-axis direction due to the movement of the beam member 522. However, the processing head 12 may move in the Y-axis direction independently of the movement of the processing head 13 in the Y-axis direction. Similarly, the processing head 13 may move in the Y-axis direction independently of the movement of the processing head 12 in the Y-axis direction. As one example, the processing head 12 may be positioned on a first beam member 522, and the processing head 13 may be positioned on a second beam member 522 that is different from the first beam member 522. In this case, the processing head 12 may move in the Y-axis direction due to the movement of the first beam member 522 independently of the movement of the processing head 13 the Y-axis direction. The processing head 13 may move in the Y-axis direction due to the movement of the second beam member 522 independently of the movement of the processing head 12 in the Y-axis direction.

The stage unit 2 includes the stage 21 and a stage driving system 22. However, the stage unit 2 may not include the stage driving system 22.

The stage 21 is a placing apparatus on which the workpiece W is placed. The stage 21 is configured to support the workpiece W placed on the stage 21. The stage 21 may be configured to hold the workpiece W placed on the stage 21. In this case, stage 21 may include at least one of a mechanical chuck, a magnetic chuck, an electrostatic chuck, and a vacuum suction chuck in order to hold the workpiece W. Alternatively, a jig for holding the workpiece W may hold the workpiece W, and the stage 21 may hold the jig holding the workpiece W. Alternatively, the stage 21 may not hold the workpiece W placed on the stage 21. In this case, the workpiece W may be placed on the stage 21 without clamp.

The stage driving system 22 moves the stage 21. Therefore, the stage driving system 22 may be referred to as a movement apparatus. The stage driving system 22 may move (namely, linearly move) the stage 21 along a movement axis that is along at least one of the X-axis direction, the Y-axis direction, and the Z-axis direction, for example. The stage driving system 22 may move the stage 21 along at least one of the OX direction, the OY direction, and the OZ direction, in addition to or instead of at least one of the X-axis direction, the Y-axis direction, and the Z-axis direction, for example. Namely, the stage driving system 22 may rotate (namely, rotationally move) the stage 21 around at least one axis of the rotational axis along the X-axis direction (namely, the A-axis), the rotational axis along the Y-axis direction (namely, the B-axis), and a rotational axis along the Z-axis direction (namely, the C-axis).

The housing 3 contains at least a part of the stage unit 2 in the processing space SP3 as described above. Especially, in the first example embodiment, the housing 3 contains at least the stage 21 of the stage unit 2 in the processing space SP3.

In order to contain the stage 21, the housing 3 includes a bottom member 31, a side wall member 32, and a ceiling member 33. The bottom member 31 is positioned on the surface plate 51. The bottom member 31 is a plate-shaped member that is along the XY plane. The side wall member 32 is a cylindrical member that protrudes from an outer edge of the bottom member 31 in the Z-axis direction. The ceiling member 33 is positioned on an upper end of the side wall member 32. The ceiling member 33 is a plate-shaped member that is along the XY plane.

The housing 3 forms the processing space SP3 by using the bottom member 31, the side wall member 32, and the ceiling member 33. Specifically, a space surrounded by the bottom member 31, the side wall member 32, and the ceiling member 33 is used as the processing space SP3. In this case, each of the bottom member 31, the side wall member 32, and the ceiling member 33 may be considered to serve as at least a part of a wall member that forms (in other words, defines) the processing space SP3.

Incidentally, the housing 3 may form the processing space SP3 by using other member in addition to or instead of at least one of the bottom member 31, the side wall member 32, and the ceiling member 33. For example, the housing 3 may include an openable and closable door. The openable and closable door may be opened to take out the workpiece W positioned in the processing space SP3 from the processing space SP3. The openable and closable door may be opened to place a new workpiece W in the processing space SP3. The openable and closable door may be closed in a case where the workpiece W is lowered in the processing space SP3. In this case, the housing 3 may form the processing space SP3 by using the openable and closable door in addition to or instead of at least one of the bottom member 31, the side wall member 32, and the ceiling member 33.

Moreover, the housing 3 may form the processing space SP3 in cooperation with at least a part of a member that is different from the housing 3, in addition to or instead of at least one of the bottom member 31, the side wall member 32, and the ceiling member 33. Namely, at least a part of the member that is different from the housing 3 may form (in other words, define) the processing space SP3. For example, the housing 3 may form the processing space SP3 in cooperation with at least a part of the surface plate 51. For example, the housing 3 may form the processing space SP3 in cooperation with at least a part of the support frame 52. For example, the housing 3 may form the processing space SP3 in cooperation with at least a part of the stage 21.

The housing 3 may be considered to spatially separate the processing space SP3 from the outer space SP1, which is outside the housing 3, by using the bottom member 31, the side wall member 32, and the ceiling member 33. In this case, each of the bottom member 31, the side wall member 32, and the ceiling member 33 may be considered to serve as a partition apparatus that forms (in other words, defines) the processing space SP3, which is spatially separated from the outer space SP1. Moreover, each of the bottom member 31, the side wall member 32, and ceiling member 33 may be considered to serve as a partitioning apparatus that defines a part of the processing space SP3, which is spatially separated from the outer space SP1.

However, at least a part of the processing space SP3 may not be spatially separated from the outer space SP1. For example, in a case where the processing space SP3 may not be purged with the purge gas, at least a part of the processing space SP3 may not be spatially separated from the outer space SP1. For example, in a case where the processing space SP3 may not be vacuumed, at least a part of the processing space SP3 may not be spatially separated from the outer space SP1. In this case, an aperture may be formed in at least one of the bottom member 31, the side wall member 32, and the ceiling member 33, which serves as the partition apparatus. The housing 3 may not include at least one of the bottom member 31, the side wall member 32, and the ceiling member 33, which serves as the partition apparatus. Alternatively, the processing system SYSa may not include the housing 3 in the first place.

The processing space SP3 may include a space in which the stage 21 is contained. The processing space SP3 may include a space in which the workpiece W placed on the stage 21 is contained. The processing space SP3 may include a space in which the processing operation is performed on the workpiece W. On the other hand, the outer space SP1 may include a space in which the surface plate 51 is positioned. The outer space SP1 may include a space in which the processing heads 12 and 13 are positioned. The outer space SP1 may include a space in which a support frame 52 that supports the processing heads 12 and 13 is positioned.

The housing 3 may restrict a flow of gas between the processing space SP3 and the outer space SP1 by using the bottom member 31, the side wall member 32, and the ceiling member 33. As one example, the housing 3 may restrict an outflow of the gas from the processing space SP3 to the outer space SP1. For example, the housing 3 may restrict the outflow of the gas from the processing space SP3 to the outer space SP1 so that an amount of the outflow of the gas from the processing space SP3 to the outer space SP1 is limited to be equal to or smaller than an allowable amount. As one example, the housing 3 may restrict an inflow of the gas from the outer space SP1 to the processing space SP3. For example, the housing 3 may restrict the inflow of the gas from the outer space SP1 to the processing space SP3 so that an amount of the inflow of the gas from the outer space SP1 to the processing space SP3 is limited to be equal to or smaller than an allowable amount. In other words, the processing space SP3 may be regarded as a space in which the flow of the gas from/to the outer space SP1 is restricted.

As described above, the aperture 34, which is usable by the processing heads 12 and 13 to perform the processing operation on the workpiece W, is formed in the housing 3. In the examples illustrated in FIG. 2 and FIG. 3, the aperture 34 is formed in the ceiling member 33. However, the aperture 34 may be formed in a member of the housing 3 that is different from the ceiling member 33. For example, the aperture 34 may be formed in the side wall member 32 of the housing 3. For example, the aperture 34 may be formed in the bottom member 31.

The aperture 34 is a through-hole that penetrates the ceiling member 33. In this case, the aperture 34 may be considered to connect the processing space SP3 of the housing 3 and the outer space SP1 that is outside the housing 3. The processing space SP3 of the housing 3 and the outer space SP1 that is outside the housing 3 may be considered to be connected through the aperture 34.

In order to process the workpiece W, each of the processing heads 12 and 13 may be inserted into the aperture 34. Specifically, the processing head 12 may move along the Z-axis direction so that the processing head 12 is inserted into the aperture 34. The processing head 13 may move along the Z-axis direction so that the processing head 13 is inserted into the aperture 34. In this case, at least a part of each of the processing heads 12 and 13 is positioned in the processing space SP3. Especially, each of the processing heads 12 and 13 may be inserted into the aperture 34 so that an emission port, from which the processing light EL is emitted, of each of the processing heads 12 and 13 is positioned in the processing space SP3. As a result, each of the processing heads 12 and 13 can emit the processing light EL in the processing space SP3. The processing light EL emitted from each of the processing heads 12 and 13 in the processing space SP3 may propagates in the processing space SP3 to reach the workpiece W.

Incidentally, in a case where the processing space SP3 of the housing 3 is vacuumed as described above, the processing space SP3 may be vacuumed after each of the processing heads 12 and 13 is inserted into the aperture 34. Namely, the vacuuming of the processing space SP3 may be started after each of the processing heads 12 and 13 is inserted into the aperture 34.

Moreover, in a case where the processing space SP3 of the housing 3 is purged with the purge gas as described above, the processing space SP3 may be purged with purge gas after each of the processing heads 12 and 13 is inserted into the aperture 34. Namely, the purging of the processing space SP3 with purge gas may be started after each of the processing heads 12 and 13 is inserted into the aperture 34.

Alternatively, in order to process the workpiece W through the aperture 34, each of the processing heads 12 and 13 may process the workpiece W by irradiating the workpiece W with the processing light EL from the outer space SP1 through the aperture 34. Specifically, each of the processing heads 12 and 13 may emit the processing light EL in the outer space SP1. In this case, each of the processing heads 12 and 13 may not be inserted into the aperture 34. Namely, the processing head 12 may emit the processing light EL in the outer space SP1 in a state where the processing head 12 is not inserted into the aperture 34. The processing head 13 may emit the processing light EL in the outer space SP1 in a state where the processing head 13 is not inserted into the aperture 34. The processing light EL, which has been emitted from each of the processing heads 12 and 13 in the outer space SP1, may pass through the aperture 34 to reach the workpiece W.

In the below-described description, an example in which each of the processing heads 12 and 13 for processing the workpiece W is inserted into the aperture 34 will be described for convenience of description. Incidentally, a description of an operation for inserting each of the processing heads 12 and 13 into the aperture 34 is omitted here, because it will be described in detail later.

A single aperture 34 is formed in the housing 3. In this case, either one of the processing heads 12 and 13 may be inserted into the aperture 34 exclusively. For example, in a case where either one of the processing heads 12 and 13 is inserted into the aperture 34, the other one of the processing heads 12 and 13 may not be inserted into the aperture 34.

A shape of the aperture 34 may be the same as a shape of a cross-section of each of the processing heads 12 and 13. Specifically, the shape of the aperture 34 along the XY plane may be the same as the shape of the cross-section of each of the processing heads 12 and 13 along the XY plane. For example, FIG. 2 illustrates an example in which the shape of the aperture 34 is a rectangular shape and the shape of the cross-section of each of the processing heads 12 and 13 is a rectangular shape. Alternatively, for example, the shape of the aperture 34 may be a circular shape and the shape of the cross-section of each of the processing heads 12 and 13 may be a circular shape. However, the shape of the aperture 34 may not be the same as the shape of the cross-section of at least one of the processing heads 12 and 13.

The shape of the aperture 34 may be the same as the shape of the cross-section of each of the processing heads 12 and 13 at a position of the aperture 34 in a state where each of the processing heads 12 and 13 is inserted into the aperture 34. In other words, the shape of the cross-section of each of the processing heads 12 and 13 at a position, which is other than the position of the aperture 34 in a state where each of the processing heads 12 and 13 is inserted into the aperture 34, may be different from the shape of the aperture 34.

A size of the aperture 34 may be set based on a size of each of the processing heads 12 and 13. Specifically, the size of the aperture 34 in a certain one direction along the XY plane may be set based on the size of each of the processing heads 12 and 13 in the same one direction. For example, the size of the aperture 34 may be set to a desired size that is larger than the size of each of the processing heads 12 and 13 so that each of the processing heads 12 and 13 is insertable into the aperture 34. For example, the size of the aperture 34 may be set to a desired size that is larger than the size of each of the processing heads 12 and 13 so that either one of the processing heads 12 and 13 is insertable into the aperture 34 exclusively.

The processing head 12 that has been inserted into the aperture 34 may be used as a member for ensuring an air sealing of the processing space SP3 of the housing 3 together with the housing 3. Namely, the processing head 12 that has been inserted into the aperture 34 may be used as a member for restricting the flow of the gas between the processing space SP3 and the outer space SP1 together with the housing 3. Similarly, the processing head 13 that has been inserted into the aperture 34 may be used as a member for ensuring an air sealing of the processing space SP3 of the housing 3 together with the housing 3. Namely, the processing head 13 that has been inserted into the aperture 34 may be used as a member for restricting the flow of the gas between the processing space SP3 and the outer space SP1 together with the housing 3. Here, a state where “the processing head 12 or 13 that has been inserted into the aperture 34 has a function of ensuring the air sealing of the processing space SP3 of the housing 3” may mean a state where an insertion of the processing heads 12 and 13 into the aperture 34 allows a degree of the air sealing of the processing space SP3 in a state where the processing head 12 or 13 is inserted into the aperture 34 is better than a degree of the air sealing of the processing space SP3 in the state where the processing head 12 or 13 is not inserted into the aperture 34.

However, it is more difficult for the housing 3 to restrict the flow of the gas between the processing space SP3 and the outer space SP1 as a gap existing in the aperture 34 into which each of the processing heads 12 and 13 has been inserted is larger. Therefore, the size of the aperture 34 may be set to a desired size that is larger than the size of each of the processing heads 12 and 13 so that the housing 3 can properly restrict the flow of the gas between the processing space SP3 and the outer space SP1. As one example, the size of the aperture 34 may be set to a desired size that larger than the size of each of the processing heads 12 and 13 so that a size of the gap existing in the aperture 34 into which each of the processing heads 12 and 13 has been inserted is smaller than an allowable amount.

Alternatively, an air sealing member for ensuring the air sealing of the processing space SP3 may be positioned in the aperture 34 so that the housing 3 can properly restrict the flow of the gas between the processing space SP3 and the outer space SP1. A packing such as an O-rings and a lip packing is one example of the air sealing member.

Especially in the first example embodiment, the aperture 34 into which each of the processing heads 12 and 13 is inserted is movable. Specifically, the aperture 34 may be movable in a plane along the XY plane. The aperture 34 may be movable along at least one of the X-axis direction and the Y-axis direction. Incidentally, the aperture 34 may be movable along the Z-axis direction.

In the example illustrated in FIG. 2 and FIG. 3, an upper surface of the ceiling member 33 is a surface that is along the XY plane. Therefore, the aperture 34, which is movable in the plane along the XY plane, may be considered to be movable along the upper surface of the ceiling member 33.

In the example illustrated in FIG. 2 and FIG. 3, a direction in which each of the processing heads 12 and 13 is inserted into the aperture 34 is the Z-axis direction that intersects the XY plane. Therefore, the aperture 34, which is movable in the plane along the XY plane, may be considered to be movable along a direction that intersects the direction in which each of the processing heads 12 and 13 is inserted into the aperture 34.

In the example illustrated in FIG. 2 and FIG. 3, the processing light EL emitted from each of the processing heads 12 and 13 propagates along the Z-axis direction. Therefore, the aperture 34, which is movable in the plane along the XY plane, may be considered to be movable along a direction that intersects a propagating direction of the processing light EL emitted from each of the processing heads 12 and 13.

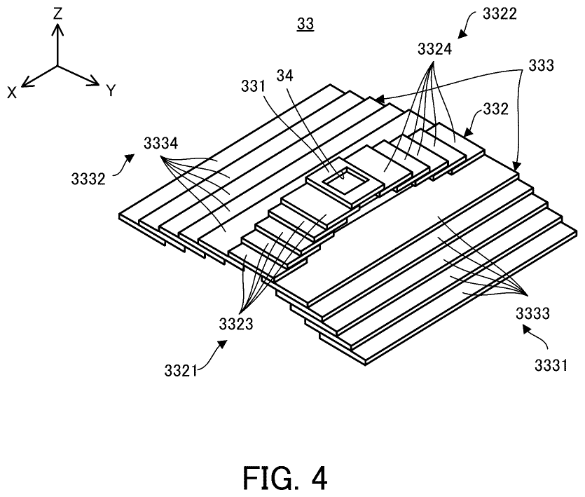

FIG. 4 illustrates one example of the ceiling member 33 in which the movable aperture 34 is formed. FIG. 4 is a perspective view that illustrates one example of a structure of the ceiling member 33 in which the movable aperture 34 is formed. As illustrated in FIG. 4, the ceiling member 33 may include an aperture member 331, a support member 332, and a support member 333.

The aperture member 331 is a plate-shaped member. The aperture member 331 is a member in which the aperture 34 is formed.

The support member 332 is a member that is configured to support the aperture member 331. Especially, the support member 332 is a member that is configured to support the aperture member 331 so that the aperture member 331 is movable in a first direction along the XY plane. In the example illustrated in FIG. 4, the support member 332 is a member that is configured to support the aperture member 331 so that the aperture member 331 is movable in the X-axis direction.

In order to support the aperture member 331 so that the aperture member 331 is movable along the X-axis direction, the support member 332 includes a support member 3321 and a support member 3322. The support member 3321 includes a plurality of support plates 3323. The support member 3322 includes a plurality of support plates 3324. The plurality of support plates 3323 are combined (in other words, connected or linked) so that the support member 3321 is allowed to expand and contract along the X-axis direction in an area at an +X side of the aperture member 331. In the example illustrated in FIG. 4, the plurality of support plates 3323 are provided so that at least a part of them overlap each other along the X-axis direction in the area at the +X side of the aperture member 331. In this case, when at least one of the plurality of support plates 3323 moves along the X-axis direction, a size of the support member 3321 along the X-axis direction, in other words, a total size of the plurality of support plates 3323, changes. Namely, the support member 3321 expands and contracts along the X-axis direction. One support plate 3323, which is positioned at the most-X-side, of the plurality of support plates 3323 is connected to the aperture member 331. The plurality of support plates 3324 are combined (in other words, connected or linked) so as to be allowed to expand and contract along the X-axis direction in an area at an −X side of the aperture member 331. In the example illustrated in FIG. 4, the plurality of support plates 3324 are provided so that at least a part of them overlap each other along the X-axis direction in the area at the −X side of the aperture member 331. In this case, when at least one of the plurality of support plates 3324 moves along the X-axis direction, a size of the support member 3322 along the X-axis direction, in other words, a total size of the plurality of support plates 3324, changes. Namely, the support member 3322 expands and contracts along the X-axis direction. One support plate 3324, which is positioned at the most +X-side, of the plurality of support plates 3324 is connected to the aperture member 331.

As a result, the expansion and the contraction of the support members 3321 and 3322 allows the aperture member 331 to move along the X-axis direction. Specifically, in a case where at least one of the plurality of support plates 3323 moves so that the size of the support member 3321 in the X-axis direction becomes shorter and at least one of the plurality of support plates 3324 moves so that the size of the support member 3322 in the X-axis direction becomes longer, the aperture member 331 moves toward the +X side along the X-axis direction. As a result, the aperture 34 formed in the aperture member 331 moves toward the +X side along the X-axis direction. On the other hand, in a case where at least one of the plurality of support plates 3323 moves so that the size of the support member 3321 in the X-axis direction becomes longer and at least one of the plurality of support plates 3324 moves so that the size of the support member 3322 in the X-axis direction becomes shorter, the aperture member 331 moves toward the −X side along the X-axis direction. As a result, the aperture 34 formed in the aperture member 331 moves toward the −X side along the X-axis direction.

However, at least one of the support members 3321 and 3322 may not be allowed to be expand and contract. At least one of the support members 3321 and 3322 may move the aperture member 331 along the X-axis without expanding and contracting. For example, at least one of the support members 3321 and 3322 may move the aperture member 331 along the X-axis by moving along the X-axis direction.

At least two of the plurality of support plates 3323 of the support member 3321 may be connected through a bellows-shaped connection member. In this case, the support member 3321 may expand and contract by changing a distance between at least two of the plurality of support plates 3323 that are connected through the bellows-shaped connection member. Similarly, at least two of the plurality of support plates 3324 of the support member 3322 may be connected through a bellows-shaped connection member. In this case, the support member 3322 may expand and contract by changing a distance between at least two of the support plates 3324 that are connected through the bellows-shaped connection member.

At least two of the plurality of support plates 3323 of the support member 3321 may be connected through a pantograph. In this case, the support member 3321 may expand and contract by the pantograph moving the plurality of support plates 3323. Similarly, at least two of the plurality of support plates 3324 of the support member 3322 may be connected through a pantograph. In this case, the support member 3322 may extend or contract by the pantograph moving the plurality of support plates 3324.

The plurality of support plates 3323 may be combined so as to ensure the air sealing of the processing space SP3. For example, the plurality of support plates 3323 may be combined so that an amount of the gas flowing from the processing space SP3 into the outer space SP1 through the gap between the plurality of support plates 3323 is limited to be equal to or smaller than an allowable amount. For example, the plurality of support plates 3323 may be combined so that an amount of the gas flowing from the outer space SP1 into the processing space SP3 through the gap between the plurality of support plates 3323 is limited to be equal to or smaller than an allowable amount.

The plurality of support plates 3324 may be combined so as to ensure the air sealing of the processing space SP3. For example, the plurality of support plates 3324 may be combined so that an amount of the gas flowing from the processing space SP3 into the outer space SP1 through the gap between the plurality of support plates 3324 is limited to be equal to or smaller than an allowable amount. For example, the plurality of support plates 3324 may be combined so that an amount of the gas flowing from the outer space SP1 into the processing space SP3 through the gap between the plurality of support plates 3324 is limited to be equal to or smaller than an allowable amount.

The support member 333 is a member that is configured to support the support member 332. Especially, the support member 333 is a member that is configured to support the support member 332 so that the support member 332 is movable in a second direction along the XY plane. The second direction in which the support member 332 moves may be a direction that intersects the first direction in which the aperture member 331 moves. In the example illustrated in FIG. 4, the support member 333 is a member that is configured to support the support member 332 so that the support member 332 is movable in the Y-axis direction.

Incidentally, since the support member 332 supports the aperture member 331, the support member 333 may be considered to support the aperture member 331 through the support member 332. The support member 333 may be considered to indirectly support the aperture member 331 through the support member 332. Especially, the aperture member 331 supported by the support member 332 moves along the second direction when the support member 332 moves along the second direction, and therefore, the support member 333 may be regarded as a member that is configured to support the aperture member 331 so that the aperture member 331 is movable in the second direction along the XY plane. In the example illustrated in FIG. 4, the support member 333 may be regarded a member that is configured to support the aperture member 331 so that the aperture member 331 is movable along the Y-axis direction.

In order to support the support member 332 so that the support member 332 is movable along the Y-axis direction, the support member 333 includes a support member 3331 and a support member 3332. The support member 3331 includes a plurality of support plates 3333. The support member 3332 includes a plurality of support plates 3334. The plurality of support plates 3333 are combined (in other words, connected or linked) so that the support member 3331 is allowed to expand and contract along the Y-axis direction in an area at an +Y side of the support member 332. In the example illustrated in FIG. 4, the plurality of support plates 3333 are provided so that at least a part of them overlap each other along the Y-axis direction in the area at the +Y side of the support member 332. In this case, when at least one of the plurality of support plates 3333 moves along the Y-axis direction, a size of the support member 3331 along the Y-axis direction, in other words, a total size of the plurality of support plates 3333, changes. Namely, the support member 3331 expands and contracts along the Y-axis direction. One support plate 3333, which is positioned at the most −Y-side, of the plurality of support plates 3333 is connected to the support member 332. The plurality of support plates 3334 are combined (in other words, connected or linked) so as to be allowed to expand and contract along the Y-axis direction in an area at an −Y side of the support member 332. In the example illustrated in FIG. 4, the plurality of support plates 3334 are provided so that at least a part of them overlap each other along the Y-axis direction in the area at the −Y side of the support member 332. In this case, when at least one of the plurality of support plates 3334 moves along the Y-axis direction, a size of the support member 3332 along the Y-axis direction, in other words, a total size of the plurality of support plates 3334, changes. Namely, the support member 3332 expands and contracts along the Y-axis direction. One support plate 3334, which is positioned at the most +Y-side, of the plurality of support plates 3334 is connected to the support member 332.

As a result, the expansion and the contraction of the support members 3331 and 3332 allows the support member 332 to move along the Y-axis direction. As a result, the aperture member 331 supported by the support member 332 is also movable along the Y-axis. Specifically, in a case where at least one of the plurality of support plates 3333 moves so that the size of the support member 3331 in the Y-axis direction becomes shorter and at least one of the plurality of support plates 3334 moves so that the size of the support member 3332 in the Y-axis direction becomes longer, the support member 332 moves toward the +Y side along the Y-axis direction. As a result, the aperture member 331 supported by the support member 332 is also movable toward the +Y side along the Y-axis direction. As a result, the aperture 34 formed in the support member 332 moves toward the +Y side along the Y-axis direction. On the other hand, in a case where at least one of the plurality of support plates 3333 moves so that the size of the support member 3331 in the Y-axis direction becomes longer and at least one of the plurality of support plates 3334 moves so that the size of the support member 3332 in the Y-axis direction becomes shorter, the support member 332 moves toward the −Y side along the Y-axis direction. As a result, the aperture member 331 supported by the support member 332 is also movable toward the −Y side along the Y-axis direction. As a result, the aperture 34 formed in the support member 332 moves toward the −Y side along the Y-axis direction.

However, at least one of the support members 3331 and 3332 may not be allowed to be expand and contract. At least one of the support members 3331 and 3332 may move the aperture member 331 along the Y-axis without expanding and contracting. For example, at least one of the support members 3331 and 3332 may move the aperture member 331 along the Y-axis by moving along the Y-axis direction.

At least two of the plurality of support plates 3333 of the support member 3331 may be connected through a bellows-shaped connection member. In this case, the support member 3331 may expand and contract by changing a distance between at least two of the plurality of support plates 3333 that are connected through the bellows-shaped connection member. Similarly, at least two of the plurality of support plates 3334 of the support member 3332 may be connected through a bellows-shaped connection member. In this case, the support member 3332 may expand and contract by changing a distance between at least two of the support plates 3334 that are connected through the bellows-shaped connection member.

At least two of the plurality of support plates 3333 of the support member 3331 may be connected through a pantograph. In this case, the support member 3331 may expand and contract by the pantograph moving the plurality of support plates 3333. Similarly, at least two of the plurality of support plates 3334 of the support member 3332 may be connected through a pantograph. In this case, the support member 3332 may extend or contract by the pantograph moving the plurality of support plates 3334.

The plurality of support plates 3333 may be combined so as to ensure the air sealing of the processing space SP3. For example, the plurality of support plates 3333 may be combined so that an amount of the gas flowing from the processing space SP3 into the outer space SP1 through the gap between the plurality of support plates 3333 is limited to be equal to or smaller than an allowable amount. For example, the plurality of support plates 3333 may be combined so that an amount of the gas flowing from the outer space SP1 into the processing space SP3 through the gap between the plurality of support plates 3333 is limited to be equal to or smaller than an allowable amount.

The plurality of support plates 3334 may be combined so as to ensure the air sealing of the processing space SP3. For example, the plurality of support plates 3334 may be combined so that an amount of the gas flowing from the processing space SP3 into the outer space SP1 through the gap between the plurality of support plates 3334 is limited to be equal to or smaller than an allowable amount. For example, the plurality of support plates 3334 may be combined so that an amount of the gas flowing from the outer space SP1 into the processing space SP3 through the gap between the plurality of support plates 3334 is limited to be equal to or smaller than an allowable amount.

Incidentally, a telescopic cover that is used in a machine tool may be used as at least one of the support members 332 and 333. Moreover, the above-described ceiling member 33 has a layered structure which is allowed to expand and contract and in which at least a part of the plurality of support plates are positioned to overlap and a position of the aperture 34 is moved by changing a degree of an overlap of at least a part of the plurality of support plates. However, the ceiling member 33 may have a bellows structure, a winding structure, or a telescopic structure. Alternatively, the ceiling member 33 may have a structure obtained by combining at least two of the layered structure, the bellows structure, the winding structure, or the telescopic structure.

Moreover, a protection cover that is used in the machine tool may be used as a ceiling member 33. In this case, the ceiling member 33 may serve as a protection cover that prevents unnecessary substance from entering the processing space SP3 from the outside of the processing space SP3. Liquid whose example is at least one of lubricating oil and water is one example of the unnecessary substance. At least one of a chip and a debris generated by a machining-processing is another example of the unnecessary substance.

The aperture member 331 may be movable in a state where the processing head 12 or 13 inserted into the aperture 34. In this case, the aperture member 331 may be movable along with a movement of the processing head 12 or 13 inserted into the aperture 34. Namely, the aperture member 331 may be movable in conjunction with the movement of the processing head 12 or 13 inserted into the aperture 34.

As described above, the processing head 12 or 13 is moved by the head driving system 14. Namely, the processing head 12 or 13 is moved by using a driving force applied to the processing head 12 or 13 from the head driving system 14. In this case, the aperture member 331 may be considered to be movable by the head driving system 14. The aperture member 331 may be considered to be movable by the driving force applied from the head driving system 14. The aperture member 331 may be considered to be movable by the driving force applied from the head driving system 14 to the processing head 12 or 13.

As described above, the processing head 12 or 13 irradiates the workpiece W with the processing light EL in a state where the processing head 12 or 13 is inserted into the aperture 34. In this case, the aperture member 331 may be movable in conjunction with the movement of the processing head 12 or 13 inserted into the aperture 34 in at least a part of a period during which the processing head 12 or 13 irradiates the workpiece W with the processing light EL.

The aperture member 331 may be movable in a state where the processing heads 12 and 13 are not inserted into the aperture 34. In this case, the aperture member 331 may be movable independently of the movement of the processing heads 12 or 13 inserted into the aperture 34. Namely, the aperture member 331 may be movable without being in conjunction with the movement of the processing heads 12 or 13 inserted into the aperture 34. Alternatively, the aperture member 331 may be movable along with the movement of the processing head 12 or 13 inserted into the aperture 34. The aperture member 331 may be movable in conjunction with the movement of the processing head 12 or 13 inserted into the aperture 34.

The aperture member 331 may not be movable independently of the movement of the processing head 12 or 13 inserted into the aperture 34. In this case, the housing 3 may not include a driving system for moving the aperture member 331 in which the aperture 34 is formed. As a result, the configuration of the housing 3 is simplified. Furthermore, even when the processing heads 12 or 13 moves, the ceiling member 33 continues to serve as a member surrounding the processing space SP3, and therefore, the air sealing of the processing space SP3 is properly ensured. However, the aperture member 331 may be movable independently of the movement of the processing head 12 or 13 inserted into the aperture 34.

Again in FIG. 1 to FIG. 3, the control unit 4 controls an operation of the processing system SYSa. For example, the control unit 4 may control an operation of the processing unit 1. For example, the control unit 4 may control an operation of at least one of the light source 11, the processing head 12, the processing head 13, and the head driving system 14 of the processing unit 1. For example, the control unit 4 may control an operation of the stage unit 2. For example, the control unit 4 may control an operation of the stage driving system 22 of the stage unit 2.

The control unit 4 may include a processor 41 and a storage apparatus 42, for example. The processor 41 may include at least one of a CPU (Central Processing Unit) and a GPU (Graphical Processing Unit), for example. The storage apparatus 42 may include a memory, for example. The control unit 4 serves as an apparatus for controlling the operation of the processing system SYSa by means of the processor 41 executing a computer program. The computer program is a computer program that allows the processor 41 to execute (namely, to perform) a below-described operation that should be executed by the control unit 4. Namely, the computer program is a computer program that allows the control unit 4 to function so as to make the processing system SYSa perform the below-described operation. The computer program executed by the processor 41 may be recorded in the storage apparatus 42 (namely, a recording medium) of the control unit 4, or may be recorded in any recording medium (for example, a hard disk or a semiconductor memory) that is built in the control unit 4 or that is attachable to the control unit 4. Alternatively, the processor 41 may download the computer program that should be executed from an apparatus positioned at the outside of the control unit 4 through a network interface.

The control unit 4 may not be positioned in the processing unit 1. For example, the control unit 4 may be positioned at the outside of the processing unit 1 as a server or the like. In this case, the control unit 4 may be connected to the processing unit 1 through a wired and/or wireless network (alternatively, a data bus and/or a communication line). A network using a serial-bus-type interface such as at least one of IEEE1394, RS-232x, RS-422, RS-423, RS-485, and USB may be used as the wired network. A network using a parallel-bus-type interface may be used as the wired network. A network using an interface that is compatible to Ethernet (a registered trademark) such as at least one of 10-BASE-T, 100BASE-TX or 1000BASE-T may be used as the wired network. A network using an electrical wave may be used as the wireless network. A network that is compatible to IEEE802.1x (for example, at least one of a wireless LAN and Bluetooth (registered trademark)) is one example of the network using the electrical wave. A network using an infrared ray may be used as the wireless network. A network using an optical communication may be used as the wireless network. In this case, the control unit 4 and the processing unit 1 may be configured to transmit and receive various information through the network. Moreover, the control unit 4 may be configured to transmit information such as a command and a control parameter to the processing unit 1 through the network. The processing unit 1 may include a receiving apparatus that receives the information such as the command and the control parameter from the control unit 4 through the network. The processing unit 1 may include a transmitting apparatus that transmits the information such as a command and a control parameter to the control unit 4 (namely, an output apparatus that outputs the information to the control unit 4) through the network. Alternatively, a first control apparatus that performs a part of the processing performed by the control unit 4 may be positioned in the processing unit 1 and a second control apparatus that performs another part of the processing performed by the control unit 4 may be positioned at the outside of the processing unit 1.

An arithmetic model that is buildable by machine learning may be implemented in the control unit 4 by the processor 41 executing the computer program. One example of the arithmetic model that is buildable by the machine learning is an arithmetic model including a neural network (so-called Artificial Intelligence (AI)), for example. In this case, the learning of the arithmetic model may include learning of parameters of the neural network (for example, at least one of weights and biases). The control unit 4 may control the operation of the processing system SYSa by using the arithmetic model. Namely, the operation for controlling the operation of the processing system SYSa may include an operation for controlling the operation of the processing system SYSa by using the arithmetic model. Note that the arithmetic model that has been built by off-line machine learning using training data may be implemented in the control unit 4. Moreover, the arithmetic model implemented in the control unit 4 may be updated by online machine learning on the control unit 4. Alternatively, the control unit 4 may control the operation of the processing system SYSa by using the arithmetic model implemented in an apparatus positioned at an outside of the control unit 4 (namely, an apparatus positioned at an outside of the processing system SYSa), in addition to or instead of the arithmetic model implemented on the control unit 4.

Note that the recording medium recording therein the computer program that should be executed by the control unit 4 may include an optical disc such as a CD-ROM, a CD-R, a CD-RW, a flexible disc, a MO, a DVD-ROM, a DVD-RAM, a DVD-R, a DVD+R, a DVD-RW, a DVD+RW and a Blu-ray (registered trademark), a magnetic disc such as a magnetic tape, an optical-magnetic disc, a semiconductor memory such as a USB memory, and another medium that is configured to store the program. The recording medium may include a device that is configured to record the computer program (for example, a device for a universal use or a device for an exclusive use in which the computer program is embedded to be executable in a form of at least one of a software, a firmware, and the like). Moreover, each processor 41 function included in the computer program may be realized by a logical process block that is realized in the control unit 4 by means of the control unit 4 (namely, a computer) executing the computer program, may be realized by a hardware such as a predetermined gate array (a FPGA (Field Programmable Gate Array), an ASIC (Application Specific Integrated Circuit)) of the control unit 4, or may be realized in a form in which the logical process block and a partial hardware module that realizes an partial element of the hardware are combined.

### (1-1-2) Configuration of Processing Head 12

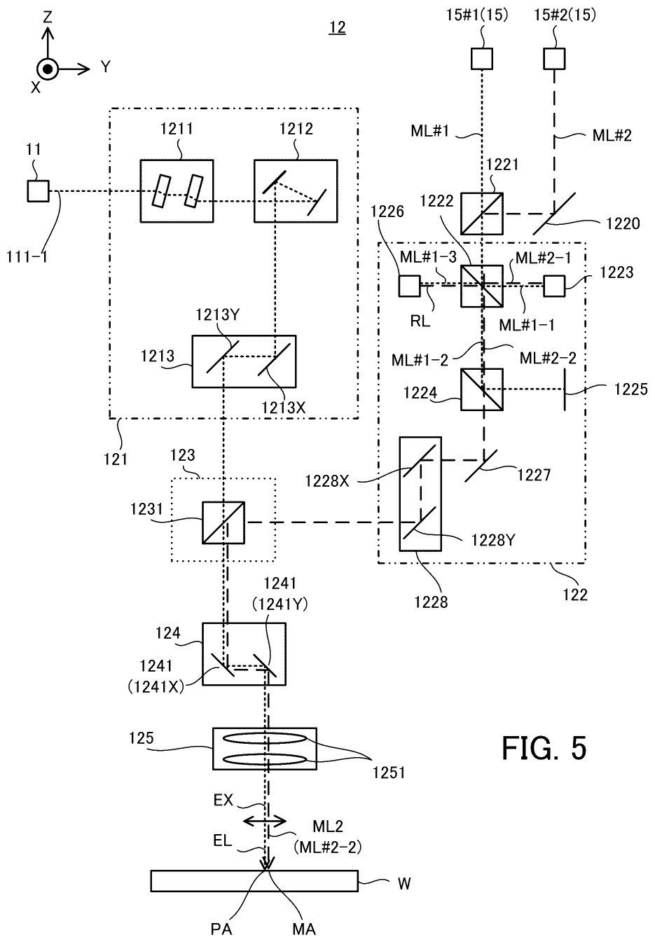

Next, with reference to FIG. 5, one example of a configuration of the processing head 12, which is configured to process the workpiece W and which is configured to measure the workpiece W, will be described as one example of a configuration of the processing heads 12 and 13. FIG. 5 is a cross-sectional view that illustrates one example of the configuration of the processing head 12, which is configured to process the workpiece W and which is configured to measure the workpiece W.

Incidentally, the configuration of the processing head 12 is not limited to the configuration illustrated in FIG. 5. The processing head 12 may have any configuration as long as it is configured to perform the operations that should be performed by the processing head 12 (for example, at least one of the processing operation, the measurement operation, and the holding operation described above). Moreover, the configuration of the processing head 13 may be the same as or may be different from that of the processing head 12. The processing head 13 may have any configuration as long as it is configured to perform the operations that should be performed by the processing head 13 (for example, at least one of the processing operations, measurement operations, and holding operations described above).

As illustrated in FIG. 5, the processing light EL generated by the light source 11 enters the processing head 13 through a light transmitting member 111 such as an optical fiber.

The processing head 12 includes a processing optical system 121, a measurement optical system 122, a combining optical system 123, a deflection optical system 124, and an irradiation optical system 125. Incidentally, the processing optical system 121, the measurement optical system 122, the combining optical system 123, and the deflection optical system 124 may be referred to as an emission optical system.

The processing optical system 121 is an optical system to which the processing light EL emitted from the light source 11 enters. The processing optical system 121 is an optical system that emits, toward the combining optical system 123, the processing light EL that has entered the processing optical system 121. The workpiece W is irradiated with the processing light EL emitted from the processing optical system 121 through the combining optical system 123, the deflection optical system 124, and the irradiation optical system 125.

The processing optical system 121 may include a position adjustment optical system 1211, an angle adjustment optical system 1212, and a Galvano mirror 1213, for example. However, the processing optical system 121 may not include at least one of the position adjustment optical system 1211, the angle adjustment optical system 1212, and the Galvano mirror 1213.

The position adjustment optical system 1211 is configured to adjust an emitting position of the processing light EL from the processing optical system 121. The position adjustment optical system 1211 may include a parallel plate that is configured to incline with respect to a propagating direction of the processing light EL, for example, and change the emitting position of the processing light EL by changing an inclined angle of the parallel plate.

The angle adjustment optical system 1212 is configured to adjust an emitting angle (namely, an emitting direction) of the processing light EL from the processing optical system 121. The angle adjustment optical system 1212 may include a mirror that is configured to incline with respect to the propagating direction of the processing light EL, for example, and change the emitting angle of the processing light by changing an inclined angle of the mirror.

The Galvano mirror 1213 is configured to deflect the processing light EL (namely, changes the emitting angle of the processing light EL). The Galvano mirror 1213 changes a condensed position of the processing light EL in a plane intersecting an optical axis EX of the irradiation optical system 125 (namely, in a plane along the XY plane) by deflecting the processing light EL. As illustrated in FIG. 5, the processing head 12 usually irradiates the workpiece W with the processing light EL in a state where the optical axis EX intersects the surface of the workpiece W. Therefore, when the condensed position of the processing light EL in the plane intersecting the optical axis EX is changed, an irradiation position PA of the processing light EL on the surface of the workpiece W is changed (namely, is moved) in a direction along the surface of the workpiece W. Namely, the irradiation position PA of the processing light EL is changed along at least one of the X-axis direction and the Y-axis direction.

The Galvano mirror 1213 includes a X scanning mirror 1213X and a Y scanning mirror 1213Y. Each of the X scanning mirror 1213X and the Y scanning mirror 1213Y is an inclined angle variable mirror whose angle relative to an optical path of the processing light EL entering the Galvano mirror 1213 is changeable. The X scanning mirror 1213X deflects the processing light EL so as to change the irradiation position PA of the processing light EL on the workpiece W along the X-axis direction. In this case, the X scanning mirror 1213X may be configured to rotate or swing around the Y-axis. Namely, the Galvano mirror 1213 may be configured to change the irradiation position PA of the processing light EL on the workpiece W along the X-axis direction by changing the position of the X scanning mirror 1213X in the OY direction (alternatively, its posture around the Y-axis). The Y scanning mirror 1213Y deflects the processing light EL so as to change the irradiation position PA of the processing light EL on the surface of the workpiece W along the Y-axis direction. In this case, the Y scanning mirror 1213Y may be configured to rotate or swing around the X-axis. Namely, the Galvano mirror 1213 may be configured to change the irradiation position PA of the processing light EL on the workpiece W along the Y-axis direction by changing the position of the Y scanning mirror 1213Y in the θX direction (alternatively, its posture around the X-axis).

The processing light EL that has been emitted from the processing optical system 121 (in this case, the processing light EL that has been emitted from the Galvano mirror 1213) enters the combining optical system 123. The combining optical system 123 includes a beam splitter (for example, a polarization beam splitter) 1231. The beam splitter 1231 emits, toward the deflection optical system 124, the processing light EL that has entered the beam splitter 1231. In an example illustrated in FIG. 5, the processing light EL that has entered the beam splitter 1231 passes through a polarization split surface of the beam splitter 1231 to be emitted toward the deflection optical system 124. Therefore, in the example illustrated in FIG. 5, the processing light EL enters the polarization split surface of the beam splitter 1231 in a state where the processing light EL has a polarized direction that allows the processing light EL to pass through the polarization split surface (a polarized direction that allows the processing light EL to be a p-polarized light with respect to the polarization split surface).

The processing light EL that has been emitted from the combining optical system 123 enters the deflection optical system 124. The deflection optical system 124 emits, toward the irradiation optical system 125, the processing light EL that has entered the deflection optical system 124.

The deflection optical system 124 includes a Galvano mirror 1241. The processing light EL that has entered the deflection optical system 124 enters the Galvano mirror 1241. The Galvano mirror 1241 deflects the processing light EL (namely, changing the emitting angle of the processing light EL). The Galvano mirror 1241 changes the condensed position of the processing light EL in a plane intersecting the optical axis EX of the irradiation optical system 125 (namely, a plane along the XY plane) by deflecting the processing light EL. As illustrated in FIG. 5, the processing head 12 usually irradiates the workpiece W with the processing light EL in a state where the optical axis EX intersects the surface of the workpiece W. Therefore, when the condensed position of the processing light EL in the plane intersecting the optical axis EX is changed, the irradiation position PA of the processing light EL on the surface of the workpiece W is changed (namely, is moved) in a direction along the surface of the workpiece W. Namely, the irradiation position PA of the processing light EL is changed along at least one of the X-axis direction and the Y-axis direction.

The Galvano mirror 1241 includes a X scanning mirror 1241X and a Y scanning mirror 1241Y. Each of the X scanning mirror 1241X and the Y scanning mirror 1241Y is an inclined angle variable mirror whose angle relative to the optical path of the processing light EL entering the Galvano mirror 1241 is changeable. The X scanning mirror 1241X deflects the processing light EL so as to change the irradiation position PA of the processing light EL on the workpiece W along the X-axis direction. In this case, the X scanning mirror 1241X may be configured to rotate or swing around the Y-axis. Namely, the Galvano mirror 1241 may be configured to change the irradiation position PA of the processing light EL on the workpiece W along the X-axis direction by changing the position of the X scanning mirror 1241X in the OY direction (alternatively, its posture around the Y-axis). The Y scanning mirror 1241Y deflects the processing light EL so as to change the irradiation position PA of the processing light EL on the surface of the workpiece W along the Y-axis direction. In this case, the Y scanning mirror 1241Y may be configured to rotate or swing around the X-axis. Namely, the Galvano mirror 1241 may be configured to change the irradiation position PA of the processing light EL on the workpiece W along the Y-axis direction by changing the position of the Y scanning mirror 1241Y in the θX direction (alternatively, its posture around the X-axis).

The processing light EL that has been emitted from the deflection optical system 124 enters the irradiation optical system 125. The irradiation optical system 125 is an optical system that is configured to irradiate the workpiece W with the processing light EL. In order to irradiate the workpiece W with the processing light EL, the irradiation optical system 125 includes an fθ lens 1251 that is configured to serve as an objective optical system. The processing light EL that has been emitted from the deflection optical system 124 enters the fθ lens 1251. The fθ lens 1251 irradiates the workpiece W with the processing light EL that has been emitted from the deflection optical system 124. As a result, the processing light EL emitted from the fθ lens 1251 enters the workpiece W by propagating in the direction along the optical axis EX. Incidentally, the optical axis EX of the irradiation optical system 125 may be an optical axis of the fθ lens 1251.

The fθ lens 1251 may condense the processing light EL that has been emitted from the Galvano mirror 1241 on the workpiece W. In this case, the processing light EL that has been emitted from the fθ lens 1251 may be irradiated onto the workpiece W without passing through another optical element (in other words, an optical member, and a lens for example) having a power. In this case, the fθ lens 1251 may be referred to as a terminal optical element, because it is a last optical element (namely, an optical element that is closest to the workpiece W) having a power of a plurality of optical elements positioned on the optical path of the processing light EL. Incidentally, the power of the optical element may be an inverse number of a focal length of the optical element. Moreover, in this case, the processing light EL from the Galvano mirror 1241 may be a parallel beam. Incidentally, the irradiation optical system 125 may include an objective optical system having a projection characteristic that is different from fθ.

The processing head 12 may perform a subtractive manufacturing operation for removing a part of the workpiece W by irradiating the workpiece W with the processing light EL. The processing head 12 may perform an additive manufacturing operation for adding new build object to the workpiece W by irradiating the workpiece W with the processing light EL. However, in a case where the processing head 12 performs the additive manufacturing operation, the processing head 12 may further include a material supply apparatus that supplies a build material M to the irradiation position PA of the processing light EL. The processing head 12 may perform a planar processing operation for making the surface of the workpiece W be closer a flat surface by irradiating the workpiece W with the processing light EL. The processing head 12 may perform another type of processing operation by irradiating the workpiece W with the processing light EL.

Measurement light ML generated by another light source 15, which is different from the light source 11, further enters the processing head 12 through a light transmitting member 151 such as an optical fiber. The light source 15 may include a light comb light source. The light comb light source is a light source that is configured to generate, as the pulsed light, light including frequency components that are arranged with equal interval on a frequency axis (in the below-described description, it is referred to as a “light frequency comb”). In this case, the light source 15 emits, as the measurement light ML, the pulsed light including the frequency components that are arranged with equal interval on the frequency axis. However, the light 20 source 15 may include a light source that is different from the light comb light source.

In the example illustrated in FIG. 5, the processing system SYSa includes a plurality of light sources 15. For example, the processing system SYSa may include the light source 15#1 and the light source 15#2. The plurality of light sources 15 may emit a plurality of measurement lights ML whose phases are synchronized with each other and that are coherent, respectively. For example, oscillation frequencies of the plurality of light sources 15 may be different from each other. Therefore, the plurality of measurement lights ML respectively emitted from the plurality of light sources 15 may be the plurality of measurement lights ML having different pulse frequencies (for example, the number of the pulsed light per unit time, and an inverse number of an emission cycle of the pulsed light). However, the processing system SYSa may include a single light source 15.

The measurement light ML that has been emitted from the light source 15 enters the measurement optical system 122. The measurement optical system 122 is an optical system that emits, toward the combining optical system 123, the measurement light ML that has entered the measurement optical system 122. The workpiece W is irradiated with the measurement light ML emitted from the measurement optical system 122 through the combining optical system 123, the deflection optical system 124, and the irradiation optical system 125.

The measurement optical system 122 includes a mirror 1220, a beam splitter 1221, a beam splitter 1222, a detector 1223, a beam splitter 1224, a mirror 1225, a detector 1226, a mirror 1227, and a Galvano mirror 1228, for example.

The measurement light ML that has been emitted from the light source 15 enters the beam splitter 1221. Specifically, the measurement light ML that has been emitted from the light source 15#1 (in the below-described description, it is referred to as the “measurement light ML#1”) enters the beam splitter 1221. The measurement light ML that has been emitted from the light source 15#2 (in the below-described description, it is referred to as the “measurement light ML#2”) enters the beam splitter 1221 through the mirror 1220. The beam splitter 1221 emits, toward the beam splitter 1222, the measurement lights ML#1 and ML#2 that have entered the beam splitter 1221. Namely, the beam splitter 1221 emits, toward the same direction (namely, toward a direction along which the beam splitter 1222 is positioned), the measurement lights ML#1 and ML#2 that have entered the beam splitter 1221 from different directions, respectively.

The beam splitter 1222 reflects, toward the detector 1223, measurement light ML#1-1 that is a part of the measurement light ML#1 that has entered the beam splitter 1222. The beam splitter 1222 emits, toward the beam splitter 1224, measurement light ML#1-2 that is another part of the measurement light ML#1 that has entered the beam splitter 1222. The beam splitter 1222 reflects, toward the detector 1223, measurement light ML#2-1 that is a part of the measurement light ML#2 that has entered the beam splitter 1222. The beam splitter 1222 emits, toward the beam splitter 1224, measurement light ML#2-2 that is another part of the measurement light ML#2 that has entered the beam splitter 1222.

The measurement lights ML#1-1 and ML#2-1 that have been emitted from the beam splitter 1222 enter the detector 1223. The detector 1223 optically receives (namely, detects) the measurement light ML#1-1 and the measurement light ML#2-1. Especially, the detector 1223 optically receives interference light generated by an interference between the measurement light ML#1-1 and the measurement light ML#2-1. Incidentally, an operation for optically receiving the interference light generated by the interference between the measurement light ML#1-1 and the measurement light ML#2-1 may be considered to be equivalent to an operation for optically receiving the measurement light ML#1-1 and the measurement light ML#2-1. A detected result by the detector 1223 is output to the control unit 4.

The measurement lights ML#1-2 and ML#2-2 that have been emitted from the beam splitter 1222 enter the beam splitter 1224. The beam splitter 1224 emits, toward the mirror 1225, a part of the measurement light ML#1-2 that has entered the beam splitter 1224. The beam splitter 1224 emits, toward the mirror 1227, a part of the measurement light ML#2-2 that has entered the beam splitter 1224.

The measurement light ML#1-2 that has been emitted from the beam splitter 1224 enters the mirror 1225. The measurement light ML#1-2 that has entered the mirror 1225 is reflected by a reflection surface (the reflection surface may be referred to as a reference surface) of the mirror 1225. Specifically, the mirror 1225 reflects, toward the beam splitter 1224, the measurement light ML#1-2 that has entered the mirror 1225. Namely, the mirror 1225 emits the measurement light ML#1-2, which has entered the mirror 1225, toward the beam splitter 1224 as measurement light ML#1-3 that is a reflection light thereof. In this case, the measurement light ML#1-3 may be referred to as a reference light. The measurement light ML#1-3 that has been emitted from the mirror 1225 enters the beam splitter 1224. The beam splitter 1224 emits, toward the beam splitter 1222, the measurement light ML#1-3 that has entered the beam splitter 1224. The measurement light ML#1-3 that has been emitted from the beam splitter 1224 enters the beam splitter 1222. The beam splitter 1222 emits, toward the detector 1226, the measurement light ML#1-3 that has entered the beam splitter 1222.

On the other hand, the measurement light ML#2-2 that has been emitted from the beam splitter 1224 enters the mirror 1227. The mirror 1227 reflects, toward the Galvano mirror 1228, the measurement light ML#2-2 that has entered the mirror 1227. Namely, the mirror 1227 emits, toward the Galvano mirror 1228, the measurement light ML#2-2 that has entered the mirror 1227.

The Galvano mirror 1228 deflects the measurement light ML#2-2 (namely, changes an emitting angle of the measurement light ML#2-2). The Galvano mirror 1228 changes a condensed position of the measurement light ML#2-2 in a plane intersecting the optical axis EX of the fθ lens 1251 (namely, a plane along the XY plane) by deflecting the measurement light ML#2-2. As illustrated in FIG. 5, the processing head 12 usually irradiates the workpiece W with the measurement light ML#2-2 in a state where the optical axis EX of the fθ lens 1251 intersects the surface of the workpiece W. Therefore, when the condensed position of the measurement light ML#2-2 in the plane intersecting the optical axis EX of the fθ lens 1251 is changed, an irradiation position MA of the measurement light ML#2-2 on the surface of the workpiece W is changed (namely, is moved) in a direction along the surface of the workpiece W. Namely, the irradiation position MA of the measurement light ML#2-2 is changed along at least one of the X-axis direction and the Y-axis direction.

The Galvano mirror 1228 includes a X scanning mirror 1228X and a Y scanning mirror 1228Y. Each of the X scanning mirror 1228X and the Y scanning mirror 1228Y is an inclined angle variable mirror whose angle relative to an optical path of the measurement light ML#2-2 entering the Galvano mirror 1228 is changeable. The X scanning mirror 1228X deflects the measurement light ML#2-2 so as to change the irradiation position MA of the measurement light ML#2-2 on the surface of the workpiece W along the X-axis direction. In this case, the X 20) scanning mirror 1228X may be configured to rotate or swing around the Y-axis. Namely, the Galvano mirror 1228 may be configured to change the irradiation position MA of the measurement light ML#2-2 on the workpiece W along the X-axis direction by changing the position of the X scanning mirror 1228X in the θY direction (alternatively, its posture around the Y-axis). The Y scanning mirror 1228Y deflects the measurement light ML#2-2 so as to change the irradiation position MA of the measurement light ML#2-2 on the surface of the workpiece W along the Y-axis direction. In this case, the Y scanning mirror 1228Y may rotate or swing around the X-axis. Namely, the Galvano mirror 1228 may be configured to change the irradiation position MA of the measurement light ML#2-2 on the workpiece W along the Y-axis direction by changing the position of the Y scanning mirror 1228Y in the θX direction (alternatively, its posture around the X-axis).

The measurement light ML#2-2 that has been emitted from the measurement optical system 122 (in this case, the measurement light ML#2-2 that has been emitted from the Galvano mirror 1228) enters the combining optical system 123. The beam splitter 1231 of the combining optical system 123 emits, toward the deflection optical system 124, the measurement light ML#2-2 that has entered the beam splitter 1231. In the example illustrated in FIG. 5, the measurement light ML#2-2 that has entered the beam splitter 1231 is reflected by the polarization split surface to be emitted toward the deflection optical system 124. Therefore, in the example illustrated in FIG. 5, the measurement light ML#2-2 enters the polarization split surface of the beam splitter 1231 in a state where the measurement light ML#2-2 has a polarized direction that allows the measurement light ML#2-2 to be reflected by the polarization split surface (a polarized direction that allows the measurement light ML#2-2 to be a s-polarized light with respect to the polarization split surface).

Here, not only the measurement light ML#2-2 but also the processing light EL enter the beam splitter 1231 as described above. Namely, both of the measurement light ML#2-2 and the processing light EL pass through the beam splitter 1231. The beam splitter 1231 emits, toward same direction (namely, toward the same deflection optical system 124), the processing light EL and the measurement light ML#2-2 that enter the beam splitter 1231 from different directions, respectively. Therefore, the beam splitter 1231 substantially serves as an combining optical member that combines the processing light EL and the measurement light ML#2-2.

Incidentally, in a case where the wavelength of the processing light EL is different from a wavelength of the measurement light ML#2-2, the combining optical system 123 may include a dichroic mirror as the combining optical member, instead of the beam splitter 1231. Even in this case, the combining optical system 123 may combine the processing light EL and the measurement light ML#2-2 (namely, combine the optical path of the processing light EL and the optical path of the measurement light ML#2-2) by using the dichroic mirror.

The measurement light ML#2-2 that has been emitted from the combining optical system 123 enters the deflection optical system 124. The deflection optical system 124 emits, toward the irradiation optical system 125, the measurement light ML#2-2 that has entered the deflection optical system 124.

The measurement light ML#2-2 that has entered the deflection optical system 124 enters the Galvano mirror 1241. The Galvano mirror 1241 deflects the measurement light ML#2-2, as with the case where the processing light EL is deflected. Therefore, the Galvano mirror 1241 is configured to change the irradiation position MA of the measurement light ML#2-2 on the surface of the workpiece W in a direction along the surface of the workpiece W. Namely, the Galvano mirror 1241 may be configured to change the irradiation position MA of the measurement light ML#2-2 on the workpiece W along the X-axis direction by changing the position of the X scanning mirror 1241X in the θY direction (alternatively, its posture around the Y-axis). The Galvano mirror 1241 may be configured to change the irradiation position MA of the measurement light ML#2-2 on the workpiece W along the Y-axis direction by changing the position of the Y scanning mirror 1241Y in the θX direction (alternatively, its posture around the X-axis).

As described above, not only the measurement light ML#2-2 but also the processing light EL enter the Galvano mirror 1241. Namely, the processing light EL and the measurement light ML#2-2 that have been combined by the beam splitter 1231 enter the Galvano mirror 1241. Therefore, both of the processing light EL and the measurement light ML#2-2 pass through the same Galvano mirror 1241. Therefore, the Galvano mirror 1241 is configured to change the irradiation position PA of the processing light EL and the irradiation position MA of the measurement light ML#2-2 in synchronization with each other. Namely, the Galvano mirror 1241 may change the irradiation position PA of the processing light EL and the irradiation position MA of the measurement light ML#2-2 in conjunction with each other.

On the other hand, the measurement light ML#2-2 is irradiated onto the workpiece W through the Galvano mirror 1228 and the processing light EL is irradiated onto the workpiece W without passing through the Galvano mirror 1228. Therefore, the processing system SYSa is configured to independently move the irradiation position MA of the measurement light ML#2-2 relative to the irradiation position PA of the processing light EL by using the Galvano mirror 1228. Namely, the processing system SYSa is configured to change a relative positional relationship between the irradiation position PA of the processing light EL and the irradiation position MA of the measurement light ML#2-2 by using the Galvano mirror 1228. Especially, the processing system SYSa is configured to change the positional relationship between the irradiation position PA of the processing light EL and the irradiation position MA of the measurement light ML#2-2 along a direction intersecting an irradiation direction of the measurement light ML#2-2 (in the example illustrated in FIG. 5, at least one of the X-axis direction and the Y-axis direction) by using the Galvano mirror 1228.

Similarly, the processing light EL is irradiated onto the workpiece W through the Galvano mirror 1213 and the measurement light ML#2-2 is irradiated onto the workpiece W without passing through the Galvano mirror 1213. Therefore, the processing system SYSa is configured to independently move the irradiation position PA of the processing light EL relative to the irradiation position MA of the measurement light ML#2-2 by using the Galvano mirror 1213. Namely, the processing system SYSa is configured to change the relative positional relationship between the irradiation position PA of the processing light EL and the irradiation position MA of the measurement light ML#2-2 by using the Galvano mirror 1213. Especially, the processing system SYSa is configured to change the positional relationship between the irradiation position PA of the processing light EL and the irradiation position MA of the measurement light ML#2-2 along a direction intersecting an irradiation direction of the processing light EL (in the example illustrated in FIG. 5, at least one of the X-axis direction and the Y-axis direction) by using the Galvano mirror 1213.

The measurement light ML#2-2 that has been emitted from the deflection optical system 124 enters the irradiation optical system 125. The irradiation optical system 125 is an optical system that is configured to irradiate the workpiece W with the measurement light ML#2-2. Specifically, the fθ lens 1251 irradiates the workpiece W with the measurement light ML#2-2 that has been emitted from the deflection optical system 124. As a result, the measurement light ML#2-2 that has been emitted from the fθ lens 1251 enters the workpiece W by propagating in the direction along the optical axis EX.

The fθ lens 1251 may condense the measurement light ML#2-2 that has been emitted from the deflection optical system 124 on the workpiece W. In this case, the measurement light ML#2-2 that has been emitted from the fθ lens 1251 may be irradiated onto the workpiece W without passing through another optical element (in other words, an optical member, and a lens for example) having a power. In this case, the fθ lens 1251 may be referred to as a terminal optical element, because it is a last optical element (namely, an optical element that is closest to the workpiece W) having a power of a plurality of optical elements positioned on the optical path of the measurement light ML#2-2. In this case, the measurement light ML#2-2 emitted from the deflection optical system 124 to enter the fθ lens 1251 may be a parallel beam.

When the workpiece W is irradiated with the measurement light ML#2-2, light due to the irradiation with the measurement light ML#2-2 is generated from the workpiece W. Namely, when the workpiece W is irradiated with the measurement light ML#2-2, the light due to the irradiation with the measurement light ML#2-2 is emitted from the workpiece W. The light due to the irradiation with the measurement light ML#2-2 (in other words, the light emitted from the workpiece W due to the irradiation with the measurement light ML#2-2) may include at least one of the measurement light ML#2-2 reflected by the workpiece W (namely, reflection light), the measurement light ML#2-2 scattered by the workpiece W (namely, scattering light), the 10) measurement light ML#2-2 diffracted by the workpiece W (namely, diffraction light) and the measurement light ML#2-2 transmitted through the workpiece W (namely, transmitted light).

At least a part of the light emitted from the workpiece W due to the irradiation with the measurement light ML#2-2 enters the irradiation optical system 125 as returned light RL. The returned light RL that has entered the irradiation optical system 125 enters the deflection optical system 124 through the fθ lens 1251. The returned light RL that has entered the deflection optical system 124 enters the combining optical system 123 through the Galvano mirror 1241. The beam splitter 1231 of the combining optical system 123 emits, toward the measurement optical system 122, the returned light RL that has entered the beam splitter 1231. In the example illustrated in FIG. 5, the returned light RL that has entered the beam splitter 1231 is reflected by the polarization split surface to be emitted toward the measurement optical system 122. Therefore, in the example illustrated in FIG. 5, the returned light RL enters the polarization split surface of the beam splitter 1231 in a state where the returned light RL has a polarized direction that allows the returned light RL to be reflected by the polarization split surface.

The returned light RL that has been emitted from the beam splitter 1231 enters the Galvano mirror 1228 of the measurement optical system 122. The Galvano mirror 1228 emits, toward the mirror 1227, the returned light RL that has entered the Galvano mirror 1228. The mirror 1227 reflects, toward the beam splitter 1224, the returned light RL that has entered the mirror 1227. The beam splitter 1224 emits, toward the beam splitter 1222, at least a part of the returned light RL that has entered the beam splitter 1224. The beam splitter 1222 emits, toward the detector 1226, at least a part of the returned light RL that has entered the beam splitter 1222.

As described above, not only the returned light RL but also the measurement light ML#1-3 enter the detector 1226. Namely, the returned light RL that propagates toward the detector 1226 through the workpiece W and the measurement light ML#1-3 that propagates toward the detector 1226 without going through the workpiece W enter the detector 1226. The detector 1226 optically receives (namely, detects) the measurement light ML#1-3 and the returned light RL. Especially, the detector 1226 optically receives interference light generated by an interference between the measurement light ML#1-3 and the returned light RL. Incidentally, an operation for optically receiving the interference light generated by the interference between the measurement light ML#1-3 and the returned light RL may be considered to be equivalent to an operation for optically receiving the measurement light ML#1-3 and the returned light RL. A detected result by detector 1226 is output to the control unit 4.

The control unit 4 acquires the detected result by the detector 1223 and the detected result by the detector 1226. The control unit 4 may generate measurement data of the workpiece W (for example, measurement data related to at least one of a position and a shape of the workpiece W) based on the detected result by the detector 1223 and the detected result by the detector 1226.

Specifically, since the pulse frequency of the measurement light ML#1 is different from the pulse frequency of the measurement light ML#2, a pulse frequency of the measurement light ML#1-1 is different from a pulse frequency of the measurement light ML#2-1. Therefore, the interference light generated by the interference between the measurement light ML#1-1 and the measurement light ML#2-1 is interference light in which pulsed light appears in synchronization with a timing at which the pulsed light of the measurement light ML#1-1 and the pulsed light of the measurement light ML#2-1 enter the detector 1223 at the same time. Similarly, a pulse frequency of the measurement light ML#1-3 is different from a pulse frequency of the returned light RL. Therefore, the interference light generated by the interference between the measurement light ML#1-3 and the returned light RL is interference light in which pulsed light appears in synchronization with a timing at which the pulsed light of the measurement light ML#1-3 and the pulsed light of the returned light RL enter the detector 1226 at the same time. Here, a position (a position along a time axis) of the pulsed light of the interference light detected by the detector 1226 changes depending on a positional relationship between the processing head 12 and the workpiece W. This is because the interference light detected by the detector 1226 is the interference light generated by the interference between the returned light RL that propagates toward the detector 1226 through the workpiece W and the measurement light ML#1-3 that propagates toward the detector 1226 without going through the workpiece W. On the other hand, a position (a position along a time axis) of the pulsed light of the interference light detected by the detector 1223 does not change depending on the positional relationship between the processing head 12 and the workpiece W. Therefore, it can be said that a difference in time between the pulsed light of the interference light detected by the detector 1223 and the pulsed light of the interference light detected by the detector 1226 indirectly indicates the positional relationship between the processing head 12 and the workpiece W. Specifically, it can be said that the difference in time between the pulsed light of the interference light detected by the detector 1223 and the pulsed light of the interference light detected by the detector 1226 indirectly indicates a distance between the processing head 12 and the workpiece W in the direction along the optical path of the measurement light ML (namely, a direction along the propagating direction of the measurement light ML). Therefore, the control unit 4 may calculate the distance between the processing head 12 and the workpiece W in the direction along the optical path of the measurement light ML (for example, the Z-axis direction) based on the difference in time between the pulsed light of the interference light detected by the detector 1223 and the pulsed light of the interference light detected by the detector 1226. In other words, the control unit 4 may calculate the position of the workpiece W in the direction along the optical path of the measurement light ML (for example, the Z-axis direction). More specifically, the control unit 4 may calculate the distance between the processing head 12 and an irradiated part of the workpiece W that is irradiated with the measurement light ML#2-2. The control unit 4 may calculate the position of the irradiated part in the direction along the optical path of the measurement light ML (for example, the Z-axis direction). Furthermore, since the irradiation position of the measurement light ML#2-2 on the workpiece W is determined by driving states of the Galvano mirrors 1241 and 1228, the control unit 4 may calculate, based on the driving states of the Galvano mirrors 1241 and 1228, the position of the irradiated part in the direction intersecting the optical path of the measurement light ML (for example, at least one of the X-axis direction and the Y-axis direction). As a result, the control unit 4 may generate the measurement data indicating the position (for example, the position in a three-dimensional coordinate space) of the irradiated part in a measurement coordinate system that is based on the processing head 12.

The processing head 12 may irradiate a plurality of parts of the workpiece W with the measurement light ML#2-2. For example, at least one of the Galvano mirrors 1241 and 1228 may change the irradiation position of the measurement light ML#2-2 on the workpiece W so that the processing head 12 irradiates the plurality of parts of the workpiece W with the measurement light ML#2-2. For example, at least one of the processing head 12 and the stage 21 may move so that the processing head 12 irradiates the plurality of parts of the workpiece W with the measurement light ML#2-2. In a case where the plurality of parts of the workpiece W are irradiated with the measurement light ML#2-2, the control unit 4 may generate the measurement data indicating the positions of the plurality of parts of the workpiece W. As a result, the control unit 4 may generate the measurement data indicating the shape of the workpiece W based on the measurement data indicating the positions of the plurality of parts. For example, the control unit 4 may generate the measurement data indicating the shape of the workpiece W by calculating, as the shape of the workpiece W, a three-dimensional shape formed by a virtual planar plane (alternatively, curved plane) connecting the plurality of parts whose positions are calculated.

### (1-2) Operation Performed by Processing System SYSa

Next, an operation performed by the processing system SYSa will be described. As described above, the processing system SYSa may perform the first processing operation for processing the workpiece W by using the processing head 12. Furthermore, the processing system SYSa may perform the second processing operation for processing the workpiece W by using the processing head 13. Therefore, in the below-described description, the first processing operation using the processing head 12 and the second processing operation using the processing head 13 will be described in order.

(1-2-1) First Processing Operation using Processing Head 12

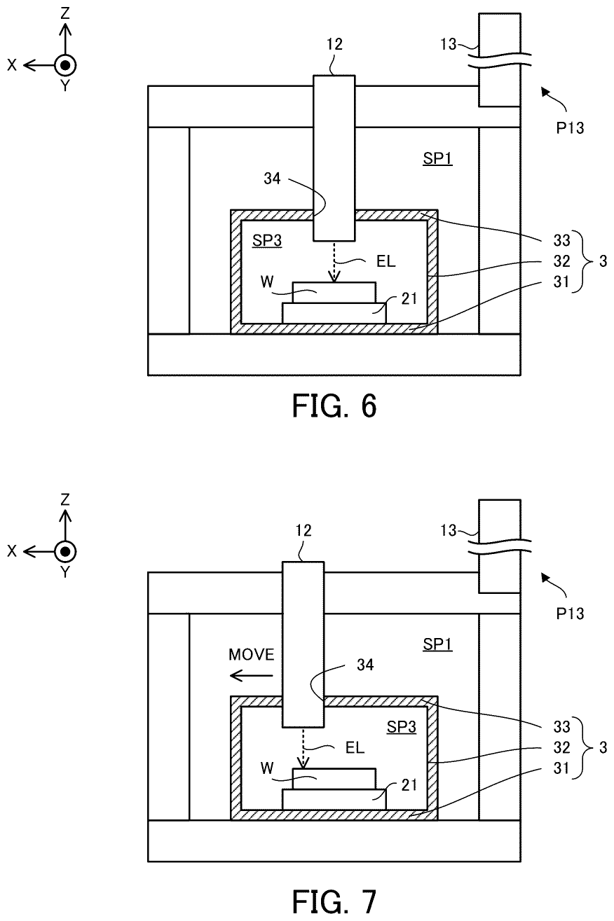

First, with reference to FIG. 6, the first processing operation using the processing head 12 will be described. FIG. 6 is a cross-sectional view that illustrates the processing head 12 performing the first processing operation.

As illustrated in FIG. 6, at least a part of the processing head 12 is inserted into the aperture 34 in a first processing period during which the processing head 12 performs the first processing operation. Therefore, the control unit 4 controls the head driving system 14 to move the processing head 12 so that at least a part of the processing head 12 is inserted into the aperture 34 in the first processing period. As a result, at least a part of the processing head 12 is positioned in the processing space SP3 of the housing 3 in the first processing period.

Especially, in the first processing period, the emission port of the processing head 12, from which the processing light EL is emitted, may be inserted into the aperture 34. Therefore, the control unit 4 may control the head driving system 14 to move the processing head 12 so that the emission port of the processing head 12 is inserted into the aperture 34 in the first processing period. As a result, the emission port of the processing head 12 may be positioned in the processing space SP3 of the housing 3 in the first processing period.

In the first example embodiment, the processing head 12 emits the processing light EL from the irradiation optical system 125 as described above. Therefore, at least a part of the irradiation optical system 125 may be inserted into the aperture 34 in the first processing period. As a result, at least a part of the irradiation optical system 125 may be positioned in the processing space SP3 of the housing 3 in the first processing period. Specifically, at least a part of the fθ lens 1251 (especially, an emission surface of the fθ lens 1251) of the irradiation optical system 125 may be inserted into the aperture 34 in the first processing period. As a result, at least a part of the fθ lens 1251 (especially, the emission surface of the fθ lens 1251) may be positioned in the processing space SP3 of the housing 3 in the first processing period.

The processing head 12 may irradiate the workpiece W with the processing light EL in a state where at least a part of the processing head 12 is positioned in the processing space SP3. As a result, the processing head 12 may process the workpiece W that is contained in the processing space SP3. Namely, even in a case where the workpiece W is contained in the processing space SP3 of the housing 3, the processing head 12 may process the workpiece W by entering the processing space SP3 through the aperture 34 of the housing 3.

In the first processing period, the other part of the processing head 12 may not be positioned in the processing space SP3 while a part of the processing head 12 may be positioned in the processing space SP3. Namely, it is sufficient that a part of the processing head 12 is positioned in the processing space SP3, and the entire processing head 12 may not be positioned in the processing space SP3. However, the entire processing head 12 may be positioned in the processing space SP3.

The processing head 12 may move in a state where at least a part of the processing head 12 is positioned in the processing space SP3, as illustrated in FIG. 7 that is a cross-sectional view illustrating the processing head 12 inserted into the aperture 34. Namely, the head driving system 14 may move the processing head 12 in a state where at least a part of the processing head 12 is positioned in the processing space SP3. For example, the head driving system 14 may move the processing head 12 along at least one of the X-axis direction, the Y-axis direction, and the Z-axis direction, in a state where at least a part of the processing head 12 positioned in the processing space SP3.

In this case, the aperture 34, into which at least a part of the processing head 12 is inserted, may also move due to the movement of the processing head 12. Namely, the aperture member 331, in which the aperture 34 is formed, may also move due to the movement of the processing head 12. In other words, the processing head 12 may move the aperture member 331.

The processing head 12 may move the aperture member 331 by using a force applied to the aperture member 331 from the processing head 12. Specifically, when the processing head 12 moves, the processing head 12 contacts with the aperture member 331. Alternatively, even when the processing head 12 is stationary, the processing head 12 may contact with the aperture member 331. In this case, the processing head 12 may be linked to the aperture member 331. As one example, the processing head 12 may be linked to the aperture member 331 through a linkage member such as a fixing pin. As another example, the processing head 12 may be substantially linked to the aperture member 331 by a frictional force between the processing head 12 and the packing such as the O-ring or the lip packing positioned in the aperture 34 described above. As another example, the processing head 12 may be substantially linked to the aperture member 331 by at least one of a compressive force and a repulsive force of the packing such as the O-ring or the lip packing positioned in the aperture 34 described above. Incidentally, in the first example embodiment, a state where “the processing head 12 contacts with the aperture member 331” may include at least one of a state where the processing head 12 directly contacts with the aperture member 331 and a state where the processing head 12 indirectly contacts with the aperture member 331. The state where the processing head 12 indirectly contacts with the aperture member 331 may include a state where the processing head 12 contacts with the aperture member 331 through another member (for example, the linkage member described above). The state where the processing head 12 indirectly contacts with the aperture member 331 may include a state where both of the processing head 12 and the aperture member 331 contact with another common member. As a result, when the processing head 12 moves, a force for pushing the aperture member 331 is applied to the aperture member 331 from the processing head 12. Therefore, when the processing head 12 moves, the aperture member 331 also moves by the force applied to the aperture member 331 from the processing head 12.

Typically, when the processing head 12 moves, a force for pushing the aperture member 331 in a movement direction of the processing head 12 is applied to the aperture member 331 from the processing head 12. Therefore, when the processing head 12 moves, the aperture member 331 also moves in the movement direction of the processing head 12 by the force applied to the aperture member 331 from the processing head 12. Therefore, the processing head 12 may move the aperture member 331 along the movement direction of the processing head 12.

As one example, the aperture 34 may move along the X-axis direction due to the movement of the processing head 12 along the X-axis direction. Namely, the aperture member 331 may move along the X-axis direction due to the movement of the processing head 12 along the X-axis direction. In other words, the processing head 12 may move the aperture member 331 along the X-axis direction by moving along the X-axis direction. Specifically, when the processing head 12 moves along the X-axis direction in a state where at least a part of the processing head 12 is inserted into the aperture 34, a force for pushing the aperture member 331 along the X-axis direction is applied from the processing head 12 to the aperture member 331. As a result, the aperture member 331 also moves along the X-axis direction by the force applied to the aperture member 331 from the processing head 12.

In a case where the aperture member 331 moves along the X-axis direction, the support member 332, which supports the aperture member 331, expands and contracts by the force applied to the aperture member 331 from the processing head 12 so that the aperture member 331 is movable along the X-axis direction. Specifically, at least one of the plurality of support plates 3323 of the support member 3321 moves by the force applied to the aperture member 331 from the processing head 12 so that the support member 3321 of the support member 332 expands and contracts. Furthermore, at least one of the plurality of support plates 3324 of the support member 3322 moves by the force applied to the aperture member 331 from the processing head 12 so that the support member 3322 of the support member 332 expands and contracts. As a result, the processing head 12 can move the aperture member 331 properly in the X-axis direction.

As another example, the aperture 34 may move along the Y-axis direction due to the movement of the processing head 12 along the Y-axis direction. Namely, the aperture member 331 may move along the Y-axis direction due to the movement of the processing head 12 along the Y-axis direction. In other words, the processing head 12 may move the aperture member 331 along the Y-axis direction by moving along the Y-axis direction. Specifically, when the processing head 12 moves along the Y-axis direction in a state where at least a part of the processing head 12 is inserted into the aperture 34, a force for pushing the aperture member 331 along the Y-axis direction is applied from the processing head 12 to the aperture member 331. As a result, the aperture member 331 also moves along the Y-axis direction by the force applied to the aperture member 331 from the processing head 12.

In a case where the aperture member 331 moves along the Y-axis direction, the support member 333, which supports the aperture member 331 through the support member 332, expands and contracts by the force applied to the aperture member 331 from the processing head 12 so that the aperture member 331 is movable along the Y-axis direction. Specifically, at least one of the plurality of support plates 3333 of the support member 3331 moves by the force applied to the aperture member 331 from the processing head 12 so that the support member 3331 of the support member 333 expands and contracts. Furthermore, at least one of the plurality of support plates 3334 of the support member 3332 moves by the force applied to the aperture member 331 from the processing head 12 so that the support member 3332 of the support member 333 expands and contracts. As a result, the processing head 12 can move the aperture member 331 properly in the Y-axis direction.

On the other hand, the aperture 34 may not move along the Z-axis direction due to the movement of the processing head 12 along the Z-axis direction. Namely, the aperture member 331 may not move along the Z-axis direction due to the movement of the processing head 12 along the Z-axis direction. In other words, the processing head 12 may not move the aperture member 331 along the Z-axis direction. However, the processing head 12 may move the aperture member 331 along the Z-axis direction.

However, the processing head 12 may move without contacting with the aperture member 331. Namely, the processing head 12 may move while maintaining a state where a gap is formed between the processing head 12 and the aperture member 331. In this case, the aperture member 331 may move by a force that is different from the force caused by the movement of the processing head 12.

The processing head 12 may process the workpiece W while moving the aperture member 331. Specifically, the processing head 12 may process the workpiece W by irradiating the workpiece W with the processing light EL in at least a part of a period during which it moves to move the aperture member 331. However, the processing head 12 may not process the workpiece W in the period during which it moves the aperture member 331. For example, the processing head 12 may not irradiate the workpiece W with the processing light EL in the period during which it moves to move the aperture member 331. The processing head 12 may process the workpiece W by irradiating the workpiece W with the processing light EL in at least a part of a period during which the processing head 12 does not move (and as a result, the aperture member 331 does not move too). The processing head 12 may process the workpiece W by irradiating the workpiece W with the processing light EL in at least a part of a period during which the processing head 12 is stationary (and as a result, the aperture member 331 is also stationary).

On the other hand, as illustrated in FIG. 6 and FIG. 7, in the first processing period during which the processing head 12 performs the first processing operation, the processing head 13 may not be inserted into the aperture 34. In the first processing period, the processing head 13 may not be positioned in the processing space SP3. In the first processing period, the processing head 13 may be positioned in the outer space SP1.

Especially, in the first processing period, the processing head 13 may be positioned at a predetermined wait position P13. The wait position P13 may be a position that is positioned at an outside of a movement range in which the processing head 12 is movable in the first processing period. Especially, the wait position P13 may be a position that is positioned at the outside the movement range in which the processing head 12 is movable along each of the X-axis direction and the Y-axis direction in the first processing period. In other words, the wait position P13 may be a position that the processing head 12 moving in the first processing period cannot reach. As a result, there is a low or no possibility that the processing head 12 moving in the first processing period collides with the processing head 13. Therefore, the processing head 12 can process the workpiece W without being affected by the processing head 13 in the first processing period.

Incidentally, even in a case where the processing head 12 performs any operation that is different from the processing operation, at least a part of the processing head 12 may be inserted into the aperture 34 as described above in a first period during which the processing head 12 performs any operation. The processing head 12 may perform any operation on the workpiece W contained in the processing space SP3 in a state where at least a part of the processing head 12 is inserted into the aperture 34. Therefore, the above-described description related to the processing head 12 performing the processing operation may be used as a description related to the processing head 12 performing any operation that is different from the processing operation.

### (1-2-2) Second Processing Operation Using Processing Head 13

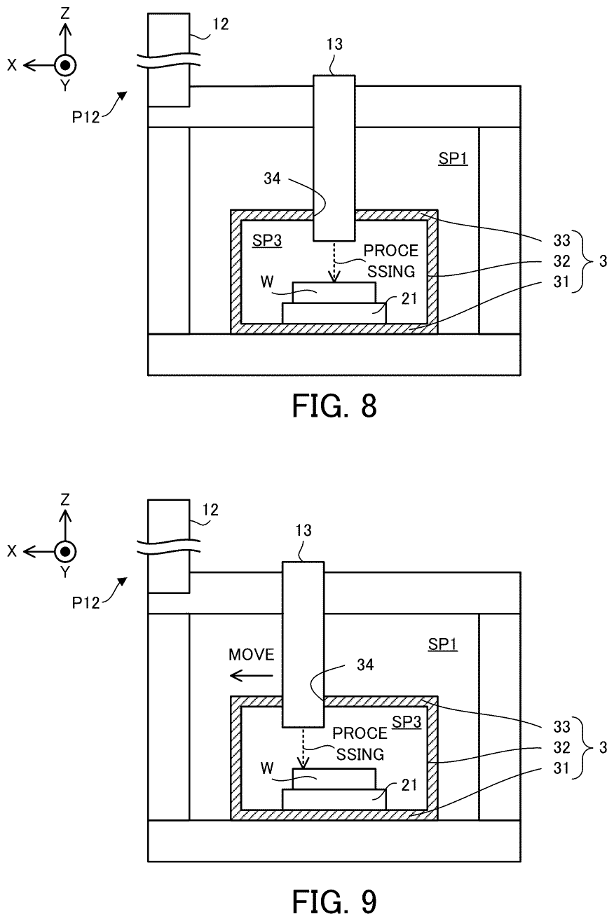

Next, with reference to FIG. 8, the second processing operation using the processing head 13 will be described. FIG. 8 is a cross-sectional view that illustrates the processing head 13 performing the second processing operation.

As illustrated in FIG. 8, at least a part of the processing head 13 is inserted into the aperture 34 in a second processing period during which the processing head 13 performs the second processing operation. Therefore, the control unit 4 controls the head driving system 14 to move the processing head 13 so that at least a part of the processing head 13 is inserted into the aperture 34 in the second processing period. As a result, at least a part of the processing head 13 is positioned in the processing space SP3 of the housing 3 in the second processing period.

Especially, in the second processing period, the emission port of the processing head 13, from which the processing light EL is emitted, may be inserted into the aperture 34. Therefore, the control unit 4 may control the head driving system 14 to move the processing head 13 so that the emission port of the processing head 13 is inserted into the aperture 34 in the second processing period. As a result, the emission port of the processing head 13 may be positioned in the processing space SP3 of the housing 3 in the second processing period.

In a case where the processing head 13 includes the irradiation optical system that emits the processing light EL, at least a part of the irradiation optical system of the processing head 13 may be inserted into the aperture 34 in the second processing period. Especially, the emission surface of the irradiation optical system of the processing head 13 may be inserted into the aperture 34 in the second processing period. As a result, at least a part of the irradiation optical system of the processing head 13 may be positioned in the processing space SP3 of the housing 3 in the second processing period.

The processing head 13 may irradiate the workpiece W with the processing light EL in a state where at least a part of the processing head 13 is positioned in the processing space SP3. As a result, the processing head 13 may process the workpiece W that is contained in the processing space SP3. Namely, even in a case where the workpiece W is contained in the processing space SP3 of the housing 3, the processing head 13 may process the workpiece W by entering the processing space SP3 through the aperture 34 of the housing 3.

In the second processing period, the other part of the processing head 13 may not be positioned in the processing space SP3 while a part of the processing head 13 may be positioned in the processing space SP3. Namely, it is sufficient that a part of the processing head 13 is positioned in the processing space SP3, and the entire processing head 13 may not be positioned in the processing space SP3. However, the entire processing head 13 may be positioned in the processing space SP3.

The processing head 13 may move in a state where at least a part of the processing head 13 is positioned in the processing space SP3, as illustrated in FIG. 9 that is a cross-sectional view illustrating the processing head 13 inserted into the aperture 34. Namely, the head driving system 14 may move the processing head 13 in a state where at least a part of the processing head 13 is positioned in the processing space SP3. For example, the head driving system 14 may move the processing head 13 along at least one of the X-axis direction, the Y-axis direction, and the Z-axis direction, in a state where at least a part of the processing head 13 positioned in the processing space SP3.

In this case, the aperture 34, into which at least a part of the processing head 13 is inserted, may also move due to the movement of the processing head 13. Namely, the aperture member 331, in which the aperture 34 is formed, may also move due to the movement of the processing head 13. In other words, the processing head 13 may move the aperture member 331.

The processing head 13 may move the aperture member 331 by using a force applied to the aperture member 331 from the processing head 13. Specifically, when the processing head 13 moves, the processing head 13 contacts with the aperture member 331. Alternatively, even when the processing head 13 is stationary, the processing head 13 may contact with the aperture member 331. In this case, the processing head 13 may be linked to the aperture member 331. As one example, the processing head 13 may be linked to the aperture member 331 through a linkage member such as a fixing pin. As another example, the processing head 13 may be substantially linked to the aperture member 331 by a frictional force between the processing head 13 and the packing such as the O-ring positioned in the aperture 34 described above. Incidentally, in the first example embodiment, a state where “the processing head 13 contacts with the aperture member 331” may include at least one of a state where the processing head 13 directly contacts with the aperture member 331 and a state where the processing head 13 indirectly contacts with the aperture member 331. The state where the processing head 13 indirectly contacts with the aperture member 331 may include a state where the processing head 13 contacts with the aperture member 331 through another member (for example, the linkage member described above). The state where the processing head 13 indirectly contacts with the aperture member 331 may include a state where both of the processing head 13 and the aperture member 331 contact with another common member. As a result, when the processing head 13 moves, a force for pushing the aperture member 331 is applied to the aperture member 331 from the processing head 13. Therefore, when the processing head 13 moves, the aperture member 331 also moves by the force applied to the aperture member 331 from the processing head 13.

Typically, when the processing head 13 moves, a force for pushing the aperture member 331 in a movement direction of the processing head 13 is applied to the aperture member 331 from the processing head 13. Therefore, when the processing head 13 moves, the aperture member 331 also moves in the movement direction of the processing head 13 by the force applied to the aperture member 331 from the processing head 13. Therefore, the processing head 13 may move the aperture member 331 along the movement direction of the processing head 13.

As one example, the aperture 34 may move along the X-axis direction due to the movement of the processing head 13 along the X-axis direction. Namely, the aperture member 331 may move along the X-axis direction due to the movement of the processing head 13 along the X-axis direction. In other words, the processing head 13 may move the aperture member 331 along the X-axis direction by moving along the X-axis direction. Specifically, when the processing head 13 moves along the X-axis direction in a state where at least a part of the processing head 13 is inserted into the aperture 34, a force for pushing the aperture member 331 along the X-axis direction is applied from the processing head 13 to the aperture member 331. As a result, the aperture member 331 also moves along the X-axis direction by the force applied to the aperture member 331 from the processing head 13.

In a case where the aperture member 331 moves along the X-axis direction, the support member 332, which supports the aperture member 331, expands and contracts by the force applied to the aperture member 331 from the processing head 13 so that the aperture member 331 is movable along the X-axis direction. Specifically, at least one of the plurality of support plates 3323 of the support member 3321 moves by the force applied to the aperture member 331 from the processing head 13 so that the support member 3321 of the support member 332 expands and contracts. Furthermore, at least one of the plurality of support plates 3324 of the support member 3322 moves by the force applied to the aperture member 331 from the processing head 13 so that the support member 3322 of the support member 332 expands and contracts. As a result, the processing head 13 can move the aperture member 331 properly in the X-axis direction.

As another example, the aperture 34 may move along the Y-axis direction due to the movement of the processing head 13 along the Y-axis direction. Namely, the aperture member 331 may move along the Y-axis direction due to the movement of the processing head 13 along the Y-axis direction. In other words, the processing head 13 may move the aperture member 331 along the Y-axis direction by moving along the Y-axis direction. Specifically, when the processing head 13 moves along the Y-axis direction in a state where at least a part of the processing head 13 is inserted into the aperture 34, a force for pushing the aperture member 331 along the Y-axis direction is applied from the processing head 13 to the aperture member 331. As a result, the aperture member 331 also moves along the Y-axis direction by the force applied to the aperture member 331 from the processing head 13.

In a case where the aperture member 331 moves along the Y-axis direction, the support member 333, which supports the aperture member 331 through the support member 332, expands and contracts by the force applied to the aperture member 331 from the processing head 13 so that the aperture member 331 is movable along the Y-axis direction. Specifically, at least one of the plurality of support plates 3333 of the support member 3331 moves by the force applied to the aperture member 331 from the processing head 13 so that the support member 3331 of the support member 333 expands and contracts. Furthermore, at least one of the plurality of support plates 3334 of the support member 3332 moves by the force applied to the aperture member 331 from the processing head 13 so that the support member 3332 of the support member 333 expands and contracts. As a result, the processing head 13 can move the aperture member 331 properly in the Y-axis direction.

On the other hand, the aperture 34 may not move along the Z-axis direction due to the movement of the processing head 13 along the Z-axis direction. Namely, the aperture member 331 may not move along the Z-axis direction due to the movement of the processing head 13 along the Z-axis direction. In other words, the processing head 13 may not move the aperture member 331 along the Z-axis direction. However, the processing head 13 may move the aperture member 331 along the Z-axis direction.

However, the processing head 13 may move without contacting with the aperture member 331. Namely, the processing head 13 may move while maintaining a state where a gap is formed between the processing head 13 and the aperture member 331. In this case, the aperture member 331 may move by a force that is different from the force caused by the movement of the processing head 13.

The processing head 13 may process the workpiece W while moving the aperture member 331. Specifically, the processing head 13 may process the workpiece W by irradiating the workpiece W with the processing light EL in at least a part of a period during which it moves to move the aperture member 331. However, the processing head 13 may not process the workpiece W in the period during which it moves the aperture member 331. For example, the processing head 13 may not irradiate the workpiece W with the processing light EL in the period during which it moves to move the aperture member 331. The processing head 13 may process the workpiece W by irradiating the workpiece W with the processing light EL in at least a part of a period during which the processing head 13 does not move (and as a result, the aperture member 331 does not move too). The processing head 13 may process the workpiece W by irradiating the workpiece W with the processing light EL in at least a part of a period during which the processing head 13 is stationary (and as a result, the aperture member 331 is also stationary).

On the other hand, as illustrated in FIG. 8 and FIG. 9, in the second processing period during which the processing head 13 performs the second processing operation, the processing head 12 may not be inserted into the aperture 34. In the second processing period, the processing head 12 may not be positioned in the processing space SP3. In the second processing period, the processing head 12 may be positioned in the outer space SP1.

Especially, in the second processing period, the processing head 12 may be positioned at a predetermined wait position P12. The wait position P12 may be a position that is positioned at an outside of a movement range in which the processing head 13 is movable in the second processing period. Especially, the wait position P12 may be a position that is positioned at the outside the movement range in which the processing head 13 is movable along each of the X-axis direction and the Y-axis direction in the second processing period. In other words, the wait position P12 may be a position that the processing head 13 moving in the second processing period cannot reach. As a result, there is a low or no possibility that the processing head 13 moving in the second processing period collides with the processing head 12. Therefore, the processing head 13 can process the workpiece W without being affected by the processing head 12 in the second processing period.

Incidentally, even in a case where the processing head 13 performs any operation that is different from the processing operation, at least a part of the processing head 13 may be inserted into the aperture 34 as described above in a second period during which the processing head 13 performs any operation. The processing head 13 may perform any operation on the workpiece W contained in the processing space SP3 in a state where at least a part of the processing head 13 is inserted into the aperture 34. Therefore, the above-described description related to the processing head 13 performing the processing operation may be used as a description related to the processing head 13 performing any operation that is different from the processing operation.

(1-2-3) Switching between Processing Head 12 and Processing Head 13

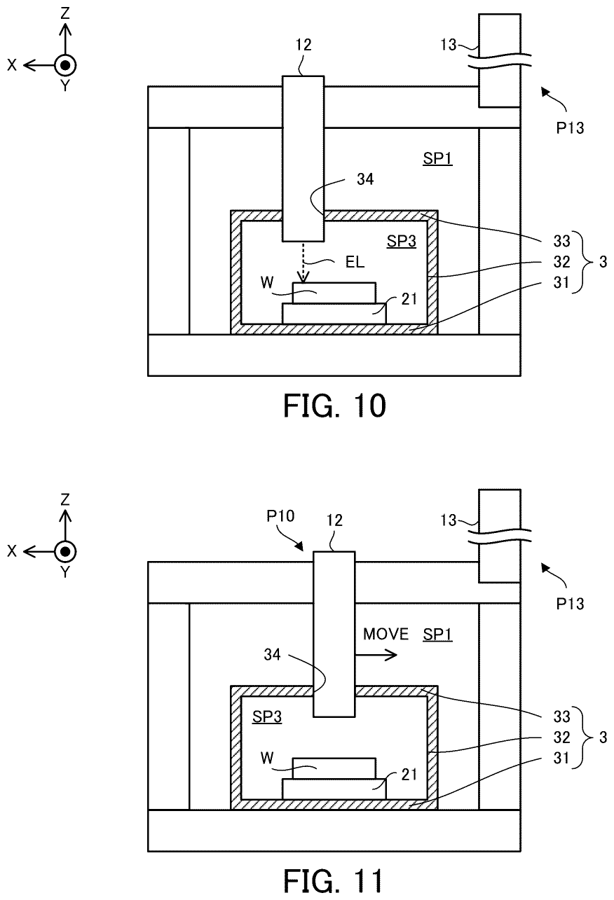

Next, with reference to FIG. 10 to FIG. 15, a switching between the processing head 12 and the processing head 13 will be described. Specifically, an operation for switching a state of the processing system SYSa from a state where one of the processing heads 12 or 13 is inserted into the aperture 34 to a state where the other one of the processing heads 12 and 13 is inserted into the aperture 34 will be described.

In the below-described description, the operation for switching the state of the processing system SYSa from the state where the processing head 12 is inserted into the aperture 34 to the state where the processing head 13 is inserted into the aperture 34 will be described for convenience of description. However, even in a case where the state of the processing system SYSa is switched from the state where the processing head 13 is inserted into the aperture 34 to the state where the processing head 12 is inserted into the aperture 34, the processing system SYSa may perform an operation that is the same as the operation described below.

FIG. 10 is a cross-sectional view that illustrates the processing system SYSa in which the processing head 12 is inserted into the aperture 34. Namely, FIG. 10 is a cross-sectional view that illustrates the processing system SYSa in the first processing period during which the processing head 12 processes the workpiece W. In this case, the processing head 12 may process the workpiece W by irradiating the workpiece W with the processing light EL. On the other hand, the processing head 13 may be positioned at the wait position P13.

After the processing head 12 has finished processing the workpiece W, the processing head 12 may mov to a predetermined replacement position P10 under the control of the control unit 4, as illustrated in FIG. 11 that is a cross-sectional view illustrating the processing head 12 that has finished processing the workpiece W. Namely, after the first processing period during which the processing head 12 processes the workpiece W has ended, the processing head 12 may move to the replacement position P10. The replacement position P10 may be a position at which the switching between the processing head 12 and the processing head 13 is performed.

The replacement position P10 may typically be a position that is determined in advance. A position that is directly above a center of the stage 21 in a plane along the XY plane is one example of the replacement position P10. A position that is directly above a center of the housing 3 in the plane along the XY plane is one example of the replacement position P10. A position that is directly above a center of the ceiling member 33 in the plane along the XY plane is one example of the replacement position P10. In this case, information related to the replacement position P10 may be information known to the control unit 4. As one example, a position of the aperture 34 at a timing at which the processing head 12 is inserted into the aperture 34 may be detected by a sensor, and a detected result by the sensor may be used as the information related to the replacement position P10. In this case, a driving system for moving the aperture 34 (the aperture member 331) may be used to move the aperture 34, into which the processing head 12 is not inserted, to the replacement position P10. This driving system may be positioned in the ceiling member 33, for example.

However, a position of the processing head 12 at the timing at which the processing head 12 has finished processing the workpiece W may be used as the replacement position P10. In this case, the processing head 12 may be considered to have already been positioned at the replacement position P10 at the timing at which the processing head 12 has finished processing the workpiece W. Therefore, in this case, the processing head 12 may not move to the replacement position P10 under the control of the control unit 4 after the processing head 12 has finished processing the workpiece W.

Incidentally, when the processing head 12 moves to the replacement position P10, the aperture 34 into which the processing head 12 is inserted is also positioned at the replacement position P10. Namely, the aperture member 331, in which the aperture 34 is formed, is also positioned at the replacement position P10. Therefore, a position of the aperture 34 (specifically, a position of the aperture member 331) at the timing at which the processing head 12 has finished processing the workpiece W may be used as the replacement position P10.

In a case where the position of the processing head 12 at the timing at which the processing head 12 has finished processing the workpiece W is used as the replacement position P10, the control unit 4 may acquire, as the information related to the replacement position P10, information related to the position of the processing head 12 at the timing at which the processing head 12 has finished processing the workpiece W from a non-illustrated position measurement apparatus that is configured to measure the position of the processing head 12. The control unit 4 may move the processing head 13 to the replacement position P10 indicated by the acquired information, as described later with reference to FIG. 13.

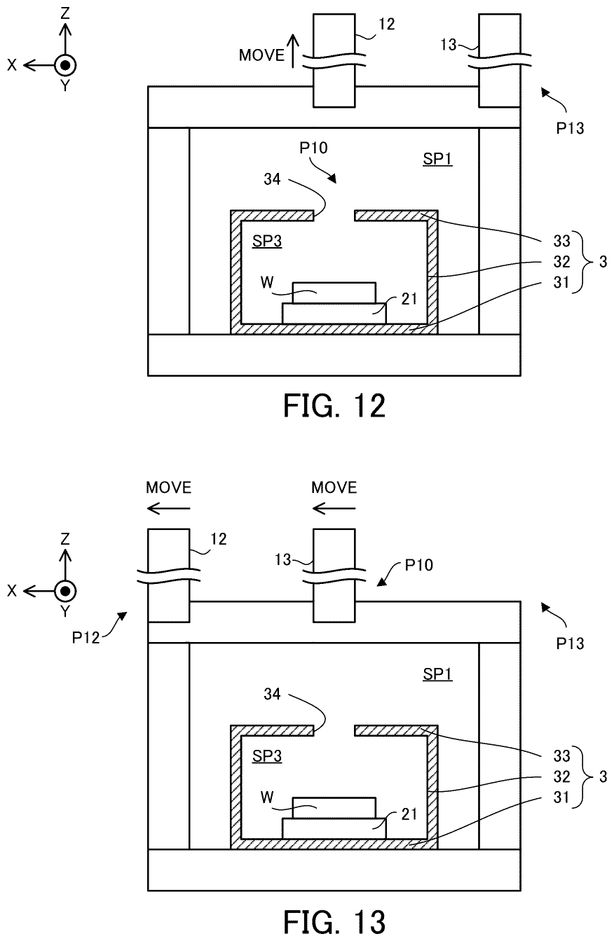

After the processing head 12 has moved to the replacement position P10, the processing head 12 moves under the control of the control unit 4 so that the processing head 12 is removed from the aperture 34, as illustrated in FIG. 12 that is a cross-sectional view illustrating the processing head 12 positioned at the replacement position P10. Specifically, as illustrated in FIG. 12, the processing head 12 moves in the Z-axis direction toward the +Z side.

After the processing head 12 has been removed from the aperture 34, the processing head 12 may move to the wait position P12 under the control of the control unit 4, as illustrated in FIG. 13 that is a cross-sectional view illustrating the processing head 12 removed from the aperture 34. Furthermore, the processing head 13 positioned at the wait position P13 may move to the replacement position P10 under the control of the control unit 4. Specifically, the control unit 4 controls the head driving system 14 based on information related to the replacement position P10 so that the processing head 13 moves to the replacement position P10. In this case, the processing head 13 may move to the replacement position P10 in at least a part of a period during which the processing head 12 moves to the wait position P12. Namely, at least a part of the movement of the processing head 12 and at least part of the movement of the processing head 13 may be performed in parallel. Alternatively, the processing head 13 may move to the replacement position P10 after the processing head 12 has reached the wait position P12.

In the period during which the processing head 12 moves to the wait position P12, the processing head 12 is not inserted into the aperture 34. Therefore, in the period during which the processing head 12 moves to the wait position P12, the aperture 34 (specifically, the aperture member 331) may remain stationary. Similarly, in the period during which the processing head 13 moves to the replacement position P10, the processing head 13 is not inserted into the aperture 34. Therefore, the aperture 34 (specifically, the aperture member 331) may remain stationary in the period during which the processing head 13 moves to the replacement position P10. Namely, the aperture 34 (specifically, the aperture member 331) may remain stationary in at least a part of a period between an end of the first processing period in which the processing head 12 processes the workpiece W and a start of the second processing period in which the processing head 13 processes the workpiece W.

In a case where the processing heads 12 and 13 are not inserted into the aperture 34, the aperture 34 (the aperture member 331) may be fixed in order to prevent the aperture 34 from unintentionally moving away from the replacement position P10. For example, the aperture 34 (the aperture member 331) may be fixed at the replacement position P10 by using a fixing member such as a fixing pin.

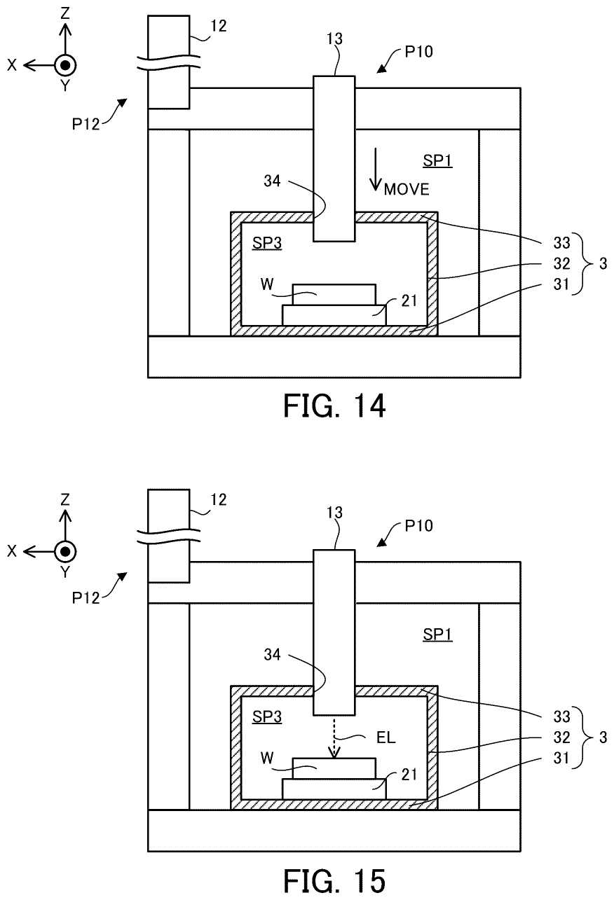

After the processing head 13 has moved to the replacement position P10, the processing head 12 moves under the control of the control unit 4 so that at least a part of the processing head 13 is inserted into the aperture 34, as illustrated in FIG. 14 that is a cross-sectional view illustrating the processing head 13 positioned at the replacement position P10. Specifically, as illustrated in FIG. 14, the processing head 13 moves in the Z-axis direction toward the −Z side.

After at least a part of the processing head 13 has been inserted into the aperture 34, the processing head 13 may process the workpiece W by irradiating the workpiece W with the processing light EL, as illustrated in FIG. 15 that is a cross-sectional view illustrating the processing head 13 inserted into the aperture 34.

### (1-3) Technical Effect of Processing System SYSa

As described above, the processing system SYSa in the first example embodiment can process the workpiece W properly by using two processing heads 12 and 13. For example, the processing system SYSa may process the workpiece W by using the processing head 12 with a first type of processing method and process the workpiece W by using the processing head 13 with a second type of processing method. Therefore, the processing system SYSa can process the workpiece W in a wide variety of processing modes, compared to a processing system in a comparative example that includes a single processing head.

Furthermore, in a case where at least one of the processing heads 12 and 13 is configured to perform any operation that is different from the processing operation, the processing system SYSa may perform a desired operation on the workpiece W by using the two processing heads 12 and 13. For example, the processing system SYSa may process the workpiece W by using the processing head 12 and measure the workpiece W by using the processing head 13 that is configured to serve as a measurement head. In this case, the processing system SYSa may process the workpiece W by using the processing head 12 based on a measured result of the workpiece W by the processing head 13. Therefore, the processing system SYSa can perform a wide variety of operations on the workpiece W compared to the processing system in the comparative example that includes the single processing head.

Furthermore, in the first example embodiment, either one of the processing heads 12 and 13 may be inserted into the aperture 34 exclusively. Namely, either one of the processing heads 12 and 13 may be positioned in the processing space SP3 exclusively. As a result, even in a case where the processing system SYSa includes two processing heads 12 and 13, the two processing heads 12 and 13 do not process the workpiece W at the same time. As a result, the processing operation performed by one of the two processing heads 12 and 13 does not affect the processing operation performed by the other one of the two processing heads 12 and 13. Therefore, even in a case where the processing system SYSa includes the two processing heads 12 and 13, the processing system SYSa can properly process the workpiece W by using the two processing heads 12 and 13.

Furthermore, in the first example embodiment, a part of the processing head 12 is positioned in the processing space SP3 and another part of the processing head 12 may not be positioned in the processing space SP3 in a state where the processing head 12 is inserted into the aperture 34. Therefore, a size of the processing space SP3 can be reduced compared to a case where the entire processing head 12 is required to be positioned in the processing space SP3. Similarly, in the first example embodiment, a part of the processing head 13 is positioned in the processing space SP3 and another part of the processing head 13 may not be positioned in the processing space SP3 in a state where the processing head 13 is inserted into the aperture 34. Therefore, the size of the processing space SP3 can be reduced compared to a case where the entire processing head 13 is required to be positioned in the processing space SP3. Therefore, the processing system SYSa can perform the processing operation using each of the processing heads 12 and 13 efficiently. For example, the processing system SYSa can reduce a time required to purge the processing space SP3 with the purge gas, and as a result, can reduce a time required to process the workpiece W. For example, the processing system SYSa can reduce a time required to evacuate the processing space SP3, and as a result, the time required to process the workpiece W can be reduced.

Furthermore, in the first example embodiment, the processing head 12 is movable in a state where the processing head 12 is inserted into the aperture 34. Therefore, even in a case where the workpiece W is contained in the processing space SP3 of the housing 3, a processing range that is allowed to be processed by the processing head 12 is not significantly restricted to a narrow range. Therefore, the processing head 12 can process larger workpieces W properly, compared to a case where the processing head 12 is not movable in a state where the processing head 12 is inserted into the aperture 34. For the same reason, the processing head 13 can process larger workpieces W properly, compared to a case where the processing head 13 is not movable in a state where the processing head 13 is inserted into the aperture 34.

Furthermore, in the first example embodiment, the aperture member 331, in which the aperture 34 is formed, is supported by the support members 332 and 333. Therefore, even in a case where the aperture member 331 moves due to the movement of the processing head 12 inserted into the aperture 34, the air sealing of the processing space SP3 of the housing 3 is ensured. As a result, the processing system SYSa can process the workpiece W properly by using the processing head 12 or 13 inserted in the aperture 34 while maintaining the air sealing of the processing space SP3.

Furthermore, in the first example embodiment, the processing head 12 inserted into the aperture 34 may be used as the member for ensuring the air sealing of the processing space SP3 of the housing 3 together with the housing 3. Similarly, the processing head 13 inserted into the aperture 34 may be used as the member for ensuring the air sealing of the processing space SP3 of the housing 3 together with the housing 3. Therefore, even in a case where the aperture 34 is formed in the housing 3, the air sealing of the processing space SP3 is properly ensured. Namely, even in a case where the aperture 34 is formed in the housing 3, the processing system SYSa can process the workpiece W while properly ensuring the air sealing of the processing space SP3 by inserting the processing head 12 or 13 into the aperture 34.

### (2) Processing System SYS in Second Example Embodiment

Next, a second example embodiment of the processing system SYS will be described. In the below-described description, the processing system SYS in the second example embodiment is referred to as a “processing system SYSb”.

### (2-1) Configuration of Processing System SYSb

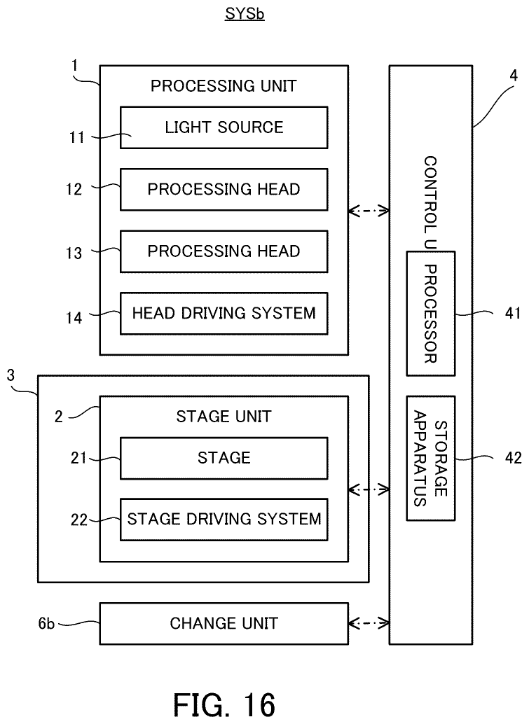

First, with reference to FIG. 16, a configuration of the processing system SYSb in the second example embodiment will be described. FIG. 16 is a block diagram that illustrates the configuration of the processing system SYSb in the second example embodiment.

As illustrated in FIG. 16, the processing system SYSb in the second example embodiment is different from the processing system SYSa in the first example embodiment in that it includes a tool change unit 6b. Incidentally, the tool change unit 6b may also be referred to as a change apparatus. Other feature of the processing system SYSb may be the same as other feature of the processing system SYSa.

The tool change unit 6b may be an apparatus that is configured to replace a member used by the processing head 12 to process the workpiece W. In other words, the tool change unit 6b may be an apparatus that is configured to replace the member of the processing head 12 to process the workpiece W. Furthermore, the tool change unit 6b may be an apparatus that is configured to replace a member used by the processing head 13 to process the workpiece W, in addition to or instead of replacing the member used by the processing head 12 to process the workpiece W. In other words, the tool change unit 6b may be an apparatus that is configured to replace the member of the processing head 13 to process the workpiece W, in addition to or instead of replacing the member of the processing head 12 to process the workpiece W. Incidentally, in the below-described description, the member used by the processing head 12 to process the workpiece W is referred to as a “tool 126”, and the member used by the processing head 13 to process the workpiece W is referred to as a “tool 136”.

As described above, the processing head 12 processes the workpiece W by irradiating the workpiece W with the processing light EL. Therefore, a member used by the processing head 12 to irradiate the workpiece W with the processing light EL is one example of the tool 126 of the processing head 12. At least one of an optical element, an optical member, and optical systems used by the processing head 12 to irradiate the workpiece W with the processing light EL is one example of the member used by the processing head 12 to irradiate the workpiece W with the processing light EL. For example, the processing head 12 processes the workpiece W by irradiating the workpiece W with the processing light EL through the irradiation optical system 125. Therefore, the irradiation optical system 125 is one example of the tool 126 of the processing head 12.

As described above, the processing head 13 processes the workpiece W by irradiating the workpiece W with the processing light EL. Therefore, a member used by the processing head 13 to irradiate the workpiece W with the processing light EL is one example of the tool 136 of the processing head 12. At least one of an optical element, an optical member, and optical systems used by the processing head 13 to irradiate the workpiece W with the processing light EL is one example of the member used by the processing head 13 to irradiate the workpiece W with the processing light EL. For example, the processing head 12 processes the workpiece W by irradiating the workpiece W with the processing light EL through the irradiation optical system 125. Therefore, the irradiation optical system 125 is one example of the tool 126 of the processing head 12.

Alternatively, in a case where the processing head 12 processes the workpiece W by using the tool (namely, performs the machining processing using the tool) as described above, the tool used by the processing head 12 to perform the machining processing is one example of the tool 126 of the processing head 12. Similarly, in a case where the processing head 13 processes the workpiece W by using the tool (namely, performs the machining processing using the tool) as described above, the tool used by the processing head 13 to perform the machining processing is one example of the tool 136 of the processing head 13.

Incidentally, in a case where the processing head 12 performs any operation that is different from the processing operation, the tool change unit 6b may be configured to replace a member used by the processing head 12 to perform any operation. For example, in a case where the processing head 12 performs the measurement operation, the tool change unit 6b may be configured to replace a member used by the processing head 12 to perform the measurement operation (for example, by the processing head 12 to measure the workpiece W). Similarly, in a case where the processing head 13 performs any operation that is different from the processing operation, the tool change unit 6b may be configured to replace a member used by the processing head 13 to perform any operation. In this case, the member used by the processing head 12 to perform any operation may be referred to as the “tool 126”, and the member used by the processing head 13 to perform any operation may be referred to as the “tool 136”.

In the second example embodiment, the tool 126 is attachable to the processing head 12 and detachable from the processing head 12. In this case, the tool change unit 6b may detach the tool 126 attached to the processing head 12. For example, the tool change unit 6b may attach the tool 126 to the processing head 12 to which the tool 126 is not attached.

For example, the tool change unit 6b may attach a first tool 126 (for example, a first irradiation optical system 125) to the processing head 12 to which the tool 126 is not attached. Then, the processing head 12 may process the workpiece W by using the first tool 126. Then, the tool change unit 6b may detach the first tool 126 attached to the processing head 12. Then, the tool change unit 6b may attach a second tool 126 (for example, a second irradiation optical system 125), which is different from the first tool 126, to the processing head 12. Namely, the tool change unit 6b may replace the first tool 126 attached to the processing head 12 with the second tool 126. Then, the processing head 12 may process the workpiece W by using the second tool 126.

Incidentally, in a case where the tool 126 is attachable to the processing head 12, the processing head 12 may mean the processing head 12 to which the tool 126 has been attached, or the processing head 12 may mean the processing head 12 to which the tool 126 has not been attached. Namely, the processing head 12 to which the tool 126 has been attached may be referred to as the first processing apparatus (alternatively, simply the first apparatus), and the processing head 12 to which the tool 126 has not been attached may be referred to as the first processing apparatus (alternatively, simply the first apparatus). In other words, in a case where the tool 126 is detachable from the processing head 12, the processing head 12 may mean the processing head 12 from which the tool 126 has been detached, or the processing head 12 may mean the processing head 12 from which the tool 126 has not been detached. Namely, the processing head 12 from which the tool 126 has been detached may be referred to as the first processing apparatus (alternatively, simply the first apparatus), and the processing head 12 from which the tool 126 has not been detached may be referred to as the first processing apparatus (alternatively, simply the first apparatus).

Similarly, in the second example embodiment, the tool 136 is attachable to the processing head 13 and detachable from the processing head 13. In this case, the tool change unit 6b may detach the tool 136 attached to the processing head 13. For example, the tool change unit 6b may attach the tool 136 to the processing head 13 to which the tool 136 is not attached.

For example, the tool change unit 6b may attach a first tool 136 to the processing head 13 to which the tool 136 is not attached. Then, the processing head 13 may process the workpiece W by using the first tool 136. Then, the tool change unit 6b may detach the first tool 136 attached to the processing head 13. Then, the tool change unit 6b may attach a second tool 136, which is different from the first tool 136, to the processing head 13. Namely, the tool change unit 6b may replace the first tool 136 attached to the processing head 13 with the second tool 136. Then, the processing head 13 may process the workpiece W by using the second tool 136.

Incidentally, in a case where the tool 136 is attachable to the processing head 13, the processing head 13 may mean the processing head 13 to which the tool 136 has been attached, or the processing head 13 may mean the processing head 13 to which the tool 136 has not been attached. Namely, the processing head 13 to which the tool 136 has been attached may be referred to as the second processing apparatus (alternatively, simply the second apparatus), and the processing head 13 to which the tool 136 has not been attached may be referred to as the second processing apparatus (alternatively, simply the second apparatus). In other words, in a case where the tool 136 is detachable from the processing head 13, the processing head 13 may mean the processing head 13 from which the tool 136 has been detached, or the processing head 13 may mean the processing head 13 from which the tool 136 has not been detached. Namely, the processing head 13 from which the tool 136 has been detached may be referred to as the second processing apparatus (alternatively, simply the second apparatus), and the processing head 13 from which the tool 136 has not been detached may be referred to as the second processing apparatus (alternatively, simply the second apparatus).

### (2-2) Configuration of Tool Change Unit b

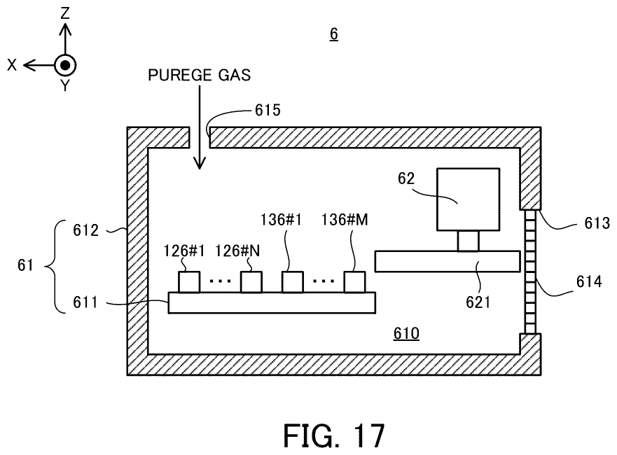

Next, with reference to FIG. 17, a configuration of the tool change unit 6b will be described. FIG. 17 is a cross-sectional view that illustrates the configuration of the tool change unit 6b.

As illustrated in FIG. 17, the tool change unit 6b includes a containing apparatus 61 and a transport apparatus 62.

The containing apparatus 61 may be configured to contain the tool 126 that is attachable to the processing head 12. In the example illustrated in FIG. 17, the containing apparatus 61 includes a containing member 611 for containing the tool 126 and a housing 612 in which a tool containing space 610 for containing the tool 126 is formed. Typically, the containing member 611 may be configured to contain a plurality of tools 126 each of which is attachable to the processing head 12. In the example illustrated in FIG. 17, the containing member 611 contains N (wherein, N is a variable that indicates an integer larger than or equal to 2) tools 126 (specifically, a tool 126#1 to a tool 126#N). Incidentally, the containing member 611 may contain a single tool 126. In other words, the processing system SYSb may include only one tool 126.

The containing member 611 may contain the plurality of tools 126 whose characteristics are different from each other. For example, the containing member 611 may contain, as at least a part of the plurality of tools 126, a plurality of optical elements whose optical characteristics are different from each other. For example, the containing member 611 may contain, as at least a part of the plurality of tools 126, a plurality of optical members whose optical characteristics are different from each other. For example, the containing member 611 may contain, as at least a part of the plurality of tools 126, a plurality of optical systems whose optical characteristics are different from each other.

As one example, the containing member 611 may contain, as at least a part of the plurality of tools 126, a plurality of irradiation optical systems 125 whose optical characteristics are different from each other. For example, the containing member 611 may contain, as at least a part of the plurality of tools 126, a plurality of irradiation optical systems 125 whose numerical apertures (NA) are different from each other. For example, the containing member 611 May contain, as at least a part of the plurality of tools 126, a plurality of irradiation optical systems 125 whose working distances are different from each other. Here, the working distance may be a distance from the terminal optical element of the irradiation optical system 125 to the condensed position of the processing light EL along the optical axis EX. For example, the containing member 611 may contain, as at least a part of the plurality of tools 126, a plurality of irradiation optical systems 125 whose sizes (namely, widths) along a direction intersecting the irradiation direction of the processing light EL are different from each other. For example, the containing member 611 may contain, as at least a part of the plurality of tools 126, a plurality of irradiation optical systems 125 whose sizes (namely, lengths) along the irradiation direction of the processing light EL are different from each other. For example, the containing member 611 may contain, as at least a part of the plurality of tools 126, a plurality of irradiation optical systems 125 whose directions for emitting the processing light EL are different from each other.

The containing apparatus 61 may be configured to contain the tool 136 that is attachable to the processing head 13, in addition to the tool 126 that is attachable to the processing head 12. Typically, the containing member 611 may be configured to contain a plurality of tools 136 each of which is attachable to the processing head 13. In the example illustrated in FIG. 17, the containing member 611 contains M (wherein, M is a variable that indicates an integer larger than or equal to 2) tools 136 (specifically, a tool 136#1 to a tool 136#M). Incidentally, the containing member 611 may contain a single tool 136. In other words, the processing system SYSb may include only one tool 136.

The containing member 611 may contain the plurality of tools 136 whose characteristics are different from each other. For example, the containing member 611 may contain, as at least a part of the plurality of tools 136, a plurality of optical elements whose optical characteristics are different from each other. For example, the containing member 611 may contain, as at least a part of the plurality of tools 136, a plurality of optical members whose optical characteristics are different from each other. For example, the containing member 611 may contain, as at least a part of the plurality of tools 136, a plurality of optical systems whose optical characteristics are different from each other.

The tool change unit 6b may include the containing member 611 that contains the plurality of tools 126 and the plurality of tools 136. Namely, the same containing member 611 may contain the plurality of tools 126 and the plurality of tools 136. Alternatively, the tool change unit 6b may include a first containing member 611 that contains the plurality of tools 126 and a second containing member 611 that contains the plurality of tools 136. Namely, two different containing members 611 may contain the plurality of tools 126 and the plurality of tools 136, respectively.

The transport apparatus 62 may be configured to transport (in other words, move) the tool 126 between the tool change unit 6b and the processing head 12. Specifically, the transport apparatus 62 may take out, from the containing member 611, the tool 126 contained in the containing member 611. Then, the transport apparatus 62 may transport the tool 126, which has been taken out from the containing member 611, to the processing head 12. Then, the transport apparatus 62 may attach the tool 126, which has been transported to the processing head 12, to the processing head 12. Furthermore, the transport apparatus 62 may detach, from the processing head 12, the tool 126 attached to the processing head 12. Then, the transport apparatus 62 may transport the tool 126, which has been detached from the processing head 12, to the containing member 611. Then, the containing member 611 may contain the tool 126, which has been transported to the containing member 611 by the transport apparatus 62.

In a case where the plurality of tools 126 are contained in the containing member 611, the control unit 4 may select one tool 126 of the plurality of tools 126 as one tool 126 that should be attached to the processing head 12. For example, the control unit 4 may select one tool 126 of the plurality of tools 126 as the one tool 126 that should be attached to the processing head 12 based on an instruction of the user of the processing system SYSb. For example, the control unit 4 may select one tool 126 of the plurality of tools 126 as the one tool 126 that should be attached to the processing head 12 based on an aspect of the first processing operation that should be performed by the processing head 12. Then, the transport apparatus 62 may transport the one tool 126 selected by the control unit 4 from the containing member 611 to the processing head 12.

The transport apparatus 62 may be configured to transport the tool 136 between the tool change unit 6b and the processing head 13, in addition to or instead of transporting the tool 126 between the tool change unit 6b and the processing head 12. Specifically, the transport apparatus 62 may take out, from the containing member 611, the tool 136 contained in the containing member 611. Then, the transport apparatus 62 may transport the tool 136, which has been taken out from the containing member 611, to the processing head 13. Then, the transport apparatus 62 may attach the tool 136, which has been transported to the processing head 13, to the processing head 13. Furthermore, the transport apparatus 62 may detach, from the processing head 13, the tool 136 attached to the processing head 13. Then, the transport apparatus 62 may transport the tool 136, which has been detached from the processing head 13, to the containing member 611. Then, the containing member 611 may contain the tool 136, which has been transported to the containing member 611 by the transport apparatus 62.

In a case where the plurality of tools 136 are contained in the containing member 611, the control unit 4 may select one tool 136 of the plurality of tools 136 as one tool 136 that should be attached to the processing head 13. For example, the control unit 4 may select one tool 136 of the plurality of tools 136 as the one tool 136 that should be attached to the processing head 13 based on an instruction of the user of the processing system SYSb. For example, the control unit 4 may select one tool 136 of the plurality of tools 136 as the one tool 136 that should be attached to the processing head 13 based on an aspect of the second processing operation that should be performed by the processing head 13. Then, the transport apparatus 62 may transport the one tool 136 selected by the control unit 4 from the containing member 611 to the processing head 13.

The transport apparatus 62 may include a transport arm 621 that is configured to temporarily hold (for example, grasp or suction) each of the tools 126 and 136 in order to transport each of the tools 126 and 136. In this case, the transport apparatus 62 may transport the tool 126 between the tool change unit 6b and the processing head 12 by using the transport arm 621. The transport apparatus 62 may transport the tool 136 between the tool change unit 6b and the processing head 13 by using the transport arm 621.

The transport apparatus 62 may include the transport arm 621 that is configured to hold the tool 126 and that is configured to hold the tool 136. Namely, the transport apparatus 62 may transport each of the tools 126 and 136 by using the same transport arm 621. Alternatively, the transport apparatus 62 may include a first transport arm 621 that is configured to hold the tool 126 and a second transport arm 621 that is configured to hold the tool 136. Namely, the transport apparatus 62 may transport the tool 126 and the tool 136 by using two different transport arms 621, respectively.

In a case where the transport apparatus 62 transports the tool 126 and the tool 136 by using the transport arm 621, a magazine-type of auto tool changer (ATC: Auto Tool Changer) used in a machine tool may be used as the tool change unit 6b. In this case, the containing member 611 may be referred to as a magazine. In other words, the magazine of the auto tool changer may be used as the containing member 611.

Alternatively, a turret-type of auto tool changer used in the machine tool may be used as the tool change unit 6b. In this case, the containing member 611 may serve as a tool pot (a registered trademark) whose shape is a drum-liked shape. In other words, the tool pot of the auto tool changer may be used as the containing member 611. In this case, the transport apparatus 62 may directly rotate the tool pot that is used as the containing member 611 so that a desired tool 126 or a desired tool 136 is positioned at a position closest to the transport apparatus 62, and then grasp or temporally hold the tool 126 or 136 positioned at the position closest to the transport apparatus 62. Alternatively, the tool pot that is used as the containing member 611 may be rotated without using a force of the transport apparatus 62 so that the desired tool 126 or the desired tool 136 is positioned at a desired position. As one example, in the example illustrated in FIG. 17, the tool pot that is used as the containing member 611 may be rotated so that the desired tool 126 that should be attached to the processing head 12 or the desired tool 136 that should be attached to the processing head 13 is positioned at the most −X side. Then, the desired tool 126 or 136 may move to protrude from a transport port 613 toward the −X side, and the processing head 12 or 13 may approach the tool 126 or 136 protruding from the transport port 613 so that the tool 126 or 136 protruding from the transport port 613 is attachable to the processing head 12 or 13.

In a case where the auto tool changer of the machine tool is used as the tool change unit 6b, the processing system SYSb may be manufactured by using the machine tool. For example, the machine tool may be used to manufacturing the processing system SYSb by attaching at least one of the processing heads 12 and 13 to a main spindle of the machine tool. In this case, an apparatus inside a housing of the machine tool that has already been designed, developed, or mass-produced may be used as a component of the processing system SYSb. For example, a stage of the machine tool may be used as the stage 21 of the processing system SYSb. For example, a guide mechanism of the machine tool may be used as at least one of the head driving system 14 and the stage driving system 22 of the processing system SYSb. Alternatively, the apparatus inside the housing of the machine tool may be improved at least partially, and the partially improved apparatus may be used as the component of the processing system SYSb. As a result, a cost of the processing system SYSb is reducible compared to a case where the component of the processing system SYSb is newly designed from scratch.

The transport apparatus 62 may be contained in the housing 612 of the containing apparatus 61. Namely, the transport apparatus 62 may be contained in the containing space 610 of the containing apparatus 61.

The transport port 613 may be formed in the housing 612. In this case, the transport apparatus 62 may transport the tool 126 between the tool change unit 6b and the processing head 12 through the transport port 613. The transport apparatus 62 may transport the tool 136 between the tool change unit 6b and the processing head 13 through the transport port 613.

A shutter member 614 may be positioned in the transport port 613. Namely, the tool change unit 6b may include the shutter member 614 positioned in the transport port 613. The shutter member 614 is a member that is allowed to be opened and closed. In a case where the shutter member 614 is opened, the transport port 613 is not blocked by the shutter member 614. Therefore, in a case where the shutter member 614 is opened, the tool containing space 610 inside the housing 612 is connected to a space outside the housing 612 through the transport port 613. On the other hand, in a case where the shutter member 614 is closed, the transport port 613 is blocked by the shutter member 614. Therefore, in a case where the shutter member 614 is closed, the tool containing space 610 inside the housing 612 is separated from the space outside the housing 612 by the shutter member 614. Here, the space outside the housing 612, which is connected to the tool containing space 610 by the transport port 613, may be at least a part of the processing space SP3, or may be a space that is different from the processing space SP3.

The tool change unit 6b may open the shutter member 614 in at least a part of a period during which the tool change unit 6b replaces the tool 126 or 136. As a result, the tool change unit 6b can replace the tool 126 or 136 through the transport port 613. On the other hand, the tool change unit 6b may close the shutter member 614 in at least a part of a period during which the tool change unit 6b does not replace the tool 126 or 136.

A gas supply port 615 may be formed in the housing 612. Inert gas such as Nitrogen gas or Argon gas may be supplied, as the purge gas (namely, gas), to the tool containing space 610 inside the housing 612 through the gas supply port 615. Namely, the processing system SYSb may supply the purge gas to the tool containing space 610 inside the housing 612 through the gas supply port 615 by using a non-illustrated gas supply apparatus. Incidentally, CDA (Clean Dry Air) may be used as the purge gas.

The purge gas may be supplied to the tool containing space 610 through the gas supply port 615 so that an air pressure in the tool containing space 610 is higher than an air pressure in the space outside the housing 612. As a result, there is a lower possibility that unnecessary substance existing in the space outside the housing 612 enters the tool containing space 610 inside the housing 612. Therefore, the tool change unit 6b can prevent the unnecessary substance from adhering to each of the tools 126 and 136 contained in the tool containing space 610.

Here, in a case where the tool containing space 610 is connected to the processing space SP3, it is possible to prevent the unnecessary substance from entering to the tool containing space 610 from the processing space SP3 even when the shutter member 614 is opened, because the air pressure of the tool containing space 610 is higher than the air pressure of the processing space SP3. it is possible to prevent the unnecessary substance from entering to the tool containing space 610 from the processing space SP3 even when a degree of the air sealing by the shutter member 614 is not so high.

The purge gas may be supplied toward the tool 126 contained in the tool containing space 610 through the gas supply port 615. For example, the purge gas may be supplied toward at least one of the plurality of tools 126 contained in the tool containing space 610 through the gas supply port 615. In this case, even in a case where the unnecessary substance adheres to the tool 126 contained in the tool containing space 610, the unnecessary substance adhering to the tool 126 is removed by the purge gas supplied toward the tool 126. Therefore, the tool change unit 6b can prevent the unnecessary substance from adhering to the tool 126 contained in the tool containing space 610.

The purge gas may be supplied toward the tool 136 contained in the tool containing space 610 through the gas supply port 615. For example, the purge gas may be supplied toward at least one of the plurality of tools 136 contained in the tool containing space 610 through the gas supply port 615. In this case, even in a case where the unnecessary substance adheres to the tool 136 contained in the tool containing space 610, the unnecessary substance adhering to the tool 136 is removed by the purge gas supplied toward the tool 136. Therefore, the tool change unit 6b can prevent the unnecessary substance from adhering to the tool 136 contained in the tool containing space 610.

At least one of the plurality of tools 126 contained in the containing space 610 may be positioned in a flow path of the purge gas from the gas supply port 615 to the transport port 613. This reduces a possibility of the unnecessary substance, which has been generated due to the processing of the workpiece W in the processing space SP3 in which the workpiece W is processed, reaching the tool 126 through the transport port 613.

At least one of the plurality of tools 136 contained in the containing space 610 may be positioned in a flow path of the purge gas from the gas supply port 615 to the transport port 613. This reduces a possibility of the unnecessary substance, which has been generated due to the processing of the workpiece W in the processing space SP3 in which the workpiece W is processed, reaching the tool 136 through the transport port 613.

### (2-3) Replacement of Each of Tools 126 and 136 in Processing Space SP3

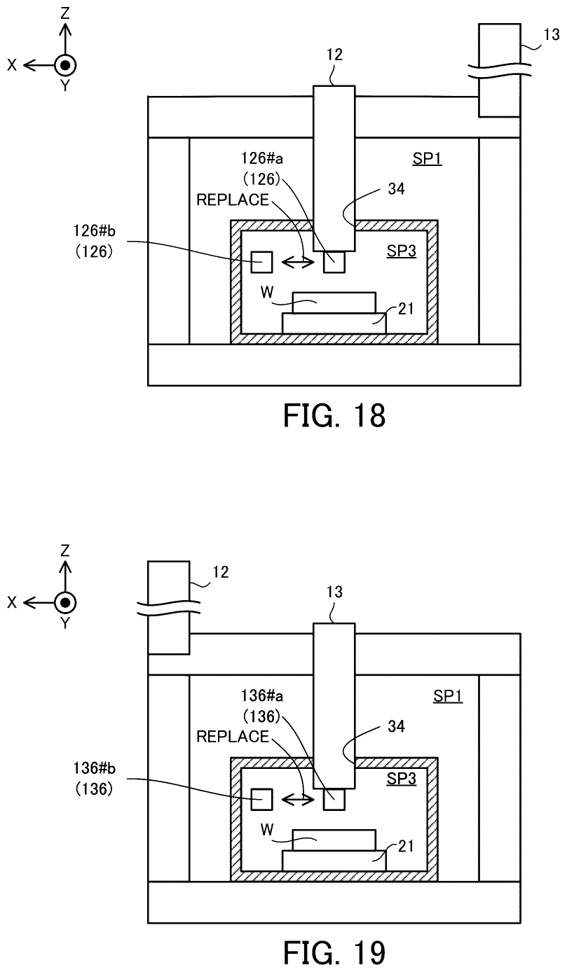

The tool change unit 6b may replace the tool 126 in the processing space SP3 inside the housing 3. The tool change unit 6b may replace the tool 136 in the processing space SP3 inside the housing 3. Next, with reference to FIG. 18 and FIG. 19, an operation for replacing each of the tools 126 and 136 in the processing space SP3 will be described.

FIG. 18 is a cross-sectional view that conceptually illustrates the operation for replacing the tool 126 in the processing space SP3. As illustrated in FIG. 18, the tool change unit 6b may replace the tool 126 in a state where the processing head 12 is inserted into the aperture 34. Namely, the tool change unit 6b may replace the tool 126 in a state where at least a part of the processing head 12 (for example, the tool 126 of the processing head 12) is positioned in processing space SP3.

Specifically, FIG. 18 illustrates the processing head 12 to which a first tool 126#a has been attached. In this case, the processing head 12 may process the workpiece W by using the first tool 126#a. After the processing head 12 has finished processing the workpiece W by using the first tool 126#a, the tool change unit 6b may detach the first tool 126#a, which has been attached to the processing head 12, from the processing head 12 inserted into the aperture 34. In this case, the tool change unit 6b may transport the first tool 126#a, which has been detached from the processing head 12, from the processing space SP3 to the tool containing space 610 of the tool change unit 6b (especially, the containing member 611 in the tool containing space 610) by using the transport apparatus 62. Then, the tool change unit 6b may attach a second tool 126#b, which is different from the first tool 126#a, to the processing head 12 inserted into the aperture 34. Specifically, the tool change unit 6b may transport the second tool 126#b, which should be attached to the processing head 12, from the tool containing space 610 of the tool change unit 6b (especially, the containing member 611 in the tool containing space 610) to the processing space SP3 by using the transport apparatus 62. Then, the tool change unit 6b may attach the second tool 126#b, which has been transported to the processing space SP3, to the processing head 12. Then, the processing head 12 may process the workpiece W by using the second tool 126#b.

In a case where the tool change unit 6b replaces the tool 126 in the processing space SP3 in this manner, the processing head 12 may remain inserted into the aperture 34 in a period during which the tool change unit 6b replaces the tool 126, which is attached to the processing head 12, from the first tool 126#a to the second tool 126#b. Namely, at least a part of the processing head 12 may remain in the processing space SP3 in the period during which the tool change unit 6b replaces the tool 126, which is attached to the processing head 12, from the first tool 126#a to the second tool 126#b. Therefore, the processing system SYSb may not remove the processing head 12 from the aperture 34 in order to replace the tool 126. Therefore, the processing system SYSb can reduce a time required to replace the tool 126, compared to a case where the processing head 12 should be removed from the aperture 34 in order to replace the tool 126.

Furthermore, the processing head 12 may remain inserted into the aperture 34 in a period from a timing at which the processing head 12 starts processing the workpiece W by using the first tool 126#a to a timing at which the processing head 12 starts processing the workpiece W by using the second tool 126#b. Namely, at least a part of the processing head 12 may remain in the processing space SP3 in the period from the timing at which the processing head 12 starts processing the workpiece W by using the first tool 126#a to the timing at which the processing head 12 starts processing the workpiece W by using the second tool 126#b. Therefore, the processing system SYSb may not remove the processing head 12 from the aperture 34. Therefore, the processing system SYSb can reduce a time required to process the workpiece W by using the first tool 126#a and the second tool 126#b, compared to a case where the processing head 12 should be removed from the aperture 34 in order to replace the tool 126.

Next, FIG. 19 is a cross-sectional view that conceptually illustrates the operation for replacing the tool 136 in the processing space SP3. As illustrated in FIG. 19, the tool change unit 6b may replace the tool 136 in a state where the processing head 13 is inserted into the aperture 34. Namely, the tool change unit 6b may replace the tool 136 in a state where at least a part of the processing head 13 (for example, the tool 136 of the processing head 13) is positioned in processing space SP3.

Specifically, FIG. 19 illustrates the processing head 13 to which a first tool 136#a has been attached. In this case, the processing head 13 may process the workpiece W by using the first tool 136#a. After the processing head 13 has finished processing the workpiece W by using the first tool 136#a, the tool change unit 6b may detach the first tool 136#a, which has been attached to the processing head 13, from the processing head 13 inserted into the aperture 34. In this case, the tool change unit 6b may transport the first tool 136#a, which has been detached from the processing head 13, from the processing space SP3 to the tool containing space 610 of the tool change unit 6b (especially, the containing member 611 in the tool containing space 610) by using the transport apparatus 62. Then, the tool change unit 6b may attach a second tool 136#b, which is different from the first tool 136#a, to the processing head 13 inserted into the aperture 34. Specifically, the tool change unit 6b may transport the second tool 136#b, which should be attached to the processing head 13, from the tool containing space 610 of the tool change unit 6b (especially, the containing member 611 in the tool containing space 610) to the processing space SP3 by using the transport apparatus 62. Then, the tool change unit 6b may attach the second tool 136#b, which has been transported to the processing space SP3, to the processing head 13. Then, the processing head 13 may process the workpiece W by using the second tool 136#b.

In a case where the tool change unit 6b replaces the tool 136 in the processing space SP3 in this manner, the processing head 13 may remain inserted into the aperture 34 in a period during which the tool change unit 6b replaces the tool 136, which is attached to the processing head 13, from the first tool 136#a to the second tool 136#b. Namely, at least a part of the processing head 13 may remain in the processing space SP3 in the period during which the tool change unit 6b replaces the tool 136, which is attached to the processing head 13, from the first tool 136#a to the second tool 136#b. Therefore, the processing system SYSb may not remove the processing head 13 from the aperture 34 in order to replace the tool 136. Therefore, the processing system SYSb can reduce a time required to replace the tool 136, compared to a case where the processing head 13 should be removed from the aperture 34 in order to replace the tool 136.

Furthermore, the processing head 13 may remain inserted into the aperture 34 in a period from a timing at which the processing head 13 starts processing the workpiece W by using the first tool 136#a to a timing at which the processing head 13 starts processing the workpiece W by using the second tool 136#b. Namely, at least a part of the processing head 13 may remain in the processing space SP3 in the period from the timing at which the processing head 13 starts processing the workpiece W by using the first tool 136#a to the timing at which the processing head 13 starts processing the workpiece W by using the second tool 136#b. Therefore, the processing system SYSb may not remove the processing head 13 from the aperture 34. Therefore, the processing system SYSb can reduce a time required to process the workpiece W by using the first tool 136#a and the second tool 136#b, compared to a case where the processing head 13 should be removed from the aperture 34 in order to replace the tool 136.

In a case where the tool change unit 6b replaces the tool 126 or 136 in the processing space SP3, the tool change unit 6b may be contained in the processing space SP3. Alternatively, a part of the tool change unit 6b may be contained in the processing space SP3, and another part of the tool change unit 6b may be contained in a space that is different from the processing space SP3 (for example, the outer space SP1 outside the housing 3). Alternatively, an aperture may be formed in the housing 3 (for example, the aperture may be formed in the side wall member 312 of the housing 3), and the tool change unit 6b may be connected to the housing 3 so that the aperture formed in the housing 3 is connected to the transport port 613 formed in the housing 612 of the tool change unit 6b.

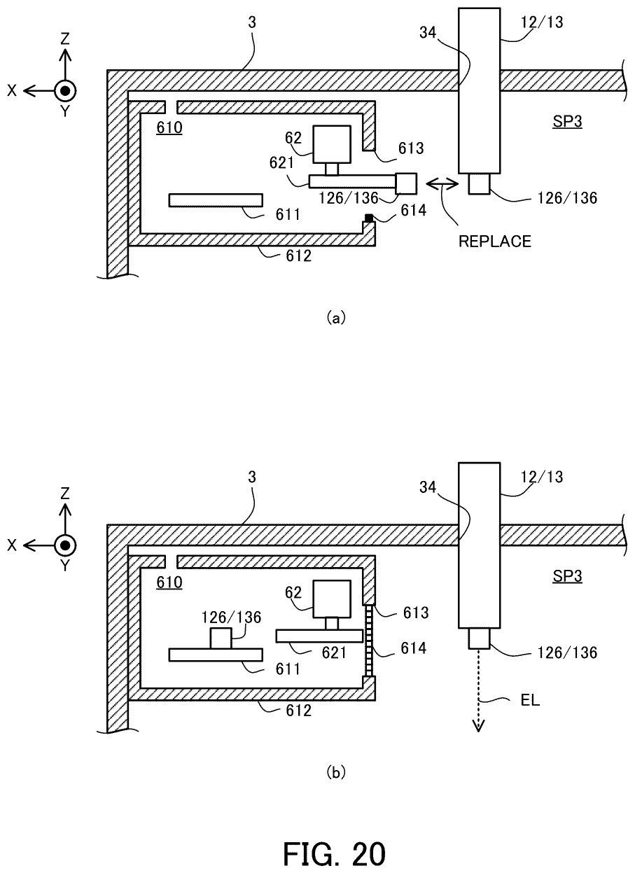

FIG. 20(a) and FIG. 20(b) illustrate one example of the tool change unit 6b contained in the processing space SP3.

FIG. 20(a) illustrates the tool change unit 6b in a period during which the tool change unit 6b replaces the tool 126 or 136. As illustrated in FIG. 20(a), in the period during which the tool change unit 6b replaces the tool 126 or 136, the tool change unit 6b may open the shutter member 614 that is positioned between the tool containing space 610 in which the tool 126 or 136 is contained and the processing space SP3 in which the processing head 12 or 13 is positioned. As a result, the tool change unit 6b may move the tool 126 or 136 between the tool containing space 610 in which the tool 126 or 136 is contained and the processing space SP3 in which the processing head 12 or 13 is positioned through the transport port 613. Namely, the tool change unit 6b may replace the tool 126 or 136 through the transport port 613. In this case, the head driving system 14 may move the processing head 12 or 13 (furthermore, the aperture member 331) in conjunction with the operation of the transport apparatus 62 so as to allow the tool change unit 6b to replace the tool 126 attached to the processing head 12 or the tool 136 attached to the processing head 13.

On the other hand, FIG. 20(b) illustrates the tool change unit 6b after the tool change unit 6b has completed replacing the tool 126 or 136. As illustrated in FIG. 20(b), after the tool change unit 6b has completed replacing the tool 126 or 136, the processing head 12 or 13 usually process the workpiece W by irradiating the workpiece W with the processing light EL. In this case, as illustrated in FIG. 20(b), the tool change unit 6b may close the shutter member 614. As a result, there is a lower possibility that the unnecessary substance generated due to the processing of the workpiece W enters the tool containing space 610 of the tool change unit 6b from the processing space SP3 in which the workpiece W exists. As a result, the tool change unit 6b can prevent the unnecessary substance from adhering to the tools 126 and 136 contained in the tool containing space 610. Incidentally, at least one of a fume, a chip (a chipped powder), and a debris generated due to the processing of the workpiece W is one example of the unnecessary substance. Furthermore, there is a lower possibility that at least one of reflected light and scattered light of the processing light EL, which has been irradiated onto the workpiece W to process the workpiece W, enters the tool containing space 610 of the tool change unit 6b from the processing space SP3 in which the workpiece W exists. Therefore, the tool change unit 6b can prevent at least one of the reflected light and the scattered light of the processing light EL from being unintentionally irradiated onto each of the tools 126 and 136 contained in the tool containing space 610.

As described above, the purge gas may be supplied to the tool containing space 610 so that the air pressure in the tool change unit 6b is higher than the air pressure in the space outside the tool change unit 6b (specifically, the space outside the housing 612). In a case where the tool change unit 6b is positioned in the processing space SP3, the purge gas may be supplied to the tool containing space 610 so that the air pressure in the tool containing space 610 inside the tool change unit 6b is higher than an air pressure in the processing space SP3 in which the workpiece W exists. As a result, there is a lower possibility that the unnecessary substance generated due to the processing of the workpiece W enters the tool containing space 610 of the tool change unit 6b from the processing space SP3 in which the workpiece W exists. Therefore, the tool change unit 6b can prevent the unnecessary substance from adhering to the tools 126 and 136 contained in the tool containing space 610.

Incidentally, as described above, the housing 3 may form the processing space SP3 by using another member in addition to or instead of at least one of the bottom member 31, the side wall member 32, and the ceiling member 33. In a case where the tool change unit 6b is positioned in the processing space SP3, the housing 3 may form the processing space SP3 in cooperation with at least a part of the tool change unit 6b. For example, the housing 3 may form the processing space SP3 in cooperation with at least a part of the housing 612 of the tool change unit 6b.

Moreover, FIG. 20(a) and FIG. 20(b) illustrate an example in which the containing member 611 of the tool change unit 6b is positioned on the +X-axis side of the processing space SP3. However, an arrangement of the containing member 611 of the tool change unit 6b is not limited to the example illustrated in FIG. 20(a) and FIG. 20(b). For example, the containing member 611 may be positioned on the −Y-side of the processing space SP3.

### (2-4) Replacement of Each of Tools 126 and 136 in Outer Space SP1

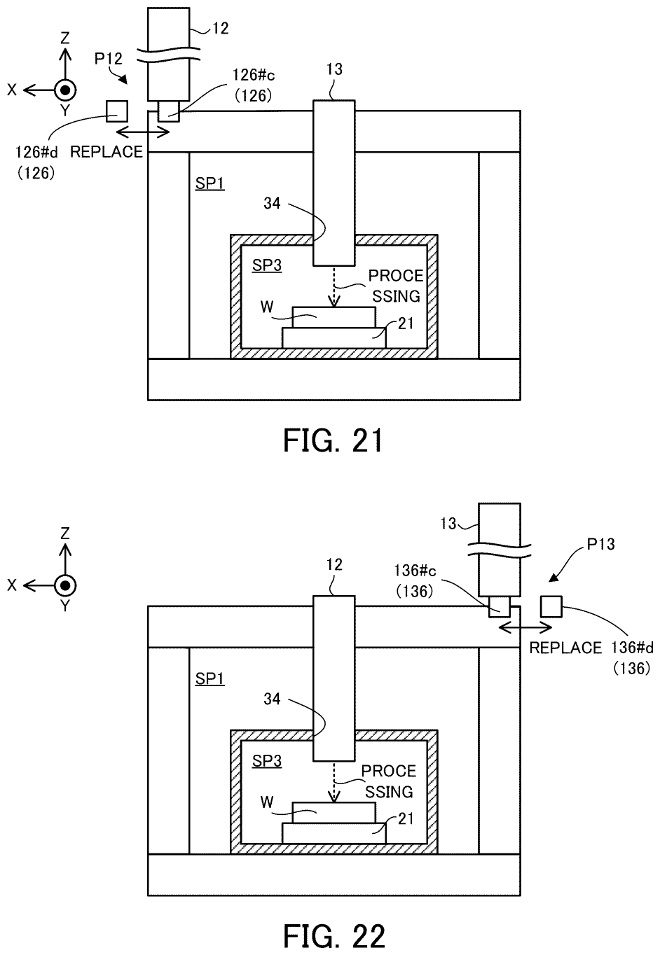

The tool change unit 6b may replace the tool 126 in the outer space SP1 outside the housing 3. The tool change unit 6b may replace the tool 136 in the outer space SP1 outside the housing 3. Next, with reference to FIG. 21 and FIG. 22, an operation for replacing each of the tools 126 and 136 in the outer space SP1 will be described.

FIG. 21 is a cross-sectional view that conceptually illustrates the operation for replacing tool 126 in the outer space SP1. As illustrated in FIG. 21, the tool change unit 6b may replace the tool 126 in at least a part of a period during which the processing head 12 is positioned in the outer space SP1. Tool change unit 6b may replace the tool 126 in at least a part of a period during which the processing head 12 is not positioned in the processing space SP3.

The tool change unit 6b may replace the tool 126 in a state where the processing head 13 is inserted into the aperture 34. The tool change unit 6b may replace the tool 126 in at least a part of the second processing period during which the processing head 13 inserted into the aperture 34 processes the workpiece W. In this case, the processing system SYSb may perform the processing of the workpiece W by the processing head 13 and the replacement of the tool 126 attached to the processing head 12 in parallel. Therefore, the processing system SYSb may effectively use at least a part of the period during which the processing head 13 processes the workpiece W as a period for replacing the tool 126 attached to the processing head 12. The processing system SYSb may effectively use at least part of the period for replacing the tool 126 attached to the processing head 12 as the period during which the processing head 13 processes the workpiece W.

However, the tool change unit 6b may replace the tool 126 in a state where the processing head 13 is not inserted into the aperture 34. The tool change unit 6b may replace the tool 126 in a state where the processing head 13 does not process the workpiece W.

The tool change unit 6b may replace the tool 126 in at least a part of a period during which the processing head 12 is positioned at the wait position P12. Namely, the tool change unit 6b may detach the tool 126 from the processing head 12 positioned at the wait position P12 and attach the tool 126 to the processing head 12 positioned at the wait position P12. In this case, there is a low or no possibility that the processing head 13 moving to process the workpiece W collides with the processing head 12 and the tool change unit 6b. Therefore, the processing head 13 can process the workpiece W without being affected by the replace of the tool 126 of the processing head 12.

As one example, in the example illustrated in FIG. 21, the processing head 12, to which a first tool 126#c has been attached, is positioned at the wait position P12. The processing head 12 may process the workpiece W by using the first tool 126#c in a state where the processing head 12 is inserted into the aperture 34, and then move to the wait position P12. Then, the tool change unit 6b may detach the first tool 126#c, which has been attached to the processing head 12, from the processing head 12 positioned at the wait position P12. Then, the tool change unit 6b may attach a second tool 126#d, which is different from the first tool 126#c, to the processing head 12 positioned at the wait position P12. Furthermore, the processing head 13 may be inserted into the aperture 34 after the processing head 12 moves to the wait position P12. Then, the processing head 13 may process the workpiece W in a state where the processing head 13 is inserted into the aperture 34. Namely, the processing head 13 may process the workpiece W in at least a part of a period during which the tool 126 of the processing head 12 positioned at the wait position P12 is replaced.

FIG. 22 is a cross-sectional view that conceptually illustrates the operation for replacing tool 136 in the outer space SP1. As illustrated in FIG. 22, the tool change unit 6b may replace the tool 136 in at least a part of a period during which the processing head 13 is positioned in the outer space SP1. Tool change unit 6b may replace the tool 136 in at least a part of a period during which the processing head 13 is not positioned in the processing space SP3.

The tool change unit 6b may replace the tool 136 in a state where the processing head 12 is inserted into the aperture 34. The tool change unit 6b may replace the tool 136 in at least a part of the first processing period during which the processing head 12 inserted into the aperture 34 processes the workpiece W. In this case, the processing system SYSb may perform the processing of the workpiece W by the processing head 12 and the replacement of the tool 136 attached to the processing head 13 in parallel. Therefore, the processing system SYSb may effectively use at least a part of the period during which the processing head 12 processes the workpiece W as a period for replacing the tool 136 attached to the processing head 13. The processing system SYSb may effectively use at least part of the period for replacing the tool 136 attached to the processing head 13 as the period during which the processing head 12 processes the workpiece W.

However, the tool change unit 6b may replace the tool 136 in a state where the processing head 12 is not inserted into the aperture 34. The tool change unit 6b may replace the tool 136 in a state where the processing head 12 does not process the workpiece W.

The tool change unit 6b may replace the tool 136 in at least a part of a period during which the processing head 13 is positioned at the wait position P13. Namely, the tool change unit 6b may detach the tool 136 from the processing head 13 positioned at the wait position P13 and attach the tool 136 to the processing head 13 positioned at the wait position P13. In this case, there is a low or no possibility that the processing head 12 moving to process the workpiece W collides with the processing head 13 and the tool change unit 6b. Therefore, the processing head 12 can process the workpiece W without being affected by the replace of the tool 136 of the processing head 13.

As one example, in the example illustrated in FIG. 22, the processing head 13, to which a first tool 136#c has been attached, is positioned at the wait position P13. The processing head 13 may process the workpiece W by using the first tool 136#c in a state where the processing head 13 is inserted into the aperture 34, and then move to the wait position P13. Then, the tool change unit 6b may detach the first tool 136#c, which has been attached to the processing head 13, from the processing head 13 positioned at the wait position P13. Then, the tool change unit 6b may attach a second tool 136#d, which is different from the first tool 136#c, to the processing head 13 positioned at the wait position P13. Furthermore, the processing head 12 may be inserted into the aperture 34 after the processing head 13 moves to the wait position P13. Then, the processing head 12 may process the workpiece W in a state where the processing head 12 is inserted into the aperture 34. Namely, the processing head 13 may process the workpiece W in at least a part of a period during which the tool 136 of the processing head 13 positioned at the wait position P13 is replaced.

In a case where the tool change unit 6b replaces the tool 126 or 136 in the outer space SP1, the tool change unit 6b may be positioned in the outer space SP1. As a result, a degree of freedom of the position of the tool change unit 6b increases, compared to a case where the tool change unit 6b is positioned in the processing space SP3. Furthermore, there is a lower possibility that the unnecessary substances, which has been generated due to the processing of the workpiece W, enters the tool containing space 610 of the tool change unit 6b, compared to a case where the tool change unit 6b is positioned in the processing space SP3.

Incidentally, as described above, the housing 3 may form the outer space SP1 by using another member in addition to or instead of at least one of the bottom member 31, the side wall member 32, and the ceiling member 33. In a case where the tool change unit 6b is positioned in the outer space SP1, the housing 3 may form the processing space SP3 in cooperation with at least a part of the tool change unit 6b. For example, the housing 3 may form the processing space SP3 in cooperation with at least a part of the housing 612 of the tool change unit 6b.

### (3) Processing System SYS in Third Example Embodiment

Next, a third example embodiment of the processing system SYS will be described. In the below-described description, the processing system SYS in the third example embodiment is referred to as a “processing system SYSc”.

### (3-1) Configuration of Processing System SYSc

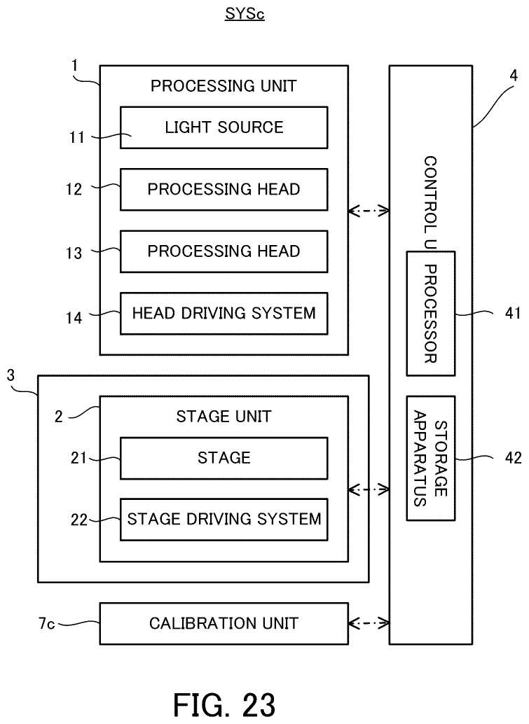

First, with reference to FIG. 23, a configuration of the processing system SYSc in the third example embodiment will be described. FIG. 23 is a block diagram that illustrates the configuration of the processing system SYSc in the third example embodiment.

As illustrated in FIG. 23, the processing system SYSc in the third example embodiment is different from at least one of the processing system SYSa in the first example embodiment and the processing system SYSb in the second example embodiment in that it includes a calibration apparatus 7c. Incidentally, the calibration apparatus 7c may be referred to as a calibration member or a calibration unit. Other feature of the processing system SYSc may be the same as other feature of at least one of the processing systems SYSa to SYSb.

The calibration apparatus 7c may be used to calibrate at least one of the processing heads 12 and 13. In this case, the processing system SYSc may calibrate at least one of the processing heads 12 and 13 by using the calibration apparatus 7c. Specifically, the control unit 4 may calibrate at least one of the processing heads 12 and 13 by using the calibration apparatus 7c.

Incidentally, in the third example embodiment, an “operation for calibrating the processing head 12” may mean an operation for setting a state of the processing head 12 to a desired state. The “operation for calibrating the processing head 12” may mean an operation for setting the state of processing head 12 to the desired state that is suitable for the usage of the processing head 12. The “operation for calibrating the processing head 12” may mean an operation for setting the state of the processing head 12 to the desired state in which the processing head 12 operates in a desired operational aspect. The “operation for calibrating the processing head 12” may mean an operation for adjusting the state of the processing head 12 so that the state of the processing head 12 is the desired state. Similarly, in the third example embodiment, an “operation for calibrating the processing head 13” may mean an operation for setting a state of the processing head 13 to a desired state. The “operation for calibrating the processing head 13” may mean an operation for setting the state of processing head 13 to the desired state that is suitable for the usage of the processing head 13. The “operation for calibrating the processing head 13” may mean an operation for setting the state of the processing head 13 to the desired state in which the processing head 12 operates in a desired operational aspect. The “operation for calibrating the processing head 13” may mean an operation for adjusting the state of the processing head 13 so that the state of the processing head 12 is the desired state.

In a case where the processing head 12 is calibrated in this manner, there is a lower possibility that the state of the processing head 12 is significantly different from the desired state, compared to a case where the processing head 12 is not calibrated. Typically, the state of the processing head 13 is maintained in the desired state. As a result, the processing head 13 can process the workpiece W properly. Similarly, in a case where the processing head 13 is calibrated in this manner, there is a lower possibility that the state of the processing head 13 is significantly different from the desired state, compared to a case where the processing head 13 is not calibrated. Typically, the state of the processing head 13 is maintained in the desired state, compared to a case where the processing head 13 is not calibrated. Therefore, the processing head 13 can process the workpiece W properly.

The processing system SYSc may include the calibration apparatus 7c that is used to calibrate each of the processing heads 12 and 13. Namely, the processing system SYSc may calibrate each of the processing heads 12 and 13 by using the same calibration apparatus 7c. Alternatively, the processing system SYSc may include a first calibration apparatus 7c that is used to calibrate the processing head 12 and a second calibration apparatus 7c that is used to calibrate the processing head 13. Namely, the processing system SYSc may calibrate the processing heads 12 and 13 by using use two different calibration apparatuses 7c, respectively.

The calibration apparatus 7c may be configured to optically receive the processing light EL emitted from the processing head 12. In this case, the control unit 4 may calibrate the processing head 12 based on a light receiving result of the processing light EL by the calibration apparatus 7c. For example, the control unit 4 may calibrate (for example, adjust, the same may be applied to the below-described description) the irradiation position PA of the processing light EL emitted from the processing head 12 based on the light receiving result of the processing light EL by the calibration apparatus 7c. For example, the control unit 4 may calibrate the irradiation position PA of the processing light EL emitted from the processing head 12 based on the light receiving result of the processing light EL by the calibration apparatus 7c so that the processing light EL is irradiated onto a desired position. For example, the control unit 4 may calibrate the irradiation position PA of the processing light EL emitted from the processing head 12 based on the light receiving result of the processing light EL by the calibration apparatus 7c so that the irradiation position PA of the processing light EL moves in a desired direction on the workpiece W. For example, the control unit 4 may calibrate the irradiation position PA of the processing light EL emitted from the processing head 12 based on the light receiving result of the processing light EL by the calibration apparatus 7c so that the irradiation position PA of the processing light EL moves by a desired distance on the workpiece W.

As described above, the processing head 12 is configured to change the irradiation position PA of the processing light EL emitted from the processing head 12 by using at least one of the Galvano mirrors 1213 and 1241 to deflect the processing light EL. In this case, the control unit 4 may calibrate the irradiation position PA of the processing light EL emitted from the processing head 12 by calibrating (for example, adjusting, the same may be applied to the below-described description) at least one of the Galvano mirrors 1213 and 1241 based on the light receiving result of the processing light EL by the calibration apparatus 7c. For example, the control unit 4 may calibrate at least one of the Galvano mirrors 1213 and 1241 so that the irradiation position PA of the processing light EL actually moves in the desired direction on the workpiece W when at least one of the Galvano mirrors 1213 and 1241 is controlled by using a Galvano control signal for moving the irradiation position PA of the processing light EL in the desired direction on the workpiece W. For example, the control unit 4 may calibrate at least one of the Galvano mirrors 1213 and 1241 so that the irradiation position PA of the processing light EL actually moves by the desired distance on the workpiece W when at least one of the Galvano mirrors 1213 and 1241 is controlled by using a Galvano control signal for moving the irradiation position PA of the processing light EL by the desired distance on the workpiece W.

The calibration apparatus 7c may be configured to optically receive the measurement light ML emitted from the processing head 12. In this case, the control unit 4 may calibrate the processing head 12 based on a light receiving result of the measurement light ML by the calibration apparatus 7c. For example, the control unit 4 may calibrate (for example, adjust, the same may be applied to the below-described description) the irradiation position MA of the measurement light ML emitted from the processing head 12 based on the light receiving result of the measurement light ML by the calibration apparatus 7c. For example, the control unit 4 may calibrate the irradiation position MA of the measurement light ML emitted from the processing head 12 based on the light receiving result of the measurement light ML by the calibration apparatus 7c so that the measurement light ML is irradiated onto a desired position. For example, the control unit 4 may calibrate the irradiation position MA of the measurement light ML emitted from the processing head 12 based on the light receiving result of the measurement light ML by the calibration apparatus 7c so that the irradiation position MA of the measurement light ML moves in a desired direction on the workpiece W. For example, the control unit 4 may calibrate the irradiation position MA of the measurement light ML emitted from the processing head 12 based on the light receiving result of the measurement light ML by the calibration apparatus 7c so that the irradiation position MA of the measurement light ML moves by a desired distance on the workpiece W.

As described above, the processing head 12 is configured to change the irradiation position MA of the measurement light ML emitted from the processing head 12 by using at least one of the Galvano mirrors 1228 and 1241 to deflect the measurement light ML. In this case, the control unit 4 may calibrate the irradiation position MA of the measurement light ML emitted from the processing head 12 by calibrating (for example, adjusting, the same may be applied to the below-described description) at least one of the Galvano mirrors 1228 and 1241 based on the light receiving result of the measurement light ML by the calibration apparatus 7c. For example, the control unit 4 may calibrate at least one of the Galvano mirrors 1228 and 1241 so that the irradiation position MA of the measurement light ML actually moves in the desired direction on the workpiece W when at least one of the Galvano mirrors 1228 and 1241 is controlled by using a Galvano control signal for moving the irradiation position MA of the measurement light ML in the desired direction on the workpiece W. For example, the control unit 4 may calibrate at least one of the Galvano mirrors 1228 and 1241 so that the irradiation position MA of the measurement light ML actually moves by the desired distance on the workpiece W when at least one of the Galvano mirrors 1228 and 1241 is controlled by using a Galvano control signal for moving the irradiation position MA of the measurement light ML by the desired distance on the workpiece W.

The calibration apparatus 7c may be configured to measure a state of the processing head 12. In this case, the control unit 4 may calibrate the processing head 12 based on a measured result of the state of the processing head 12 by the calibration apparatus 7c. An imaging apparatus that is configured to image at least a part of the processing head 12 is one example of the calibration apparatus 7c that is configured to measure the state of the processing head 12.

The calibration apparatus 7c may be configured to optically receive the processing light EL emitted from the processing head 13. In this case, the control unit 4 may calibrate the processing head 13 based on a light receiving result of the processing light EL by the calibration apparatus 7c. For example, the control unit 4 may calibrate the irradiation position PA of the processing light EL emitted from the processing head 13 based on the light receiving result of the processing light EL by the calibration apparatus 7c. For example, the control unit 4 may calibrate the irradiation position PA of the processing light EL emitted from the processing head 13 based on the light receiving result of the processing light EL by the calibration apparatus 7c so that the processing light EL is irradiated onto a desired position. For example, the control unit 4 may calibrate the irradiation position PA of the processing light EL emitted from the processing head 13 based on the light receiving result of the processing light EL by the calibration apparatus 7c so that the irradiation position PA of the processing light EL moves in a desired direction on the workpiece W. For example, the control unit 4 may calibrate the irradiation position PA of the processing light EL emitted from the processing head 13 based on the light receiving result of the processing light EL by the calibration apparatus 7c so that the irradiation position PA of the processing light EL moves by a desired distance on the workpiece W.

The calibration apparatus 7c may be configured to measure a state of the processing head 13. In this case, the control unit 4 may calibrate the processing head 13 based on a measured result of the state of the processing head 13 by the calibration apparatus 7c. An imaging apparatus that is configured to image at least a part of the processing head 13 is one example of the calibration apparatus 7c that is configured to measure the state of the processing head 13.

The control unit 4 may calibrate the processing head 13 by using a result of the calibration of the processing head 12 using the calibration apparatus 7c. For example, the control unit 4 may calibrate the irradiation position PA of the processing light EL emitted from the processing head 13 by using the result of the calibration of the irradiation position PA of the processing light EL emitted from the processing head 12. For example, the control unit 4 may calibrate the irradiation position PA of the processing light EL emitted from the processing head 13 in a calibration method that is the same as that used to calibrate the irradiation position PA of the processing light EL emitted from the processing head 12.

The control unit 4 may calibrate the processing head 12 by using a result of the calibration of the processing head 13 using the calibration apparatus 7c. For example, the control unit 4 may calibrate the irradiation position PA of the processing light EL emitted from the processing head 12 by using the result of the calibration of the irradiation position PA of the processing light EL emitted from the processing head 13. For example, the control unit 4 may calibrate the irradiation position PA of the processing light EL emitted from the processing head 12 in a calibration method that is the same as that used to calibrate the irradiation position PA of the processing light EL emitted from the processing head 13.

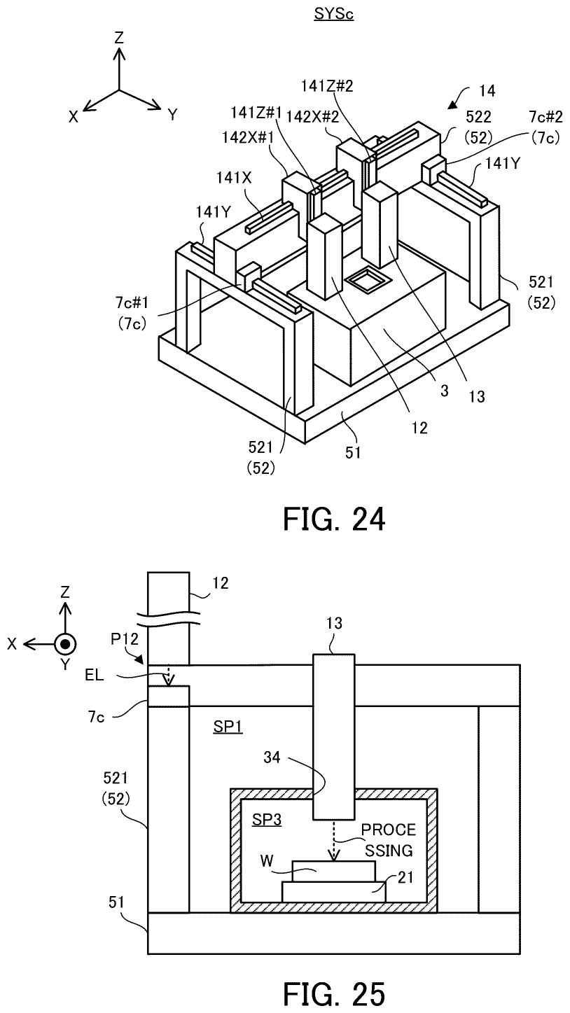

The calibration apparatus 7c may be positioned in the processing space SP3. The calibration apparatus 7c may be positioned in the outer space SP1. Two calibration apparatuses 7c may be positioned in the processing space SP3 and the outer space SP1, respectively. For example, FIG. 24 illustrates one example of the calibration apparatus 7c that is positioned in the outer space SP1. In the example illustrated in FIG. 24, two calibration apparatuses 7c are positioned on a pair of support frames 521. However, the arrangement position of the calibration apparatus 7c is not limited to the example illustrated in FIG. 24.

In a case where the calibration apparatus 7c is configured to optically receive the processing light EL emitted from the processing head 12, the calibration apparatus 7c may be positioned at a position at which the calibration apparatus 7c can optically receive the processing light EL emitted from the processing head 12. In a case where the calibration apparatus 7c is configured to optically receive the processing light EL emitted from the processing head 13, the calibration apparatus 7c may be positioned at a position at which the calibration apparatus 7c can optically receive the processing light EL emitted from the processing head 13. In a case where the calibration apparatus 7c is configured to measure the state of the processing head 12, the calibration apparatus 7c may be positioned at a position at which the calibration apparatus 7c can measure the state of the processing head 12. In a case where the calibration apparatus 7c is configured to measure the state of the processing head 13, the calibration apparatus 7c may be positioned at a position at which the calibration apparatus 7c can measure the state of the processing head 13.

The control unit 4 may calibrate the processing head 12 before the processing head 12 starts processing the workpiece W. The control unit 4 may calibrate the processing head 12 in at least a part of a period during which the processing head 12 processes the workpiece W. The control unit 4 may calibrate the processing head 12 after the processing head 12 has finished processing the workpiece W.

The control unit 4 may calibrate the processing head 13 before the processing head 13 starts processing the workpiece W. The control unit 4 may calibrate the processing head 13 in at least a part of a period during which the processing head 13 processes the workpiece W. The control unit 4 may calibrate the processing head 13 after the processing head 13 has finished processing the workpiece W.

In a case where the tool change unit 6b replaces the tool 126 of the processing head 12 as described in the second example embodiment, the control unit 4 may calibrate the processing head 12 at a timing at which the tool change unit 6b replaces the tool 126. Specifically, the control unit 4 may calibrate the processing head 12 after the tool change unit 6b has replaced the tool 126. For example, the control unit 4 may calibrate the processing head 12 so that the state of the processing head 12 is maintained in the desired state that allows the processing head 12 to properly process the workpiece W by using the tool 126 newly attached to the processing head 12. As a result, even in a case where a processing characteristic of the processing head 12 (for example, an optical characteristic related to the irradiation of the processing light EL) changes due to the replacement of the tool 126, the processing head 12 can properly process the workpiece W.

In a case where the tool change unit 6b replaces the tool 136 of the processing head 13 as described in the second example embodiment, the control unit 4 may calibrate the processing head 13 at a timing at which the tool change unit 6b replaces the tool 136. Specifically, the control unit 4 may calibrate the processing head 13 after the tool change unit 6b has replaced the tool 136. For example, the control unit 4 may calibrate the processing head 13 so that the state of the processing head 13 is maintained in the desired state that allows the processing head 13 to properly process the workpiece W by using the tool 136 newly attached to the processing head 13. As a result, even in a case where a processing characteristic of the processing head 13 (for example, an optical characteristic related to the irradiation of the processing light EL) changes due to the replacement of the tool 136, the processing head 13 can properly process the workpiece W.

The control unit 4 may calibrate the processing head 12 in at least a part of the second processing period during which the processing head 13 processes the workpiece W. For example, FIG. 25 illustrates the processing heads 12 and 13 in the second processing period. As illustrated in FIG. 25, the processing head 13 is inserted into the aperture 34 in the second processing period. Therefore, the control unit 4 may calibrate the processing head 12 by using the calibration apparatus 7c in a state where the processing head 13 is inserted into aperture 34. The control unit 4 may calibrate the processing head 12 by using the calibration apparatus 7c in a state where at least a part of the processing head 13 is positioned in the processing space SP3. In this case, the processing system SYSc may perform the processing of the workpiece W by the processing head 13 and the calibration of the processing head 12 in parallel. Therefore, the processing system SYSc may effectively use at least a part of a period during which the processing head 13 processes the workpiece W as a period for calibrating the processing head 12. The processing system SYSc may effectively use at least a part of the period for calibrating the processing head 12 as the period during which the processing head 13 processes the workpiece W.

As described above, the processing head 12 may be positioned at the wait position P12 in at least a part of the second processing period during which the processing head 13 processes the workpiece W. In this case, the control unit 4 may calibrate the processing head 12 that is positioned at the wait position P12, as illustrated in FIG. 25. Namely, the control unit 4 may calibrate the processing head 12 in at least a part of a period during which the processing head 12 is positioned at the wait position P12, as illustrated in FIG. 25. In this case, there is a low or no possibility that the processing head 13 moving to process the workpiece W collides with the processing head 12 and the calibration apparatus 7c. Therefore, the processing head 13 can process the workpiece W without being affected by the calibration of the processing head 12.

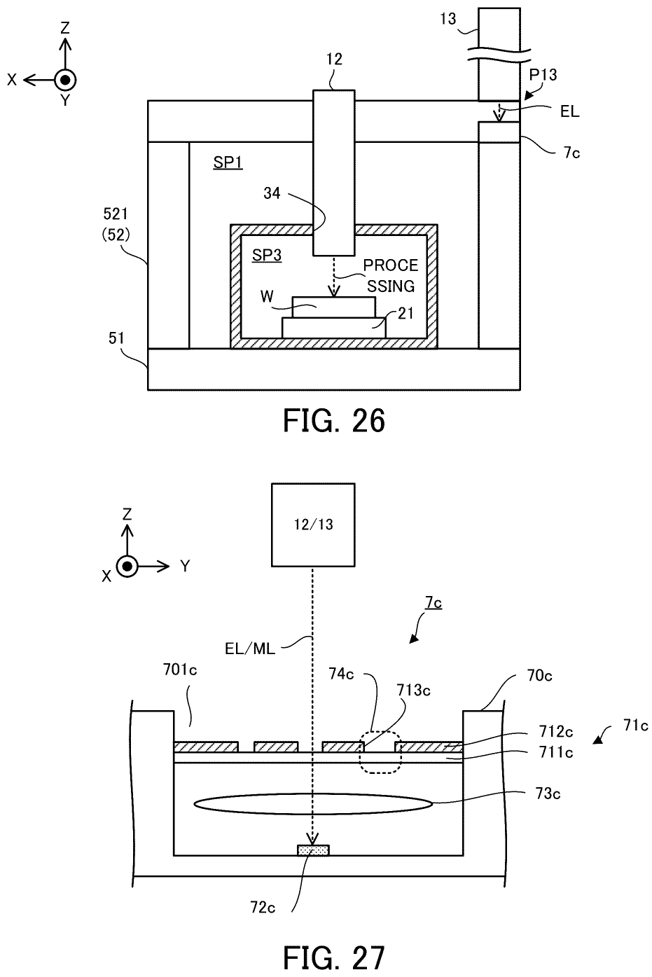

The control unit 4 may calibrate the processing head 13 in at least a part of the first processing period during which the processing head 12 processes the workpiece W. For example, FIG. 26 illustrates the processing heads 12 and 13 in the first processing period. As illustrated in FIG. 26, the processing head 12 is inserted into the aperture 34 in the first processing period. Therefore, the control unit 4 may calibrate the processing head 13 by using the calibration apparatus 7c in a state where the processing head 12 is inserted into aperture 34. The control unit 4 may calibrate the processing head 13 by using the calibration apparatus 7c in a state where at least a part of the processing head 12 is positioned in the processing space SP3. In this case, the processing system SYSc may perform the processing of the workpiece W by the processing head 12 and the calibration of the processing head 13 in parallel. Therefore, the processing system SYSc may effectively use at least a part of a period during which the processing head 12 processes the workpiece W as a period for calibrating the processing head 13. The processing system SYSc may effectively use at least a part of the period for calibrating the processing head 13 as the period during which the processing head 12 processes the workpiece W.

As described above, the processing head 13 may be positioned at the wait position P13 in at least a part of the first processing period during which the processing head 12 processes the workpiece W. In this case, the control unit 4 may calibrate the processing head 13 that is positioned at the wait position P13, as illustrated in FIG. 26. Namely, the control unit 4 may calibrate the processing head 13 in at least a part of a period during which the processing head 13 is positioned at the wait position P13, as illustrated in FIG. 26. In this case, there is a low or no possibility that the processing head 12 moving to process the workpiece W collides with the processing head 13 and the calibration apparatus 7c. Therefore, the processing head 12 can process the workpiece W without being affected by the calibration of the processing head 13.

### (3-2) One Specific Example of Calibration Apparatus 7c

Next, one specific example of the calibration apparatus 7c will be described. In the below-described description, the calibration apparatus 7c that is configured to optically receive the processing light EL emitted from each of the processing heads 12 and 13 and the measurement light ML emitted from the processing head 12 will be described. However, the calibration apparatus 7c is not limited to the calibration apparatus 7c described below. The calibration apparatus 7c may be any apparatus as long as it is usable to calibrate at least one of the processing heads 12 and 13.

### (3-2-1) Configuration of Calibration Apparatus 7c

First, with reference to FIG. 27, a configuration of one specific example of the calibration apparatus 7c will be described. FIG. 27 is a cross-sectional view that illustrates the configuration of one specific example of the calibration apparatus 7c.

As illustrated in FIG. 12, the optical measurement apparatus 18b includes a beam passing member 71c, a light receiving element 72c, and a light receiving optical system 73c. The beam passing member 71c is a member having a formed light passing area 74c through which at least one of the processing light EL and the measurement light ML is allowed to pass. The light receiving element 72c is configured to optically receive at least one of the processing light EL and the measurement light ML that has passed through the light passing area 74c of the beam passing member 71c. The light receiving element 72c is a sensor that corresponds to the wavelength of the processing light EL and the wavelength of the measurement light ML. At least one of a photodetector, a CCD (Charge Coupled Device) sensor, a CMOS (Complementary Metal Oxide Semiconductor) sensor, and a sensor that uses an InGaAs (Indium Gallium Arsenide) element is one example of the light receiving element 72c.

Especially in the third example embodiment, the light receiving element 72c may be configured to optically receive at least one of the processing light EL and the measurement light ML, which has passed through the light passing area 74c of the beam passing member 71c, through the light receiving optical system 73c. Therefore, the beam passing member 71c may be positioned above the light receiving optical system 73c, and the light receiving optical system 73c may be positioned above the light receiving element 72c. The beam passing member 71c may be positioned between the processing head 12 or 13 and the light receiving optical system 73c, and the light receiving optical system 73c may be positioned between the beam passing member 71c and the light receiving element 72c.

The beam passing member 71c, the light receiving element 72c, and the light receiving optical system 73c may be positioned in a hole 701c (namely, a concave part) formed at a base member 70c of the calibration apparatus 7c. However, at least one of the beam passing member 71c, the light receiving element 72c, and the light receiving optical system 73c may be positioned at any position that is different from the hole 701b.

The beam passing member 71c includes a glass substrate 711c and an attenuation film 712c that is formed on at least a part of a surface of the glass substrate 711c. The attenuation film 712c is a member that is configured to attenuate the processing light EL and the measurement light ML entering the attenuation film 712c. The attenuation film 712c may include a chromium film or a chromium oxide film. Note that “the attenuation of the processing light EL by the attenuation film 712c” in the third example embodiment may include not only allowing an intensity of the processing light EL that has passed through the attenuation film 712c to be lower than an intensity of the processing light EL entering the attenuation film 712c but also shielding (namely, blocking) the processing light EL entering the attenuation film 712c. Similarly, “the attenuation of the measurement light ML by the attenuation film 712c” in the third example embodiment may include not only allowing an intensity of the measurement light ML that has passed through the attenuation film 712c to be lower than an intensity of the measurement light ML entering the attenuation film 712c but also shielding (namely, blocking) the measurement light ML entering the attenuation film 712c.

At least one aperture 713c is formed in the attenuation film 712c. In an example illustrated in FIG. 27, a plurality of apertures 713c are formed in the attenuation film 712c. The aperture 713c is a through hole that penetrates the attenuation film 712c in the Z-axis direction. Therefore, when the processing light EL enters the aperture 713c formed in the attenuation film 712c, the processing light EL passes through the beam passing member 71c through the aperture 713c. Namely, the processing light EL is not attenuated or shielded by the attenuation film 712c to enter the light receiving element 72c through the aperture 713c. Similarly, when the measurement light ML enters the aperture 713c formed in the attenuation film 712c, the measurement light ML passes through the beam passing member 71c through the aperture 713c. Namely, the measurement light ML is not attenuated or shielded by the attenuation film 712c to enter the light receiving element 72c through the aperture 713c.

In this manner, a part of the beam passing member 71c on which the attenuation film 712c is not formed (namely, a part at which the aperture 713c is formed) serves as a light passing area 74c through which each of the processing light EL and the measurement light ML is allowed to pass. Therefore, the light passing area 74c is formed at the beam passing member 71c by the aperture 713c. In a case where the plurality of apertures 713c are formed, a plurality of light passing areas 74c are formed at the beam passing member 71c by the plurality of the apertures 713c, respectively.

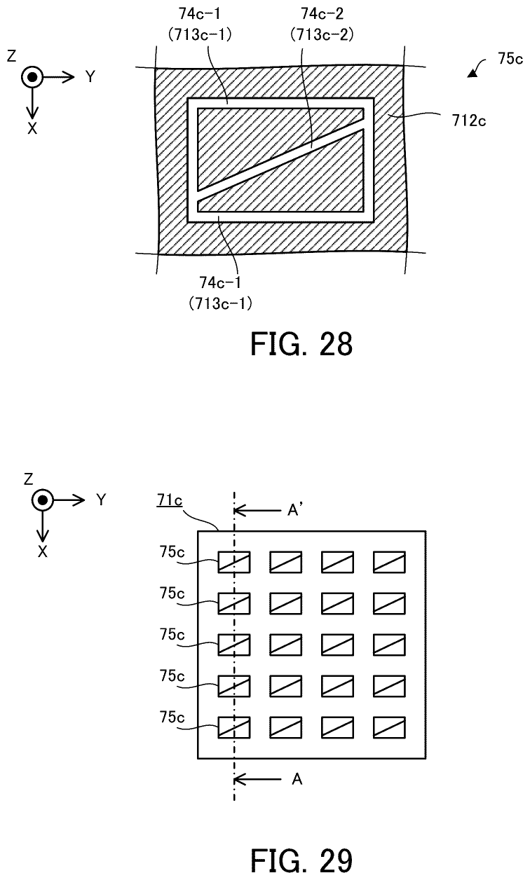

The light passing area 74c may have a predetermined shape in a plane along the surface of the beam passing member 71c (typically, the XY plane). Namely, the apertures 713c forming the light passing area 74c may have a predetermined shape in a plane along the surface of the beam passing member 71c (typically, the XY plane). In this case, the light passing area 74c may form a mark (namely, a pattern) having a predetermined shape corresponding to the shape of the light passing area 74c in a plane along the surface of the beam passing member 71c (typically, the XY plane). Namely, the mark (namely, the pattern) having the predetermined shape may be formed on the beam passing member 71c by the light passing area 74c formed by the aperture 713c having the predetermined shape. For example, as illustrated in FIG. 28, the light passing area 74c that forms a search mark 75c, which is one example of the mark, may be formed on the beam passing member 71c. The light passing area 74c that forms the search mark 75c may include two first linear light passing areas 74c-1 and one second linear light passing area 74c-2. Each of the two first linear light passing areas 74c-1 may extend along a first direction. The two first linear light passing areas 74c-1 may be away from each other along a third direction that is orthogonal to the first direction. The one second linear light passing area 74c-2 may be positioned between the two first linear light passing areas 74c-1. The one second linear light passing area 74c-2 may extend along a second direction that is inclined with respect to (namely, obliquely intersects) the first direction. Namely, the light passing area 74c that forms the search mark 75c may be formed by the two first linear apertures 713c-1, each of which extends along the first direction and which are away from each other along the third direction that is orthogonal to the first direction, and the second linear aperture 713c-2, which is positioned between the two first linear apertures 713c-1 and which extends along the second direction that is inclined with respect to (namely, obliquely intersect) the first direction. In an example illustrated in FIG. 28, the light passing area 74c that forms the search mark 75c includes the two first linear light passing area 74c-1, each of which extend along the Y-axis direction and which are away from each other along the X-axis direction that is orthogonal to the Y-axis direction, and the second linear light passing area 74c-2, which extends along a direction that is inclined with respect to (namely, obliquely intersect) the X-axis direction. Namely, in the example illustrated in FIG. 28, the light passing area 74c that forms the search mark 75c may be formed by the two first linear apertures 713c-1, each of which extend along the Y-axis direction and which are away from each other along the X-axis direction that is orthogonal to the Y-axis direction, and the second linear aperture 713c-2, which extends along a direction that is inclined with respect to (namely, obliquely intersect) the X-axis direction.

A plurality of search marks 75c (alternatively, a plurality of any marks, the same is applied in the below-described description) may be formed on the beam passing member 71c. Namely, a plurality of light passing areas 74c, which form the plurality of search marks 75c (alternatively, the plurality of any marks), may be formed at the beam passing member 71c. For example, as illustrated in FIG. 29, the plurality of search marks 75c distributed in a matrix pattern may be formed on the beam passing member 71c. In the example illustrated in FIG. 29, the plurality of search marks 75c that are regularly arranged along each of the X-axis direction and the Y-axis direction are formed on the beam passing member 71c.

In a case where the plurality of (namely, two, three, or more) search marks 75c are formed on the beam passing member 71c, each of the processing heads 12 and 13 may irradiate at least two search marks 75c that are different from each other with the processing light EL in order. Similarly, each of the processing heads 12 and 13 may irradiate at least two search marks 75c that are different from each other with the measurement light ML in order in the calibration period.

In a case where the processing unit 1c irradiates at least two search marks 75c with the processing light EL in order, the light receiving element 72c may optically receive the processing light EL that has passed through each of at least two search marks 75c. In this case, the light receiving optical system 73c may change a propagating direction of the processing light EL that has passed through each of at least two search marks 75c so that the processing light EL that has passed through each of at least two search marks 75c, which are formed at different positions on the beam passing member 71c, propagate toward the same light receiving element 72c.

In a case where the processing unit 1c irradiates at least two search marks 75c with the measurement light ML in order, the light receiving element 72c may also optically receive the measurement light ML that has passed through each of at least two search marks 75c. In this case, the light receiving optical system 73c may change a propagating direction of the measurement light ML that has passed through each of at least two search marks 75c so that the measurement light ML that has passed through each of at least two search marks 75c, which are formed at different positions on the beam passing member 71c, propagate toward the same light receiving element 72c.

(3-2-2) Calibration of Processing Head 12 using One Specific Example of Calibration Apparatus 7c

Next, an example of the calibration of the processing head 12 using one specific example of the calibration apparatus 7c illustrated in FIG. 27. Especially, the calibration of the irradiation position PA of the processing light EL emitted from the processing head 12 will be described as one example of the calibration of the processing head 12. Incidentally, the calibration of the irradiation position MA of the measurement light ML emitted from the processing head 12 and the calibration of the processing head 13 may be performed in the same manner as the calibration described below, although a detailed description thereof is omitted for avoiding a redundant description.

(3-2-2-1) Irradiation of Processing Light EL onto Calibration Apparatus 7c

The processing head 12 may irradiate at least one search mark 75c with the processing light EL in a state where a positional relationship between the processing head 12 (especially, the irradiation optical system 125) and the calibration apparatus 7c is fixed. In this case, the processing head 12 may irradiate a desired search mark 75c with the processing light EL by using at least one of the Galvano mirrors 1213 and 1241 to move the irradiation position PA of the processing light EL on the beam passing member 71c. Specifically, the control unit 4 may generate the Galvano control signal for controlling at least one of the Galvano mirrors 1213 and 1241 so as to irradiate the desired search mark 75c with the processing light EL. Then, the processing head 12 may irradiate the desired search mark 75c with the processing light EL by controlling at least one of the Galvano mirrors 1213 and 1241 based on the Galvano control signal.

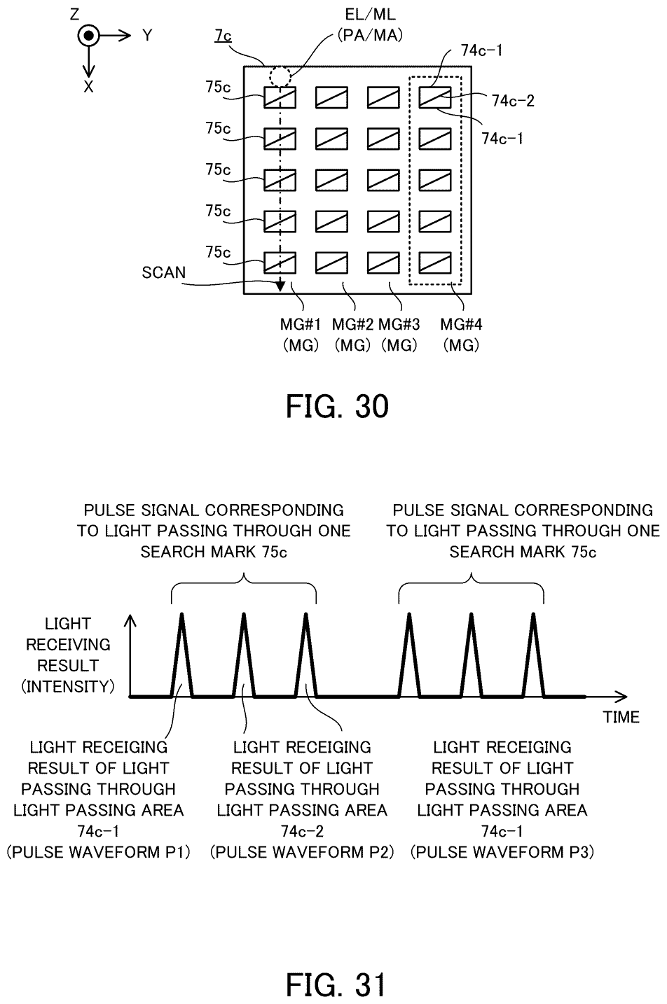

The processing head 12 may irradiate the search mark 75c with the processing light EL along a predetermined scanning direction along which the two first linear light passing areas 74c-1 and the one second linear light passing area 74c-2 forming the search mark 75c are aligned, as illustrated in FIG. 30. Namely, the processing head 12 may irradiate the search mark 75c with the processing light EL by moving the irradiation position PA of the processing light EL along the predetermined scanning direction. In the example illustrated in FIG. 30, the predetermined scanning direction is the X-axis direction. Therefore, the processing head 12 may irradiate the search mark 75c with the processing light EL by moving the irradiation position PA of the processing light EL along the X-axis direction.

In a case where the plurality of search marks 75c are formed on the calibration apparatus 7c as described above, the processing head 12 may irradiate the plurality of search marks 75c with the processing light EL in order. Namely, the processing head 12 may irradiate the plurality of search marks 75c with the processing light EL in order along a direction that is along the surface of the beam passing member 71c on which the plurality of search marks 75c are formed. In other words, the processing head 12 may scan the plurality of search marks 75c with the processing light EL in order. Namely, the processing head 12 may scan the plurality of search marks 75c with the processing light EL in order along the direction that is along the surface of the beam passing member 71c on which the plurality of search marks 75c are formed.

When the search mark 75c is irradiated with the processing light EL, the light receiving element 72c optically receives the processing light EL that has passed through the light passing area 74c that forms the search mark 75c. Namely, the light receiving element 72c optically receives the processing light EL through the search mark 75c. As a result, the light receiving element 72c optically receives the processing light EL that has passed through one of the two first linear light passing areas 74c-1 forming the search mark 75c, and then optically receives the processing light EL that has passed through the second linear light passing area 74c-2 forming the search mark 75c, and then optically receives the processing light EL that has passed through the other one of the two first linear light passing areas 74c-1 forming the search mark 75c. Therefore, the light receiving element 72c outputs light receiving information that indicates, as a light receiving result, a light receiving signal including a pulse signal in which a pulse waveform P1 corresponding to the processing light EL that has passed through one of the two first linear light passing areas 74c-1, a pulse waveform P2 corresponding to the processing light EL that has passed through the second linear light passing area 74c-2, and a pulse waveform P3 corresponding to the processing light EL that has passed through the other one of the two first linear light passing areas 74c-1 appear in order, as illustrated in FIG. 31 that is a graph illustrating the light receiving result of the processing light EL by the light receiving element 72c. In a case where the plurality of search marks 75c are irradiated with the measurement light ML in order, the light receiving element 72c outputs the light receiving information that indicates, as the light receiving result, the light receiving signal including a plurality of pulse signals in each of which the pulse waveforms P1 to P3 appear in order.

### (3-2-2-2) Generation (Acquisition) of Irradiation Position Information

Then, the control unit 4 may calculate the irradiation positions PA of the processing light EL based on the light receiving information output from the light receiving element 72c. Namely, the control unit 4 generates irradiation position information related to the irradiation positions PA of the processing light EL based on the light receiving information.

In the third example embodiment, the control unit 4 may generate, as the irradiation position information, information related to a relative positional relationship between a base irradiation position BPA of the processing light EL and an actual irradiation position PA of the processing light EL (in the below-described description, it is referred to as an “actual irradiation position APA”). Specifically, as described above, the processing head 12 irradiates one search mark 75c with the processing light EL based on the Galvano control signal for controlling at least one of the Galvano mirrors 1313 and 1341 to irradiate the one search mark 75c with the processing light EL, in order to calibrate the processing head 12 by using the calibration apparatus 7c. The base irradiation position BPA may be an ideal irradiation position PA (in other words, a designed or target irradiation position PA) of the processing light EL when the processing head 12 irradiates the one search mark 75c with the processing light EL based on the Galvano control signal for irradiating the one search mark 75c with the processing light EL. On the other hand, the actual irradiation position APA may be the actual irradiation position PA of the processing light EL when the processing head 12 irradiates the same one search mark 75c with the processing light EL based on the same Galvano control signal for irradiating the same one search mark 75c with the processing light EL. The light receiving information output from the light receiving element 72c includes information related to this actual irradiation position APA. Therefore, the control unit 4 may calculate the actual irradiation position APA based on the light receiving information. On the other hand, the information related to the base irradiation position BPA may be information known to the control unit 4. As a result, the control unit 4 may generate the irradiation position information that includes the information related to the relative positional relationship between the base irradiation position BPA and the actual irradiation position APA, based on the light receiving information and the information related to the base irradiation position BPA.

The information related to the base irradiation position BPA may be generated in advance based on the light receiving information acquired by the processing head 12 in an initial processing state irradiating the calibration apparatus 7c with the processing light EL. Therefore, the processing system SYSc may perform an initial operation for generating the information related to the base irradiation position BPA by using the processing head 12 in the initial processing state before the calibrating the processing head 12.

In a case where the plurality of search marks 75c are irradiated with the processing light EL in order as described above, the control unit 4 may generate, as the irradiation position information, the information related to the relative positional relationship between the base irradiation position BPA and the actual irradiation position APA at each of a plurality of different positions in a processing shot area PSA. Specifically, the control unit 4 may generate, as the irradiation position information, the information related to the relative positional relationship between the base irradiation position BPA and the actual irradiation position APA at a position of each of the plurality of search marks 75c distributed in the processing shot area PSA.

Incidentally, the processing shot area PSA indicates an area (in other words, a range) in which the processing head 12 performs the processing in a state where a positional relationship between the processing head 12 and the workpiece W is fixed (namely, is not changed). Typically, the processing shot area PSA is set to be an area that is the same as a scanning range or narrower than the scanning range of the processing light EL that is deflected by at least one of the Galvano mirrors 1213 and 1241 in a state where the positional relationship between the processing head 12 and the workpiece W is fixed.

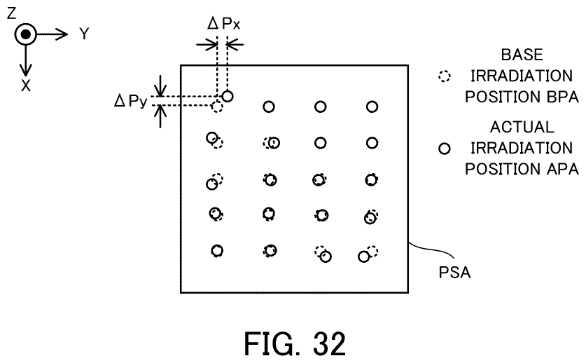

The control unit 4 may calculate, as the relative positional relationship between the base irradiation position BPA and the actual irradiation position APA, a distance (in other words, a positional deviation) between the base irradiation position BPA and the actual irradiation position APA in a direction along the surface of the beam passing member 71c. Especially, the control unit 4 may calculate the distance between the base irradiation position BPA and the actual irradiation position APA at each of the plurality of positions in the processing shot area PSA. For example, FIG. 32 illustrates the relative positional relationship between the base irradiation position BPA and the actual irradiation position APA at each of the plurality of positions in the processing shot area PSA. Considering that the surface of the beam passing member 71c is a surface that is along the XY plane, the control unit 4 may calculate a distance ΔPx between the base irradiation position BPA and the actual irradiation position APA in the X-axis direction as the relative positional relationship between the base irradiation position BPA and the actual irradiation position APA, as illustrated in FIG. 32. Especially, the control unit 4 may calculate the distance ΔPx at each of the plurality of positions in the processing shot area PSA. Furthermore, the control unit 4 may calculate a distance ΔPy between the base irradiation position BPA and the actual irradiation position APA in the Y-axis direction as the relative positional relationship between the base irradiation position BPA and the actual irradiation position APA. Especially, the control unit 4 may calculate the distance ΔPy at each of the plurality of positions in the processing shot area PSA.

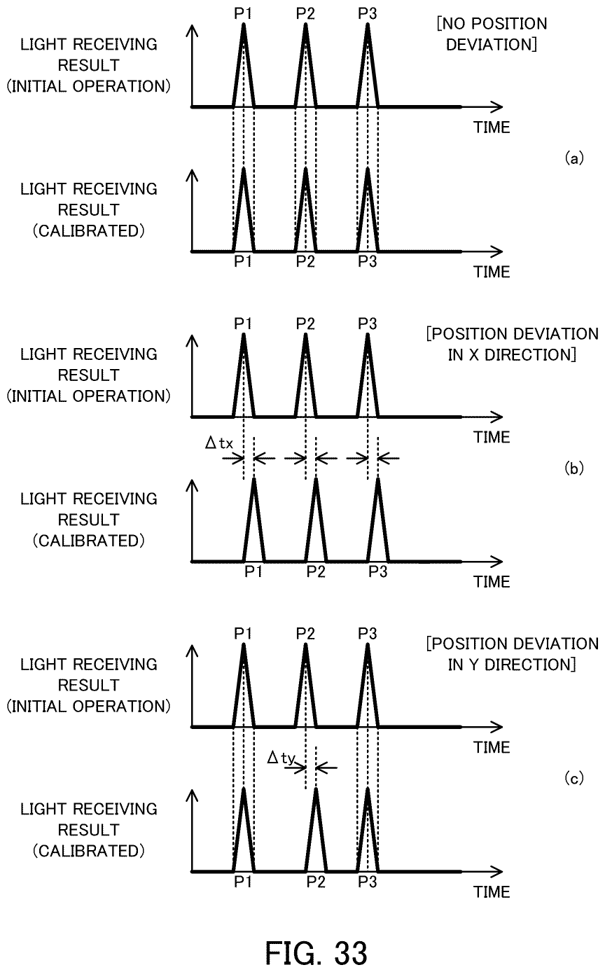

Next, with reference to FIG. 33(a) to FIG. 33(b), one example of an operation for calculating the distances ΔPx and ΔPy based on the light receiving information indicating the light receiving result of the processing light EL irradiated onto the desired search mark 75c will be described. However, the control unit 4 may calculate the distances ΔPx and ΔPy by performing an operation that is different from the below-described operation.

FIG. 33(a) illustrates the light receiving information (especially, the pulse signal in which the pulse waveforms P1 to P3 appear in order) in a case where the actual irradiation position APA is the same as the base irradiation position BPA. Especially, an upper drawing of FIG. 33(a) illustrates the light receiving information acquired in a case where the desired search mark 75c is irradiated with the processing light EL in the initial operation, and a lower drawing of FIG. 33(a) illustrates the light receiving information acquired in a case where the same desired search mark 75c is irradiated with the processing light EL in order to actually calibrate the processing head 12. In a case where the actual irradiation position APA is the same as the base irradiation position BPA, timings at which the pulse waveforms P1 to P3 appear in the initial operation are the same as timings at which the pulse waveforms P1 to P3 appear in a calibration operation, respectively.

FIG. 33(b) illustrates the light receiving information (especially the pulse signal in which the pulse waveforms P1 to P3 appear in order) in a case where the actual irradiation position APA and the base irradiation position BPA are away from each other along the X-axis direction. Especially, an upper drawing of FIG. 33(b) illustrates the light receiving information acquired in a case where the desired search mark 75c is irradiated with the processing light EL in the initial operation, and a lower drawing of FIG. 33(b) illustrates the light receiving information acquired in a case where the same desired search mark 75c is irradiated with the processing light EL in order to actually calibrate the processing head 12. In a case where the actual irradiation position APA and the base irradiation position BPA are away from each other along the X-axis direction, the timings at which the pulse waveforms P1 to P3 appear in the initial operation are advanced or delayed by a time Δtx corresponding to the distance ΔPx from the timing at which the pulse waveforms P1 to P3 appear in the calibration operation, respectively.

FIG. 33 (c) illustrates the light receiving information (especially the pulse signal in which the pulse waveforms P1 to P3 appear in order) in a case where the actual irradiation position APA and the base irradiation position BPA are away from each other along the Y-axis direction. Especially, an upper drawing of FIG. 33 (c) illustrates the light receiving information acquired in a case where the desired search mark 75c is irradiated with the processing light EL in the initial operation, and a lower drawing of FIG. 33 (c) illustrates the light receiving information acquired in a case where the same desired search mark 75c is irradiated with the processing light EL in order to actually calibrate the processing head 12. In a case where the actual irradiation position APA and the base irradiation position BPA are away from each other along the Y-axis direction, a difference between the timing at which the pulse waveform P2 appears in the initial operation and the timing at which the pulse waveform P2 appears in the calibration operation is advanced or delayed by a time Δty corresponding to the distance ΔPy, compared to a difference between the timings at which the pulse waveforms P1 and P3 appear in the initial operation and the timings at which the pulse waveforms P1 and P3 appear in the calibration operation.

Therefore, the control unit 4 may calculate the distance ΔPx based on the time Δtx corresponding to the difference between the timings at which the pulse waveforms P1 to P3 appear in the initial operation and the timings at which the pulse waveforms P1 to P3 acquired in order to actually calibrate the processing head 12 appear. The control unit 4 may calculate the distance ΔPy based on the time Δty corresponding to a difference between the difference of the timing at which the pulse waveform P2 appears in the initial operation and the timing at which the pulse waveform P2 acquired in order to actually calibrate the processing head 12 appears, and the difference of the timings at which the pulse waveform P1 and P3 appear in the initial operation and the timings at which the pulse waveform P1 and P3 acquired in order to actually calibrate the processing head 12 appear.

(3-2-2-3) Calibration of Irradiation Position PA of Processing Light EL and Irradiation Position of Measurement Light ML based on Irradiation Position Information

Then, the control unit 4 may calibrate the irradiation position PA of the processing light EL based on the irradiation position information. Specifically, the control unit 4 may calibrate the irradiation position PA of the processing light EL based on the irradiation position information so that the irradiation position PA of the processing light EL becomes a desired irradiation position.

As one example, the control unit 4 may calibrate the irradiation position PA of the processing light EL so that the actual irradiation position APA is closer to the base irradiation position BPA than before the irradiation position PA of the processing light EL is calibrated. In this case, the control unit 4 may calibrate the irradiation position PA of the processing light EL at each of the plurality of positions in the processing shot area PSA based on the information related to the relative positional relationship between the base irradiation position BPA and the actual irradiation position APA at each of the plurality of positions in the processing shot area PSA so that the actual irradiation position APA is closer to the base irradiation position BPA at each of the plurality of positions in the processing shot area PSA. Namely, the control unit 4 may calibrate the irradiation position PA of the processing light EL at one position in the processing shot area PSA based on the information related to the relative positional relationship between the base irradiation position BPA and the actual irradiation position APA at the one position in the processing shot area PSA so that the actual irradiation position APA is closer to the base irradiation position BPA at the one position in the processing shot area PSA.

As another example, the control unit 4 may calibrate the irradiation position PA of the processing light EL so that the actual irradiation position APA is the same as the base irradiation position BPA. In this case, the control unit 4 may calibrate the irradiation position PA of the processing light EL at each of the plurality of positions in the processing shot area PSA based on the information related to the relative positional relationship between the base irradiation position BPA and the actual irradiation position APA at each of the plurality of positions in the processing shot area PSA so that the actual irradiation position APA is the same as the base irradiation position BPA at each of the plurality of positions in the processing shot area PSA. Namely, the control unit 4 may calibrate the irradiation position PA of the processing light EL at one position in the processing shot area PSA based on the information related to the relative positional relationship between the base irradiation position BPA and the actual irradiation position APA at the one position in the processing shot area PSA so that the actual irradiation position APA is the same as the base irradiation position BPA at the one position in the processing shot area PSA.

As a result, the processing head 12 can properly irradiate a desired position with the processing light EL. Therefore, the processing head 12 can properly process the workpiece W.

(3-2-2-4) Modified Example of Calibration of Processing Head 12 using One Specific Example of Calibration Apparatus 7c

In the above-described description, the processing head 12 may irradiate the search mark 75c with the processing light EL by using at least one of the Galvano mirrors 1213 and 1241 so that the processing light EL scans at least one search mark 75c along the predetermined scanning direction. However, the processing head 12 may irradiate the search marks 75c with the processing light EL without using at least one of the Galvano mirrors 1213 and 1241 so that the processing light EL scans at least one of the search marks 75c along the predetermined scanning direction.

As one example, the head driving system 14 may move the processing head 12 along the predetermined scanning direction so that the processing light EL scans at least one of the search marks 75c along the predetermined scanning direction. In this case, the control unit 4 may calculate, based on the irradiation position information, a difference between a direction along which the processing head 12 actually moves and a direction along which the processing head 12 should move. For example, the difference between the direction along which the processing head 12 actually moves in a case where the head driving system 14 moves the processing head 12 along the X-axis direction and the X-axis direction may be calculated. For example, the difference between the direction along which the processing head 12 actually moves in a case where the head driving system 14 moves the processing head 12 along the Y-axis direction and the Y-axis direction may be calculated. Then, the control unit 4 may calibrate the head driving system 14 so that an error of the movement direction of the processing head 12 becomes smaller or canceled. Namely, the control unit 4 may calibrate a movement aspect of the processing head 12. Incidentally, since the head driving system 14 moves not only the processing head 12 but also the processing head 13, the control unit 4 may calibrate the movement aspect of the processing head 13 based on the error of the movement direction of the processing head 12.

As a result, the processing system SYSc can move the processing head 12 properly, compared to a case where the movement aspect of the processing head 12 is not calibrated. Similarly, the processing system SYSc can move the processing head 13 properly, compared to a case where the movement aspect of the processing head 13 is not calibrated. Therefore, the processing system SYSc can process the workpiece W properly.

As another example, the stage driving system 22 may move the stage 21 along the predetermined scanning direction so that the processing light EL scans at least one of the search marks 75c along the predetermined scanning direction. In this case, the control unit 4 may calculate, based on the irradiation position information, a difference between a direction along which the stage 21 actually moves and a direction along which the stage 21 should move. For example, the difference between the direction along which the stage 21 actually moves in a case where the stage driving system 22 moves the stage 21 along the X-axis direction and the X-axis direction may be calculated. For example, the difference between the direction along which the stage 21 actually moves in a case where the stage driving system 22 moves the stage 21 along the Y-axis direction and the Y-axis direction may be calculated. Then, the control unit 4 may calibrate the stage driving system 22 so that an error of the movement direction of the stage 21 becomes smaller or canceled. Namely, the control unit 4 may calibrate a movement aspect of the stage 21.

As a result, the processing system SYSc can move the stage 21 properly, compared to a case where the movement aspect of the stage 21 is not calibrated. Therefore, the processing system SYSc can process the workpiece W properly.

### (4) Processing System SYS in Fourth Example Embodiment

Next, a fourth example embodiment of the processing system SYS will be described. In the below-described description, the processing system SYS in the fourth example embodiment is referred to as a “processing system SYSd”. The processing system SYSd in the fourth example embodiment is different from at least one of the processing system SYSa in the first example embodiment to the processing system SYSc in the third example embodiment in that it includes a processing unit 1d instead of the processing unit 1. Other feature of the processing system SYSa may be the same as other feature of at least one of the processing systems SYSa to SYSc. The processing unit 1d is different from the processing unit 1 in that it may include a processing head 12d instead of the processing head 12. The processing unit 1d is different from the processing unit 1 in that it may include a processing head 13d instead of the processing head 13. Incidentally, the processing unit 1d may include both of the processing heads 12d and 13d. Alternatively, the processing unit 1d may include the processing heads 12 and 13d, but may not include the processing head 12d. Alternatively, the processing unit 1d may include the processing heads 12d and 13, but may not include the processing head 13d. In the below-described description, an example in which the processing unit 1d includes both of the processing heads 12d and 13d will be described for convenience of description. Other feature of the processing unit 1d may be the same as other feature of the processing unit 1.

Therefore, in the below-described description, the processing heads 12d and 13d in the fourth example embodiment will be described in order.

### (4-1) Processing Head 12d

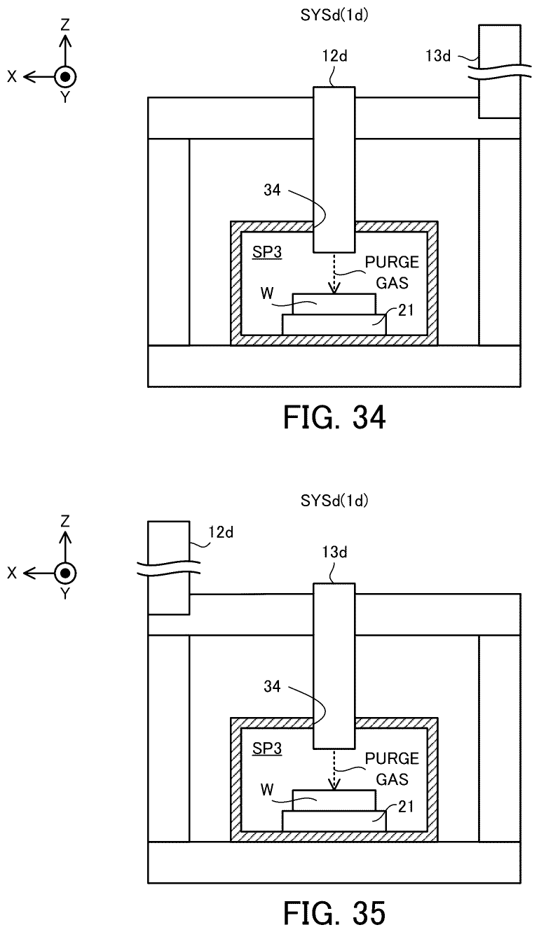

First, with reference to FIG. 34, the processing head 12d in the fourth example embodiment will be described. FIG. 34 is a cross-sectional view that illustrates the processing head 12d in the fourth example embodiment.

As illustrated in FIG. 34, the processing head 12d may be different from the processing head 12 in that it is configured to supply gas. For example, the processing head 12d may be configured to supply the gas, which is supplied to the processing head 12d from a non-illustrated gas supply apparatus, to a desired target. In the below-described description, an example in which the processing head 12d is configured to supply the purge gas, which is one example of the gas, will be described for convenience of description. The purge gas may be the inert gas such as the Nitrogen gas. Other feature of the processing head 12d may be the same as other feature of the processing head 12.

The processing head 12d may supply the purge gas to the processing space SP3 in at least a part of the period during which at least a part of the processing head 12d is inserted into the aperture 34. The processing head 12d may supply the purge gas to the processing space SP3 in at least a part of the period during which at least a part of the processing head 12d is positioned in the processing space SP3. The processing head 12d may supply the purge gas to the processing space SP3 in at least a part of the first processing period during which the processing head 12d processes the workpiece W.

The processing head 12d may supply the purge gas to the processing space SP3 to supply the purge gas to the workpiece W contained in the processing space SP3. The processing head 12d may supply the purge gas to the processing space SP3 to prevent the unnecessary substance generated due to the processing of the workpiece W from adhering to the workpiece W. The processing head 12d may supply the purge gas to the processing space SP3 to remove the unnecessary substance adhered to the workpiece W. As a result, the processing head 12d may prevent the unnecessary substance from adhering to the workpiece W. As a result, the processing head 12d can process the workpiece W properly without being affected by the unnecessary substance.

In a case where the processing head 12d processes the workpiece W by using the principle of the thermal processing as described above, the processing head 12d may supply the purge gas to the processing space SP3 to form a local purge space, which is purged with the purge gas, at the irradiation position PA of the processing light EL on the workpiece W. For example, since the processing head 12d may perform the planar processing operation using the principle of the thermal processing as described above, the processing head 12d may supply the purge gas to the processing space SP3 to form the local purge space at the irradiation position PA of the processing light EL on the workpiece W in a case where the processing head 12d performs the planar processing operation. As a result, the processing head 12d can prevent an oxidation of the surface of the workpiece W due to the thermal processing.

Incidentally, in addition to or instead of the processing head 12d, a non-illustrated gas supply apparatus may supply the purge gas to the processing space SP3. Namely, the processing system SYSd may include both of a gas supply path that supplies the purge gas from the processing head 12d to the processing space SP3 and a gas supply path that supplies the purge gas from the gas supply apparatus to the processing space SP3. In this case, the processing head 12d may supply the purge gas to the processing space SP3 after the gas supply apparatus has supplied the purge gas to the processing space SP3. The processing head 12d may supply the purge gas locally to a part of the processing space SP3 after the gas supply apparatus has supplied the purge gas to the entire processing space SP3. As a result, a time required to purge the processing space SP3 with the purge gas can be shortened, compared to a case where only the processing head 12d supplies the purge gas to the processing space SP3.

### (4-2) Processing Head 13d

Next, with reference to FIG. 35, the processing head 13d in the fourth example embodiment will be described. FIG. 35 is a cross-sectional view that illustrates the processing head 13d in the fourth example embodiment.

As illustrated in FIG. 35, the processing head 13d may be different from the processing head 13 in that it is configured to supply gas. For example, the processing head 13d may be configured to supply the gas, which is supplied to the processing head 13d from a non-illustrated gas supply apparatus, to a desired target. In the below-described description, an example in which the processing head 13d is configured to supply the purge gas, which is one example of the gas, will be described for convenience of description. The purge gas may be the inert gas such as the Nitrogen gas. Other feature of the processing head 13d may be the same as other feature of the processing head 13.

The processing head 13d may supply the purge gas to the processing space SP3 in at least a part of the period during which at least a part of the processing head 13d is inserted into the aperture 34. The processing head 13d may supply the purge gas to the processing space SP3 in at least a part of the period during which at least a part of the processing head 13d is positioned in the processing space SP3. The processing head 13d may supply the purge gas to the processing space SP3 in at least a part of the first processing period during which the processing head 13d processes the workpiece W.

The processing head 13d may supply the purge gas to the processing space SP3 to supply the purge gas to the workpiece W contained in the processing space SP3. The processing head 13d may supply the purge gas to the processing space SP3 to prevent the unnecessary substance generated due to the processing of the workpiece W from adhering to the workpiece W. The processing head 13d may supply the purge gas to the processing space SP3 to remove the unnecessary substance adhered to the workpiece W. As a result, the processing head 13d may prevent the unnecessary substance from adhering to the workpiece W. As a result, the processing head 13d can process the workpiece W properly without being affected by the unnecessary substance.

In a case where the processing head 13d processes the workpiece W by using the principle of the thermal processing as described above, the processing head 13d may supply the purge gas to the processing space SP3 to form a local purge space, which is purged with the purge gas, at the irradiation position PA of the processing light EL on the workpiece W. For example, since the processing head 13d may perform the planar processing operation using the principle of the thermal processing as described above, the processing head 13d may supply the purge gas to the processing space SP3 to form the local purge space at the irradiation position PA of the processing light EL on the workpiece W in a case where the processing head 13d performs the planar processing operation. As a result, the processing head 13d can prevent an oxidation of the surface of the workpiece W due to the thermal processing.

Incidentally, in addition to or instead of the processing head 13d, a non-illustrated gas supply apparatus may supply the purge gas to the processing space SP3. Namely, the processing system SYSd may include both of a gas supply path that supplies the purge gas from the processing head 13d to the processing space SP3 and a gas supply path that supplies the purge gas from the gas supply apparatus to the processing space SP3. In this case, the processing head 13d may supply the purge gas to the processing space SP3 after the gas supply apparatus has supplied the purge gas to the processing space SP3. The processing head 13d may supply the purge gas locally to a part of the processing space SP3 after the gas supply apparatus has supplied the purge gas to the entire processing space SP3. As a result, a time required to purge the processing space SP3 with the purge gas can be shortened, compared to a case where only the processing head 13d supplies the purge gas to the processing space SP3.

### (5) Processing System SYS in Fifth Example Embodiment

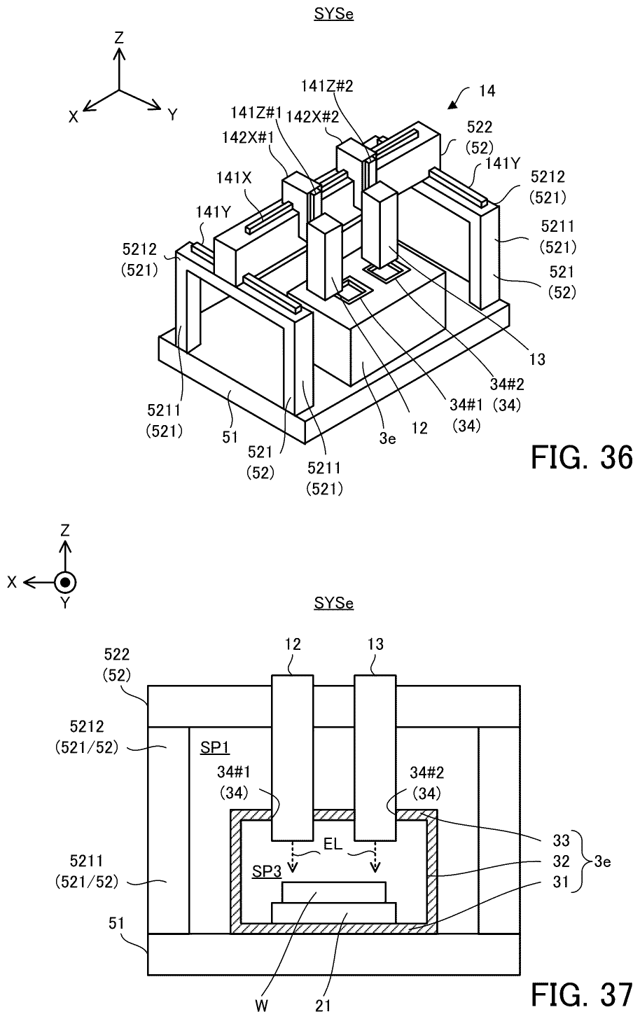

Next, a fifth example embodiment of the processing system SYS will be described. In the below-described description, the processing system SYS in the fifth example embodiment is referred to as a “processing system SYSe”. The processing system SYSe in the fifth example embodiment is different from at least one of the processing system SYSa in the first example embodiment to the processing system SYSd in the fourth example embodiment in that it includes a housing 3e instead of the housing 3. Other feature of the processing system SYSe may be the same as other feature of at least one of the processing systems SYSa to SYSd. Therefore, in the below-described description, the housing 3e in the fifth example embodiment will be described with reference to FIG. 36 and FIG. 37. FIG. 36 is a perspective view that illustrates a configuration of the processing system SYSe in the fifth example embodiment. FIG. 37 is a cross-sectional view that illustrates the configuration of the processing system SYSe in the fifth example embodiment.

As illustrated in FIG. 36 and FIG. 37, the housing 3e in the fifth example embodiment is different from the above-described housing 3 in which a single aperture 34 is formed in that a plurality of apertures 34 are formed. In the below-described description, an example in which two apertures 34 (specifically, apertures 34#1 and 34#2) are formed will be described, as illustrated in FIG. 36 and FIG. 37. Other feature of the housing 3e may be the same as other feature of the housing 3.

In the fifth example embodiment, as illustrated in FIG. 37, at least a part of the processing head 13 may be inserted into the aperture 34#2 in at least a part of a period during which at least a part of the processing head 12 is inserted into the aperture 34#1. At least a part of the processing head 12 may be inserted into the aperture 34#2 in at least a part of a period during which at least a part of the processing head 13 is inserted into the aperture 34#1. At least a part of the processing head 13 may be positioned in the processing space SP3 in at least a part of the period during which at least a part of the processing head 12 is positioned in the processing space SP3. At least a part of the processing head 12 may be positioned in the processing space SP3 in at least a part of the period during which at least a part of the processing head 13 is positioned in the processing space SP3. Namely, both of at least a part of the processing head 12 and at least a part of the processing head 13 may be positioned in the processing space SP3 at the same time.

In this case, the processing head 12 may process the workpiece W while moving the aperture 34#1 in at least a part of the first processing period during which the processing head 12 processes the workpiece W. Similarly, the processing head 13 may process the workpiece W while moving the aperture 34#2 in at least a part of the second processing period during which the processing head 13 processes the workpiece W.

The processing head 12 may move independently of the movement of the processing head 13. Namely, the processing head 12 may move regardless of the movement of the processing head 13. Similarly, the processing head 13 may move independently of the movement of the processing head 12. Namely, the processing head 13 may move regardless of the movement of the processing head 12.

A space in which the processing head 12 moves within the processing space SP3 may be distinguished from a space in which the processing head 13 moves within the processing space SP3. For example, the processing head 12 may move in a first space within the processing space SP3, and the processing head 13 may move in a second space within the processing space SP3, which is different from the first space.

In a case where the processing head 12 is inserted into the aperture 34#1 and the processing head 13 is not inserted into the aperture 34#2, the aperture 34#2 may be closed by a lid. In a case where the processing head 13 is inserted into the aperture 34#2 and the processing head 12 is not inserted into the aperture 34#1, the aperture 34#1 may be closed by a lid.

### (6) Modified Example

A lid may be positioned in the aperture 34 of the housing 3. For example, in a case where neither processing head 12 nor 13 is inserted into the aperture 34, the aperture 34 may be closed by the lid. For example, in a case where the processing head 12 or 13 is inserted in the aperture 34, the aperture 34 may not be closed by the lid. In this case, the opening and closing of the aperture 34 with the lid may be automatically performed by an apparatus that opens and closes the lid, or may be manually performed by a user of the processing system SYS. Alternatively, the processing head 12 or 13 inserted into the aperture 34 may perform the opening and closing of the aperture 34 with the lid. For example, the lid may be opened by the processing head 12 or 13 inserted into the aperture 34 pushing the lid of the aperture 34. For example, the lid may be opened by the processing head 12 or 13 inserted into the aperture 34 engaging with the lid of the aperture 34.

In the above-described description, the processing head 12 is configured to be inserted into the aperture 34 formed in the ceiling member 33 of the housing 3, and the processing head 12 inserted into the aperture 34 is configured to be removed from the aperture 34. Namely, the processing head 12 is not fixed to the ceiling member 33 of the housing 3. However, the processing head 12 may be fixed to the ceiling member 33. Typically, the processing head 12 may be fixed to the ceiling member 33 in a state where the processing head 12 is inserted into the aperture 34. In this case, the ceiling member 33 to which the processing head 12 is fixed may serve as a partition apparatus that forms (for example, surrounds) the processing space SP3 in a case where the processing head 12 processes the workpiece W. On the other hand, the ceiling member 33 to which the processing head 12 is fixed may not serve as the partition apparatus that forms (for example, surrounds) the processing space SP3 in a case where the processing head 12 does not process the workpiece W. As one example, the ceiling member 33 to which the processing head 12 is fixed may be separated from the housing 3 in a case where the processing head 12 does not process the workpiece W. In this case, the processing space SP3 may be regarded as an open space.

In the above-described description, the housing 3 includes a single ceiling member 33. However, the housing 3 may include a plurality of ceiling members 33. For example, the housing 3 may include a first ceiling member 33 in which the aperture 34 into which the processing head 12 is inserted is formed and a second ceiling member 33 in which the aperture 34 into which the processing head 13 is inserted is formed.

In the above-described description, the ceiling member 33 ensures the air sealing of the processing space SP3. As a result, the ceiling member 33 prevents the unnecessary substance from leaking from the processing space SP3 to the outer space SP1. However, the processing system SYS may prevent the unnecessary substance from leaking from the processing space SP3 to the outer space SP1 by using an air curtain in addition to or instead of the ceiling member 33.

In the above-described description, the processing system SYS includes the two processing heads 12 and 13. The processing system SYS may further include three or more processing heads (alternatively, three or more other heads that perform any operations). Even in this case, one of the three or more processing heads may be inserted into the aperture 34 exclusively. Namely, one of the three or more processing heads may be positioned in the processing space SP3 exclusively.

In a case where the processing system SYSe in the fifth example embodiment described above further includes three or more processing heads (alternatively, three or more other heads that perform any operations), three or more apertures 34 may be formed in the housing 3e. Namely, the apertures 34, whose number is equal to the number of the processing heads, may be formed in the housing 3e. Alternatively, the apertures 34, whose number is smaller than the number of the processing heads, may be formed in the housing 3e.

In the above-described description, the aperture 34 is moved (namely, the aperture member 331 is moved) by the movement of the processing heads 12 or 13. However, the processing system SYS may include an aperture driving system for moving the aperture 34 (specifically, moving the aperture member 331 in which the aperture 34 is formed). The aperture driving system may move the aperture member 331 in synchronization with the movement of at least one of the processing heads 12 and 13. For example, the aperture driving system may move the aperture member 331 in synchronization with the movement of the processing head 12 in at least a part of the processing period during which the processing head 12 processes the workpiece W. For example, the aperture driving system may move the aperture member 331 in synchronization with the movement of the processing head 13 in at least a part of the processing period during which the processing head 13 processes the workpiece W. However, the aperture driving system may move the aperture member 331 independently of the movement of at least one of the processing heads 12 and 13.

In the above-described description, the aperture 34 (the aperture member 331) moves along the XY plane. However, the aperture 34 may move along a curved surface in the XYZ coordinate system. In this case, the side wall member 32 may has a structure that is allowed to expand and contract, and the ceiling member 33 may be a curved-shaped member.

In the above-described description, the processing system SYS includes the two processing heads 12 and 13. However, the processing system SYS may include one of the processing heads 12 and 13 may not include the other one of the processing heads 12 and 13. Namely, the processing system SYS may include a single head. Alternatively, the processing system SYS may include other processing head (alternatively, any other head) in addition to the processing heads 12 and 13. Namely, the processing system SYS may include three or more processing heads.

In the above-described description, the processing system SYS includes single processing unit 1. However, the processing system SYS may include a plurality of processing units 1. In this case, the processing system SYS may include a plurality of control units 4 that control the plurality of processing units 1, respectively. As one example, the processing system SYS may include a first processing unit 1, a second processing unit 1, a first control unit 4 that controls the first processing unit 1, and a second control unit 4 that controls the second processing unit 1. Alternatively, the processing system SYS may include the control unit 4 that controls at least two of the plurality of processing units 1. As one example, the processing system SYS may include a first processing unit 1, a second processing unit 1, and a single control unit 4 that controls the first processing unit 1 and the second processing unit 2.

In the above-described description, the processing system SYS processes the workpiece W by irradiating the workpiece W with the processing light EL. Namely, the processing system SYS processes the workpiece W by irradiating the workpiece W with an energy beam in the form of light. However, the processing system SYS may process the workpiece W by irradiating the workpiece W with any energy beam that is different form the light. At least one of a charged particle beam, an electromagnetic wave and the like is one example of any energy beam. A least one of an electron beam, an ion beam and the like is one example of the charged particle beam. Moreover, in the above-described description, the processing system SYS processes the workpiece W by irradiating the workpiece W with the measurement light ML. However, the processing system SYS may measure the workpiece W by irradiating the workpiece W with any energy beam that is different from the light.

### (5) Supplementary Note

Regarding the above-described example embodiment, below described Supplementary notes are further disclosed.

### [Supplementary Note 1]

A processing system that is configured to perform a processing for changing a shape of an object, wherein
the processing system includes:
a partition apparatus that defines a part of a processing space, a flow of gas between an outer space and the processing space is restricted;
a first apparatus that is configured to perform a first operation for changing the shape of the object by processing the object contained in the processing space; and
a second apparatus that is configured to perform a second operation in the processing space,
the partition apparatus includes an aperture member in which an aperture is formed and which is movable,
in a first period during which the first apparatus performs the first operation, at least a part of the first apparatus is inserted into the aperture, which is formed in the aperture member, to be positioned in the processing space,
in the first period, the second apparatus is positioned in the outer space,
in a second period during which the second apparatus performs the second operation, at least a part of the second apparatus is inserted into the aperture to be positioned in the processing space, and
in the second period, the first apparatus is positioned in the outer space.

### [Supplementary Note 2]

The processing system according to the Supplementary Note 1, wherein
the aperture member is movable in a state where the first apparatus or the second apparatus is inserted into the aperture.

### [Supplementary Note 3]

The processing system according to the Supplementary Note 1 or 2, wherein
a switching between the first apparatus and the second apparatus is performed in a state where the aperture member is positioned at a predetermined position.

### [Supplementary Note 4]

The processing system according to the Supplementary Note 3, wherein
the aperture member moves to the predetermined position after the first period ends, and
the second apparatus moves to a position, which corresponds to the aperture after the first period ends, before the second period starts.

### [Supplementary Note 5]

The processing system according to any one of the Supplementary Notes 1 to 4, wherein
the first apparatus inserted into the aperture moves the aperture member, and
the second apparatus inserted into the aperture moves the aperture member.

### [Supplementary Note 6]

The processing system according to the Supplementary Note 5, wherein
the first apparatus inserted into the aperture moves the aperture member by using a formed that is applied from the first apparatus to the aperture member, and
the second apparatus inserted into the aperture moves the aperture member by using a formed that is applied from the second apparatus to the aperture member.

### [Supplementary Note 7]

The processing system according to the Supplementary Note 5 or 6, wherein
the first apparatus inserted into the aperture contacts with the aperture member, and
the second apparatus inserted into the aperture contacts with the aperture member.

### [Supplementary Note 8]

The processing system according to any one of the Supplementary Notes 5 to 7, wherein
the first apparatus inserted into the aperture is linked to the aperture member, and
the second apparatus inserted into the aperture is linked to the aperture member.

### [Supplementary Note 9]

The processing system according to any one of the Supplementary Notes 5 to 8 further including a movement apparatus that is configured to move each of the first and second apparatuses, wherein
the first apparatus moved by the movement apparatus moves the aperture member, and
the second apparatus moved by the movement apparatus moves the aperture member.

### [Supplementary Note 10]

The processing system according to any one of the Supplementary Notes 5 to 9, wherein
the first apparatus inserted into the aperture moves the aperture member along a movement direction of the first apparatus, and
the second apparatus inserted into the aperture moves the aperture member along a movement direction of the second apparatus.

### [Supplementary Note 11]

The processing system according to any one of the Supplementary Notes 5 to 10, wherein
the movement apparatus moves the first apparatus along a first intersection direction that intersects a first insertion direction along which the first apparatus is inserted into the aperture,
the movement apparatus moves the second apparatus along a second intersection direction that intersects a second insertion direction along which the second apparatus is inserted into the aperture,
the first apparatus moves the aperture member along the first intersection direction, and
the second apparatus moves the aperture member along the second intersection direction.

### [Supplementary Note 12]

The processing system according to any one of the Supplementary Notes 1 to 11, wherein
the partition apparatus includes:
a first support member that supports the aperture member so that the aperture member is movable along a first direction; and
a second support member that supports the aperture member so that the aperture member is movable along a second direction that intersects the first direction.

### [Supplementary Note 13]

The processing system according to the Supplementary Note 12, wherein
the partition member uses, as at least a part of a wall member that forms the processing space, a member that includes the aperture member, the first support member, and the second support member.

### [Supplementary Note 14]

The processing system according to any one of the Supplementary Notes 1 to 13, wherein
a first tool is attachable to at least one of the first apparatus and the second apparatus, and
the processing system further includes a change apparatus that is configured to detach the first tool from the first apparatus or the second apparatus positioned in the processing space, and that is configured to attach the first tool to the first apparatus or the second apparatus positioned in the processing space.

### [Supplementary Note 15]

The processing system according to the Supplementary Note 14, wherein
a second tool is attachable to at least one of the first apparatus and the second apparatus,
the change apparatus is configured to detach the second tool from the first apparatus or the second apparatus that is inserted into the aperture and that is positioned in the processing space, and that is configured to attach the second tool to the first apparatus or the second apparatus that is positioned in the processing space,
in the first period, the first apparatus performs the first operation by using the first tool, then the change apparatus replaces the first tool with the second tool, and then the first apparatus performs the first operation by using the second tool, and
at least a part of the first apparatus remains inserted into the aperture to be positioned in the processing space in a period from a timing at which the first apparatus starts the first operation by using the first tool to a timing at which the first apparatus finishes the first operation by using the second tool.

### [Supplementary Note 16]

The processing system according to the Supplementary Note 15, wherein
the change apparatus includes a containing apparatus in which a containing space for containing the first tool and the second tool is formed,
the change apparatus moves at least one of the first tool and the second tool, which are contained in the containing apparatus, between the containing space in the containing apparatus and the processing space.

### [Supplementary Note 17]

The processing system according to the Supplementary Note 16, wherein
the containing apparatus includes a shutter member that is positioned between the containing space in the containing apparatus and the processing space and that is openable and closable.

### [Supplementary Note 18]

The processing system according to the Supplementary Note 17, wherein
the shutter member is closed in a period during which the first operation is performed.

### [Supplementary Note 19]

The processing system according to any one of the Supplementary Notes 16 to 18, wherein
an air pressure in the containing space is higher than an air pressure in the processing space.

### [Supplementary Note 20]

The processing system according to any one of the Supplementary Notes 15 to 19, wherein
a third tool and a fourth tool are attachable to at least one of the first apparatus and the second apparatus,
the change apparatus is configured to detach the third tool from the first apparatus or the second apparatus that is inserted into the aperture and that is positioned in the processing space, and that is configured to attach the third tool to the first apparatus or the second apparatus that is positioned in the processing space,
the change apparatus is configured to detach the fourth tool from the first apparatus or the second apparatus that is inserted into the aperture and that is positioned in the processing space, and that is configured to attach the fourth tool to the first apparatus or the second apparatus that is positioned in the processing space,
in the second period, the second apparatus performs the second operation by using the third tool, then the change apparatus replaces the third tool with the fourth tool, and then the second apparatus performs the second operation by using the fourth tool, and
at least a part of the second apparatus remains inserted into the aperture to be positioned in the processing space in a period from a timing at which the second apparatus starts the second operation by using the third tool to a timing at which the second apparatus finishes the second operation by using the fourth tool.

### [Supplementary Note 21]

The processing system according to any one of the Supplementary Notes 1 to 20, wherein
a fifth tool is attachable to at least one of the first apparatus and the second apparatus, and
the processing system further includes a second change apparatus that is configured to detach the fifth tool from the first apparatus or the second apparatus to which the fifth tool has been attached, and that is configured to attach the fifth tool to the second apparatus or the second apparatus in the processing space.

### [Supplementary Note 22]

The processing system according to the Supplementary Note 21, wherein
the second change apparatus detach the fifth tool from the other of the first apparatus and the second apparatus or attach the fifth tool to the other of the first apparatus and the second apparatus in a state where at least a part of one of the first apparatus and the second apparatus is inserted into the aperture.

### [Supplementary Note 23]

The processing system according to any one of the Supplementary Notes 1 to 22, wherein
the processing system further includes a first calibration apparatus that is used to calibrate the first apparatus, and
the processing system calibrates the first apparatus by using the first calibration apparatus.

### [Supplementary Note 24]

The processing system according to the Supplementary Note 23, wherein
the first calibration apparatus is positioned in the outer space.

### [Supplementary Note 25]

The processing system according to the Supplementary Note 23 or 24, wherein
the processing system calibrates the first apparatus by using the first calibration apparatus in the second period.

### [Supplementary Note 26]

The processing system according to the Supplementary Note 25, wherein
the first apparatus is positioned at a first wait position that is at an outside of a movement range of the second apparatus in the second period, and
the processing system calibrates the first apparatus positioned at the first wait position by using the first calibration apparatus.

### [Supplementary Note 27]

The processing system according to the Supplementary Note 26, wherein
the processing system is configured to attach a tool to the first apparatus in a period during which the first apparatus is positioned at the first wait position.

### [Supplementary Note 28]

The processing system according to any one of the Supplementary Notes 23 to 27, wherein
the processing system controls the second apparatus by using a result of a calibration of the first apparatus using the first calibration apparatus.

### [Supplementary Note 29]

The processing system according to any one of the Supplementary Notes 1 to 28, wherein
the processing system further includes a second calibration apparatus that is used to calibrate the second apparatus, and
the processing system calibrates the second apparatus by using the second calibration apparatus.

### [Supplementary Note 30]

The processing system according to the Supplementary Note 29, wherein
the second calibration apparatus is positioned in the outer space.

### [Supplementary Note 31]

The processing system according to the Supplementary Note 29 or 30, wherein
the processing system calibrates the second apparatus by using the second calibration apparatus in the first period.

### [Supplementary Note 32]

The processing system according to the Supplementary Note 31, wherein
the second apparatus is positioned at a second wait position that is at an outside of a movement range of the first apparatus in the first period, and
the processing system calibrates the second apparatus positioned at the second wait position by using the second calibration apparatus.

### [Supplementary Note 33]

The processing system according to the Supplementary Note 32, wherein
the processing system is configured to attach a tool to the second apparatus in a period during which the second apparatus is positioned at the second wait position.

### [Supplementary Note 34]

The processing system according to any one of the Supplementary Notes 29 to 33, wherein
the processing system controls the first apparatus by using a result of a calibration of the second apparatus using the second calibration apparatus.

### [Supplementary Note 35]

The processing system according to any one of the Supplementary Notes 1 to 34, wherein
the first apparatus is configured to supply gas, and
the second apparatus is configured to supply gas.

### [Supplementary Note 36]

The processing system according to the Supplementary Note 35, wherein
the first apparatus is configured to supply the gas in the first period during which at least a part of the first apparatus is inserted into the aperture to be positioned in the processing space, and
the second apparatus is configured to supply the gas in the second period during which at least a part of the second apparatus is inserted into the aperture to be positioned in the processing space.

### [Supplementary Note 37]

The processing system according to any one of the Supplementary Notes 1 to 36, wherein
the first apparatus performs the first operation by irradiating the object with an energy beam.

### [Supplementary Note 38]

The processing system according to any one of the Supplementary Notes 1 to 37, wherein
the second apparatus performs the second operation by irradiating the object with an energy beam.

### [Supplementary Note 39]

The processing system according to any one of the Supplementary Notes 1 to 38, wherein
the first operation performs at least one of a processing operation for processing the object and a measurement operation for measuring the object, and
the second operation includes at least one of a processing operation for processing the object and a measurement operation for measuring the object.

### [Supplementary Note 40]

The processing system according to the Supplementary Note 39, wherein
the processing operation includes at least one of a subtractive manufacturing operation for removing at least a part of the object, an additive manufacturing operation for adding a build object to the object, and a melting processing operation for making at least a part of a surface of the object be planar.

### [Supplementary Note 41]

A processing system that is configured to perform a processing for changing a shape of an object, wherein
the processing system includes:
a partition apparatus that defines a part of a processing space, a flow of gas between an outer space and the processing space is restricted; and
a first apparatus that is configured to perform a first operation for changing the shape of the object by processing the object contained in the processing space,
the partition apparatus includes:
an aperture member in which an aperture is formed and which is movable; and
a support member that supports the aperture member in a movable manner and that is formed by stacking a plurality of plates,
the first apparatus inserted into the aperture performs the first operation while moving the aperture member,
at least one of the plurality of plates moves doe to a movement of the aperture member.

### [Supplementary Note 42]

A processing system that is configured to perform a processing for changing a shape of an object, wherein
the processing system includes:
a first apparatus that is configured to perform a first operation for changing the shape of the object by processing the object contained in the processing space;
a second apparatus that is configured to perform a second operation in the processing space; and
a change apparatus that is configured to attach a first tool to the first apparatus and that is configured to detach the first tool from the first apparatus,
the first tool includes an optical system, and
the first operation includes processing the object by irradiating the object with processing light through the optical system.

### [Supplementary Note 43]

A processing system that is configured to perform a processing for changing a shape of an object, wherein
the processing system includes:
a partition apparatus that forms a processing space in which the object is contained;
a first apparatus that is configured to perform a first operation for changing the shape of the object by processing the object contained in the processing space; and
a second apparatus that is configured to perform a second operation on the object contained in the processing space,
the partition apparatus includes an aperture member in which a first aperture and a second aperture, which connect the processing space and an outer space that is at an outside of the partition apparatus, are formed,
in a first period during which the first apparatus performs the first operation, at least a part of the first apparatus is inserted into the first aperture to be positioned in the processing space and the first aperture is moved by the first apparatus contacting with the aperture member, and
in a second period during which the second apparatus performs the second operation, at least a part of the second apparatus is inserted into the second aperture to be positioned in the processing space and the second aperture is moved by the second apparatus contacting with the aperture member,
in the first period, the second apparatus is positioned in the outer space,
in a second period during which the second apparatus performs the second operation, at least a part of the second apparatus is inserted into the aperture to be positioned in the processing space,
in the second period, the first apparatus is positioned in the outer space.

At least a part of the feature of each example embodiment described above is allowed to be combined with at least another part of the feature of each example embodiment described above. A part of the feature of each example embodiment described above may not be used. Moreover, the disclosures of all publications and United States patents that are cited in each example embodiment described above are incorporated in the disclosures of the present application by reference if it is legally permitted.

The present invention is allowed to be changed, if desired, without departing from the essence or spirit of the invention which can be read from the claims and the entire specification, and a processing system, which involves such changes, is also intended to be within the technical scope of the present invention.

### DESCRIPTION OF REFERENCE CODES

SYS processing system
1 processing unit
11 light source
12, 13 processing head
126, 136 tool
14 head driving system
2 stage unit
21 stage
22 stage driving system
3 housing 3
31 bottom member
32 side wall member
33 ceiling member
331 aperture member
332, 333, 3321, 3322, 3331, 3332 support member
3323, 3324, 3333, 3334 support plate
34 aperture
4 control unit
51 surface plate
52 support frame
6b tool change unit
61 containing apparatus
610 tool containing space
611 containing member
612 housing
613 transport port
614 shutter member
615 gas supply port
62 transport apparatus
7c calibration unit
W workpiece
EL processing light
SP1 outer space
SP3 inner space, processing space

1. A processing system that is configured to perform a processing for changing a shape of an object, wherein
the processing system comprises:
a housing that defines a part of a processing space and separates the processing space from an outer space, wherein a flow of gas between an outer space and the processing space is restricted;
a first processing head that is configured to perform a first operation for changing the shape of the object by processing the object contained in the processing space;
a second processing head that is configured to perform a second operation in the processing space; and
a control circuit configured to control the first processing head and the second processing head, wherein
the housing includes an aperture plate in which an aperture is formed and which is movable,
in a first period during which the first processing head performs the first operation, the control circuit is configured to insert at least a part of the first processing head into the aperture to be positioned in the processing space,
in the first period, the control circuit is configured to position the second processing head in the outer space,
in a second period during which the second processing head performs the second operation, the control circuit is configured to insert at least a part of the second processing head into the aperture to be positioned in the processing space, and
in the second period, the control circuit is configured to position the first processing head in the outer space.

2.-42. (canceled)

43. The processing system according to claim 1, wherein
the first processing head includes a first tool that is inserted into the aperture in a case where the first operation is performed, and
a shape of the aperture is the same as a shape of a cross-section of the first tool that is positioned at a position that is the same as a position of the aperture in the first period.

44. The processing system according to claim 43, wherein
the second processing head includes a second tool that is inserted into the aperture in a case where the second operation is performed, and
a shape of the aperture is the same as a shape of a cross-section of the second tool that is positioned at a position that is the same as a position of the aperture in the second period.

45. The processing system according to claim 1, wherein
the first processing head includes a first tool that is inserted into the aperture in a case where the first operation is performed, and
a size of the aperture along one direction in a plane on which the aperture is positioned is the same as a size of a part of the first tool, which is positioned at a position that is the same as a position of the aperture in the first period, along the one direction.

46. The processing system according to claim 45, wherein
the second processing head includes a second tool that is inserted into the aperture in a case where the second operation is performed, and
a size of the aperture along one direction in a plane on which the aperture is positioned is the same as a size of a part of the second tool, which is positioned at a position that is the same as a position of the aperture in the second period, along the one direction.

47. The processing system according to claim 45, wherein
the control circuit is configured to move the aperture plate in a state where the first processing head or the second processing head is inserted into the aperture.

48. The processing system according to claim 47, wherein
the control circuit is configured to switch between the first processing head and the second processing head in a state where the aperture plate is positioned at a predetermined position.

49. The processing system according to claim 48, wherein
the aperture plate moves to the predetermined position after the first period ends, and
the second processing head moves to a position, which corresponds to the aperture after the first period ends, before the second period starts.

50. The processing system according to claim 49, wherein
the first processing head inserted into the aperture moves the aperture plate by using a force applied from the first processing head to the aperture plate, and
the second processing head inserted into the aperture moves the aperture plate by using a force applied from the second processing head to the aperture plate.

51. The processing system according to claim 1, further comprising
a driver that is configured to move each of the first and second processing heads, wherein
the first processing head moved by the driver moves the aperture plate, and
the second processing head moved by the driver moves the aperture plate.

52. The processing system according to claim 51, wherein
the driver moves the first processing head along a first intersection direction that intersects a first insertion direction along which the first processing head is inserted into the aperture,
the driver moves the second processing head along a second intersection direction that intersects a second insertion direction along which the second processing head is inserted into the aperture,
the first processing head moves the aperture plate along the first intersection direction, and
the second processing head moves the aperture plate along the second intersection direction.

53. The processing system according to claim 1, wherein
the housing includes:
a first support plate that supports the aperture plate so that the aperture plate is movable along a first direction; and
a second support plate that supports the aperture plate so that the aperture plate is movable along a second direction that intersects the first direction.

54. The processing system according to claim 53, wherein
the housing uses, as at least a part of a wall that forms the processing space, a member that includes the aperture plate, the first support plate, and the second support plate.

55. The processing system according to claim 1, further comprising
an auto tool changer that is configured to
detach a first tool from the first processing head or from the second processing head positioned in the processing space, and
attach the first tool to the first processing head or the second processing head positioned in the processing space.

56. The processing system according to claim 55, wherein
a second tool is attachable to at least one of the first processing head and the second processing head,
the auto tool changer is configured to
detach the second tool from the first processing head or the second processing head that is inserted into the aperture and that is positioned in the processing space, and
attach the second tool to the first processing head or the second processing head that is positioned in the processing space,
in the first period, the control circuit is configured to control the first processing head to perform the first operation using the first tool, then the auto tool changer is configured to replace the first tool with the second tool, and then the control circuit is configured to control the first processing head to perform the first operation by using the second tool, and
the control circuit is configured to maintain at least a part of the first processing head remains in the aperture to be positioned in the processing space in a period from a timing at which the first processing head starts the first operation by using the first tool to a timing at which the first processing head finishes the first operation by using the second tool.

57. The processing system according to claim 56, wherein
the auto tool changer includes a container for containing the first tool and the second tool,
the auto tool changer is configured to move at least one of the first tool and the second tool in the container between the container and the processing space.

58. The processing system according to claim 1, wherein
the processing system further comprises a first calibration detector that is used to calibrate the first processing head, and
the control circuit is configured to calibrate the first processing head by using the first calibration detector.

59. The processing system according to claim 1, wherein the housing further includes a support that supports the aperture plate in a movable manner, the support including a stacking of a plurality of plates.

60. A processing method of performing a processing for changing a shape of an object, wherein
the processing method comprises:
defining, by using a housing, a part of a processing space and separates the processing space from an outer space, wherein, a flow of gas between an outer space and the processing space is restricted
performing, by using a first processing head, a first operation for changing the shape of the object by processing the object contained in the processing space; and
performing, by using a second processing head, a second operation in the processing space, wherein
the housing includes an aperture plate in which an aperture is formed and which is movable,
during a first period
performing the first operation includes inserting at least a part of the first processing head into the aperture to be positioned in the processing space, and
positioning the second processing head in the outer space; and
during a second period
performing the second operation includes inserting at least a part of the second processing head into the aperture to be positioned in the processing space, and
positioning the first processing head in the outer space.

61. A non-transitory computer readable storage medium configured to store a program that, when executed by circuitry, causes the circuitry to perform the method of claim 60.
